(19) United States
(12) Patent Application Publication
(10) Pub. No.: US 2020/0234605 A1
(43) Pub. Date: Jul. 23, 2020

(54) Telecommunications - enabled semitransparent thought- directed cognitive and conceptual communication linkage method for a workplace brain/cognitive education, training, and augmentation program

(71) Applicant: Laird Harrison Shuart, Topeka, KS (US)

(72) Inventor: Laird Harrison Shuart, Topeka, KS (US)

(21) Appl. No.: 16/602,879

(22) Filed: Dec. 16, 2019

Related U.S. Application Data
(60) Provisional application No. 62/918,149, filed on Jan. 17, 2019.

(51) Int. Cl. G09B 5/10; H04L 12/18; G09B 7/02; G06F 3/01

(52) U.S. Cl. CPC G09B 5/10; G06F 3/011; G09B 7/02; H04L 12/1822

(57) ABSTRACT

A method of semitransparent thought-directed cognitive linkage that facilitates a workplace brain/cognitive training and augmentation program whereby following the successful completion of a computer system's regular cognitive/behavioral biometric authentication/access management process, selected participants who have been recognized and authenticated take part in a separate and distinct supplemental program while they are cognitively and conceptually linked, allowing the participants to transfer information and learning between and among other program participants on how they respond to certain stimuli that includes unconscious behavior, demonstrated preferences, solving techniques, and other implicit learning and knowledge they may not consciously be aware they possess.

### CROSS-REFERENCE TO RELATED APPLICATIONS

This application claims the benefit of provisional application No. 62/918,149, filed on Jan. 17, 2019

### FEDERALLY SPONSORED RESEARCH

Not Applicable

### SEQUENCE LISTING OR PROGRAM

Not Applicable

### BACKGROUND

### Field

This invention relates to computer software, which upon execution extends a computer system's regular risk-based multi-factor authentication/access management process that includes a cognitive/behavioral based continuous authentication protocol by facilitating the establishment of a telecommunications-enabled semitransparent thought-directed method of cognitive/conceptual communication linkage between a computer system and a program participant, and directly between and among program participants themselves in varying real time for the participants involved, that may exist at differing levels of intensity—that forms a basis for a new type of brain/cognitive education, training, and augmentation program directed at improving both biological and technical functioning—designed to provide real world benefits that can be transformative; and that adds value to a participant's knowledge, natural intelligence, his mental processing mechanisms, and his ability to learn in new ways that can continuously drive and deliver innovation in a workplace.

Computing device authentication is the process of verifying a user's identity, and continuous authentication is the process of verifying that one is transacting with the same entity over time. In the context of a computer system logon, authentication has historically consisted of a two-step process. First, the user will enter a username, user ID, or other unique sequence of characters that identifies the user. In many cases, this information is known not only to the user, but also to others through a directory listing or other source. To complete the process, the user must then enter a pre-selected or pre-assigned password, passphrase, passkey, PIN number, or other unique sequence of characters that is secret and known only to the user and the computer system. If the two pieces of logon information successfully correspond, the user is authenticated, since ostensibly the user is the only individual who could know both pieces of information. In essence, passwords, PINs, and most other types of non-biometric authenticators are simply proxies for a user, assigned or accepted by the system's administrator, and do not represent characteristics of the user himself.

In the real world, recognizing individuals is something humans do every day—by recognizing a person's face, their voice, or the way they talk. For generations, people have conducted transactions in face to face situations where those factors can be taken into consideration and people get to know and grow to trust each other. The most basic level of trust involves knowing an individual's true identity. Today we are witnessing the convergence of two fundamental shifts: the move to digital (i.e. non-personal) interactions and transactions, and the emergence of connected mobile computing devices (e.g. smart devices); which means a person can conduct financial and other confidential transactions on the managed computer system they have in their hands at all times. This convergence mandates that new trusted methods of person verification, identification, and authentication be created and that associated new access management technology such as continuous authentication, multi-factor authentication, and risk-based authentication must be implemented. Every day millions of significant monetary transactions take place between complete strangers. These monetary transactions take place outside financial sight in cyberspace, often through mobile computing devices where it is impossible to see the full transaction taking place. Banks and other financial services providers are facing unprecedented security risks to their businesses. As the bank's customers, we are now dependent on their security mechanisms to protect us as transactions are conducted. Advanced access control mechanisms are taking on these recognition and trust functions through artificial intelligence and machine learning.

Today however, we are also living in a world of symbols that continuously requires abstract and representational thinking to a greater and greater degree. This necessitates learning to trust symbols and representations of humans as well as real people, and allows would-be intruders to create multiple separate online identities. Other connections and other cognitive perspectives are inhibited as symbolic communication through an increasing number of alternative types of computing devices further continues to accomplish alienation from reality. This emerging symbolic culture inhibits human communications by blocking and otherwise suppressing channels of sensory awareness. Numerical symbolism is also of fundamental importance to the development of a cultural world. Children, and adults who need to educate and/or re-educate themselves to adapt to ever changing technology, must accomplish new learning that involves symbolism that may not have ever involved reality. Symbolic thinking—the ability to use symbols to represent things—sometimes requires recognizing symbols that are only symbols themselves. Children are sometimes learning important concepts through virtual reality only, concepts that will be used in real life, but that may never include real life training. Understanding abstract concepts requires humans to comprehend the relationships that exist between objects as well as the objects themselves. For example, electronic payment methods do not involve the use of tangible currency and coins and therefore the concept of making correct “change” does not apply; which means that someday the ability to make change may no longer represent a required skill. The steps and processes of “handling” money every day are changing rapidly, and it is too early to know the ultimate effects of a truly cashless economy—such as storing all records involving one's financial holdings in the “cloud”, and having only a piece of paper with numbers on it to represent one's life savings. In essence, we may someday be living with only the concept of possessing money. Similarly, using another example, education and training involving specialized procedural knowledge may someday only involve transferring the concept of that education and real life training to another participant—as opposed to that participant actually having to acquire it himself through repetitive task performance. With technology changing the world so dramatically, memorization of facts will yield to the need to learn new concepts and processes quickly, and conceptual transfer will be required to achieve this. Retraining and reskilling employees in the age of automation, especially those that will be brought about by advances in artificial intelligence, disrupt the world of work and the levels and types of skills companies require will keep shifting. Technology that can accomplish these types of large scale conceptual transfers quickly and effectively will become very valuable. For humans to remain relevant in a world quickly moving to AI and machine learning, ongoing conceptual learning will continue to be necessary, but will need to be accomplished much faster and in alternative ways, as the specific skills required to keep most jobs will continue to change rapidly. A self-paced, individualized approach to this type of program makes the most ethical sense in this new era; utilizing temporarily imported infrastructure and context to achieve faster, deeper learning through non-intrusive methods, such as thought-directed shared simulated reality and other technology disclosed herein. In the Information Age, the largest companies will place a continuing emphasis on information processing as a service by offering many different ways to process the new information a person receives each day, in essence doing a person's reasoning and decision making for him. The technology disclosed herein is designed to make a person better at processing his own information.

As opposed to authentication and access management processes, authorization, meanwhile, is a mechanism by which a computer system determines what level of access an authenticated user should be granted to secure resources within the system. For example, a system might be designed to provide certain users with unrestricted access to all directories and files within the system, while other users are permitted to access only certain directories and files. Similarly, a database management system might provide certain users with the ability to read, write, edit, delete, or upload files, while other users are limited to read-only access. The most recent workplace privacy and data security rules and regulations however, such as those imposed in New York State effective Mar. 1, 2017, require a company's written cybersecurity program to include a provision limiting access privileges to the information system further; to only the access required in order to perform their daily job functions and responsibilities; that may eventually become an authorization standard.

Because passwords may be stolen or divulged, thereby rendering the computer system susceptible to unauthorized access, some systems use additional or alternate methods of authentication and/or authorization. For example, a system may require the presence of a physical token, such as a card with a magnetic strip that can be swiped by the user and read by the system. Other systems may rely on the use of biometrics, or characteristics (i.e. physiological, cognitive or behavioral) that can be used to distinguish one individual from another through the use of digital equipment. The use of behavioral biometrics and behavioral analytics in particular signal an important shift in the authentication field in that rather than simply verifying an object possessed by the user such as a secret password or a physical token, which can be considered only proxies for a user, they allow the system to analyze and verify the inherent traits and characteristics of the user himself. For many reasons a user's true identify is becoming the new computer system security perimeter.

The concept of multi-factor authentication (MFA) is gaining traction quickly because of the increased need to enhance cloud, network, PC, and internet security to meet regulatory compliance requirements. Multi-factor authentication creates layered security by requiring multiple authenticators, which creates multiple checkpoints. The weakness of one checkpoint is offset by the strength of another checkpoint in the process. For instance, “what the user knows” and a unique biometric fingerprint (“what the user is”). Layered security also requires evidence which has separate range of attack vectors, requiring would be intruders to have a more complex attack plan to be successful. Increasing the strength of authentication can be done by adding factors from the same or different kinds of authentication categories that don't have the same vulnerabilities. Multi-factor authentication methods include “what the user knows”, “what the user has”, “what the user is”, “what the user typically does”, (behavioral habits that are independent of physical biometric attributes), and “context” (location, time, party, prior relationship, etc.). Requiring two or more factors from the same or different categories creates two-factor authentication, and requiring any combination of two or more factors from different categories creates multi-factor authentication. Multi-factor authentication methods often include a biometric layer that focuses on making the user himself his actual password. If the trend toward biometric authentication systems continues—whereby a user's behavior, cognitive function and/or cognitive/behavioral biometrics (that may comprise an individual's cognitive fingerprint for example) are used for identification and authentication—new windows on the mind will be created, and massive amounts of big data relating to thought-based authentication and authorization processes such as the conceptual/preference authentication technology disclosed herein will be generated that can be and will be used to change the world in ways undreamed of previously. Every day businesses cross the line that separates today from tomorrow. Time itself assures that. Some businesses anticipate this change and prepare for it. Others simply watch it happen. The technology disclosed herein anticipates the future.

Continuous authentication mechanisms are designed to assure the computer system that once it has granted privileges to a specific authorized user, it is that same specific authorized user that remains in control of the entire logon session. Behavioral biometric authenticators work well for this type of authentication mechanism. More and more IT professionals are indicating thought-based biometric technology might be the most promising method for use in meeting future continuous authentication cybersecurity regulations. One reason is that a brain related biometric authenticator can be updated for a different mental activity should there be a security breach, unlike a fingerprint biometric which remains for life and cannot be replaced once compromised. Given that it is difficult to copy another person's exact thought process, this type of technology offers other valuable advantages as well. Continuous authentication is necessary for a changing world. A major question arises as to who owns and who is entitled to control an individual's identity. We need to have a ubiquitous identity that is trusted, and at the same time somehow centralized for global identity purposes, and at the same time fluid enough to allow for commerce to be conducted. Government is trusted by the people to a large extent—it issues Social Security benefits, manages Medicare, and issues your driver's license, etc., but because of the velocity of commerce governments seem to always be behind and throwing up constraints over privacy without understanding the imperative for this global identity. They tend to serve in a protective capacity—utilizing various government agencies. Identity management processes require a balancing act to apply the right amount of friction in the right places to conduct commerce. Too little friction, or too much friction gets in the way of business—so each organization needs to find the right balance for them. One of the keys is to make certain transactions and certain customers, get through without friction—meaning behind the scenes identification becomes more important. Customers want to be on both sides of a transaction. They want to conduct a transaction, and they want to feel secure doing it. A good authentication process and access management system will put the right friction in the right places to facilitate the right transactions—using a risk-based approach. We are in an environment where we can use infrastructure, where we can create data, information, and knowledge, and we have risk principles that can be used to manage processes. The balancing act is to apply friction in the right places to facilitate growth, so friction can be viewed as a positive thing—placing friction in the right place to facilitate and actually stimulate business growth. A workplace brain/cognitive education, training, and augmentation program that continually promotes innovation is just such a place.

According to the 2016 Data Breach Investigative Report (DBIR), “63% of confirmed data breached involved weak, default, or stolen passwords.” The 2017 DBIR was even more sobering as Verizon found that 81% of hacking-related breaches in its data set leveraged either stolen or weak passwords. Identity is today's most consequential attack vector. Organizations are working to protect this threat vector and enforce strong access control. Recommendations looking beyond standard MFA and considering even more modern approaches to authentication have been put forward. Our expectations for authentication need to change; and include creating a modern user experience, authentication appropriate to the risk mitigated, and invisible authentication solutions. The era of requiring only a username and password for authentication is coming to an end and newer more effective methods of access control must be created and implemented. Continuing to use the current method shifts the ultimate responsibility for security to end users. User experience is about leveraging the new spectrum of technology and context to take the ultimate burden back from the end user at least partially, but end users must be empowered to participate in new ways. The choice of challenges must be a fundamental component. Authenticators and/or authentication methods should include: biometrics, device recognition, thought-based methods, and contextual authentication. The primary emphasis of modern authentication should be choice, taking into account context. The mobile phone has become a marvelous authentication platform. Besides using something you have, it is itself an “authenticator” for establishing trust via fingerprint, device recognition, and mobile apps. Choice is about strengthening authentication, and not counting only the number of factors involved. The key issue is to consider the risk to be mitigated and then apply authentication challenges in layers to appropriately mitigate that risk.

Modern authentication methods change the view of authentication from being a simple binary event (i.e. a user is either authenticated or not authenticated), to viewing authentication as a continuous risk-based process. The activity that a user is performing has a measured level of risk. In this context, risk is essentially the product of the likelihood something outside normal expectations is going to happen that might have a negative impact if it does. The risk mitigated from the cumulative authentication challenges must equate to the amount of risk authenticating the user presents. As previously stated, the key issue is to consider the risk to be mitigated and then apply authentication challenges in layers to appropriately mitigate that risk. It is important to realize that risk is not static: it is dynamic and can change during a single user session mandating continuous risk-based user authentication controls. A bank customer wants to view information using the computer he normally does, and that has a certain level of risk to mitigate. A transfer of funds involving a mobile phone is a different matter. Authentication challenges need to be dynamic and appropriate to mitigate risk, while not burdening the user with onerous risk for benign activities.

Using a risk score approach to authentication that may be accomplished in a multitude of differing ways fundamentally changes the constricts of authentication as a user is never trusted completely. Normally, a user's satisfied authentication challenge tests permit him/her to do a certain activity. But risk assessments must be continuously assessed throughout a session, as risk is dynamic.

Modern authentication is not only about solving today's issues, but building a foundation for the future. Modern authentication solutions for users must coexist with and support authentication for IT devices and physical access, as people and things will need to operate within a trusted system. Security and authentication are critical in such a reality, as security is a fundamental enabler. Finally, business-to-employee, business-to-consumer, business-to-business, and employee-to-employee dynamics need to be considered when implementing modern authentication solutions. New authentication considerations will require new authentication mechanisms, that in turn will create massive amounts of big data usable for cognitive and behavioral analytics. Mobile authentication is more important as direct-to-consumer brands increase in popularity—and new communication channels become necessary.

Big data has become a fairly common term that is used across industries. It refers to large, complex volumes of data that are generated from multiple sources. The concept of big data has been around for years and growing numbers of organizations are recognizing the value that can be found in big data, analytics, and cognitive informatics. As a result, an increasing number of business leaders are waking up to the fact that being able to store, access, and transform business data is one thing, but if a company does not have employees armed with skills required to creatively interact with the business intelligence gathered, the return on any investment made has the likely potential to fall short of expectations—maybe far short. If managed correctly, data can be used to make smarter business moves, drive more efficient operations and keep customers happy. As massive amounts of big data will be created as the by-product of the transactions that take place each business day—that include many types of communication from many different sources—businesses will need to create new technology and methods to organize and analyze their data; they will need to create new ways to put this data to work. Today, big data enables the biggest companies in America to develop a 360 degree view of the strengths and vulnerabilities of their suppliers, competitors, and customers. Access to massive amounts of data allows these companies to spot negative trends early and aggressively so they can move against them as necessary before they become a competitive threat. The technology disclosed herein can be used to create a more robust and dynamic basis for the creation of a company's big data. The technology involved in the conceptual learning and knowledge taking place as part of the program disclosed herein can be modified as desired to collect this big data in the form of data, information, or knowledge—not simply data that must be put through further processing in order to comprise information and knowledge. This can be accomplished by altering a variable's cognitive/conceptual narrative to include more interfacing opportunities, or to generate and collect new and/or more types of communication that can then be used to create more effective cognitive and big data analytics—and to increase the program's overall effectiveness. The data, information, and knowledge created through the program each day as a result of the participants responses to the variables presented can be considered a form of big data—the by-product of the thoughts created by the program participants interacting with each other each business day. A cognitive variable's preference element(s) responses are particularly important because they are the by-product of each program participant's thinking process as he demonstrates a preference—choosing one option over another in making his response. Using the variable at paragraph [0123] as an example, program participants acting in the role of a customer are asked to state what bill(s) they would use to pay for a lunch costing $9.80, and what amount of change (or “what” change, as applicable) they would expect to get back. Decision making and reasoning are upper level cognitive skills that must be utilized in order to be able to pick one alternative over another or to originate a new alternative in order to reach a goal or solve a problem, and consequently there will be associated conceptual communication created as a by-product of those cognitive processes that is currently rarely if ever collected in the big data collection process because it is not in a recognizable format. That problem can be solved using the technology disclosed herein. This type of communication can now be transmitted, recognized, measured, and documented through component 2 of the thought-directed cognitive/conceptual linkage. If a participant enters the following response to an example variable on a device's keyboard or keypad; “a $10.00 bill and a $5.00 bill”, that exact explicit response is transmitted through component 1. The reason(s) why the participant decided on that alternative, and the meaning of the specific words used are embedded in that response, and may be revealed later during level 2 processing. Communication that does not exist in explicit form cannot be recognized by component 1 of the linkage because it has not been entered through an input device, but it has an existence that is separate from the explicit response in the form of the communication that is generated that can be collected and documented evidencing the fact that the communication did exist for a period of time, that may be revealed through a subsequent response, for example, as shadow associated conceptual communication. The new method of cognitive linkage disclosed herein can pick it up as associated conceptual communication that can be carried through component 2 of the thought-directed cognitive/conceptual linkage. Component 2 has the ability to transmit ambiguous communication, such as the meaning of a response that is not explicitly stated. This new form of communication can be evidenced by analyzing certain parts of an explicit or preference element response acquired and documented for example, the communication taking place between one participant who originates his response that uses this option of payment based on his imagination, creativity, perception, and reasoning, and a receiving participant who views the response and is perceptive enough to pick up on that. This perception can be evidenced if a participant changes his initial response to an action that he hypothetically took or could take in simulated reality, as a result of level two processing that introduces a new expanded concept that has not been directly referenced or explicitly stated in the variable's cognitive narrative. A participant can generate a thought for training, education, and brain augmentation purposes, and can directly transfer that thought to a second participant through the technology disclosed herein even though that thought is never explicitly stated. Associated information (not to be confused with associated conceptual communication) can be carried through component 1 because even though it may not be explicitly stated in a response it can be explicitly picked up through neural coding and decoding measurements of how long it takes him to read, think about, and enter his response for instance, that can be measured and analyzed. Implicit learning and knowledge involved, such as the unconscious learning developed in waiter training that a participant may have had in real life for example—that he may not consciously know he has—can be validated in other ways as he would most likely have demonstrated that unconscious learning and knowledge earlier in level one processing and would not have had to change his initial response later. The thought-directed linkage allows communication to change form while it is being transmitted—implicit learning and knowledge can become explicit through his thought compression processes utilized in making his response. A participant can turn implicit unconscious knowledge into explicit knowledge, and can bring it into the real world through the linkage. The originating participant may have had a deeper immersion into the simulated reality or a better imagination than the receiving participant because he recognized a way to modify the narrative to expand the concept being transferred to change the conceptual message. While the secret of unlocking creating genius remains elusive, research suggests, as does the technology disclosed herein, that it is possible to prime the mind for creative ideas to emerge.

In the workplace, employees need to be able to anticipate, identify, measure, and analyze customer needs and desires to create new products and customer-driven services. Reliable data which can help businesses adapt and change in order to thrive in an increasingly competitive landscape. However, big data requires new technology, and organizations without strong data-focused leadership will fall behind their competitors. Businesses realize that by partnering with specialist, they gain access to fuller technical skills. But developing these skills within their own organizations also makes sense, and when factoring in potential security and privacy issues maybe even more sense, and the technology disclosed in this application promotes this concept. Business leaders need to understand that the best informed decisions are made when data are involved and is accessible to all those involved in decision making. Big data can be broken down, deconstructed, and analyzed in the best way when that is done internally by those employees closest to a company's customers and providers on a daily basis. The right internal programs will enable organizations to gather data from a large number of sources while reducing the risk that valuable information is unavailable for use by parties that actually need and want it.

The security and privacy concerns previously mentioned and other identity related security threats can at least be partially addressed in identity management systems that authenticate the user through a new type of cognitive/behavioral biometrics that reflect “who the user is” and “what the user normally does”. Cognition, a term which refers to both the mind and the brain, can be defined as the “application of the process of thought to knowing” (i.e. thinking) to create new knowledge. Behavior can be considered as a complex interaction between cognition, affect, and conation, and as such, can serve as an additional authentication factor in multifactor authentication mechanisms. Cognition forms the basis of our intellectual capacities. A user's cognitive function, or the brain mechanisms involved with thinking, reasoning, learning, and remembering (“what the user is”) can be determined through his responses to certain prompts that measure, among other things, his attention, awareness, comprehension, computational linguistics, concentration, decision making, executive function, forensic authorship, judgment, logical thinking long-term memory, math skills, perception, planning, problem solving, short-term memory, structural semantics, symbolic thinking, visual-spatial recognition, verbal fluency, phonemic fluency, and working memory. Questions and mental exercises that measure an individual's cognitive function have been used for years in the fields of psychology, psychiatry, education, and human resource management for a variety of purposes, but thought-based technology has only recently been introduced as a basis for recognizing and authenticating a user.

Cognition involves the internal structures and processes that are involved in the acquisition and use of knowledge that include perception, attention, learning, memory, language, thinking, and reasoning. Cognition throughout life can be broadly described as an interaction between knowledge driven processes and sensory processes, and between controlled processes and automatic processes. A primary cognitive function of all social species is communication, which can be accomplished by a combination of signals. Of all species on Earth, only humans have developed communication systems based upon abstract signs and signals. Humans use language to share information, to ask questions, to make promises, to direct other people's actions, and to express emotions. There is evidence that the existence of certain sentence types, word order patterns, and certain kinds of expressions are motivated by interactive processes of language use. Language itself may be viewed as a cognitive-communication process; thinking affects language, and language affects thinking. Some people believe that the proof that thinking exists involves the ability to solve abstract problems. Many processes make up cognitive communication, such as problem solving and executive function. This means that a company's control of its narrative and messaging with consumers is key and can become more personalized and effective through a continuous effort, a necessity in direct-to-consumer transactions. A company can attain better control of its narrative with customers as a result of the technology disclosed herein. AI will improve to the point where responses can be based on context and nuances. It is unclear exactly how much communication really takes place through other sensory channels while we are engaged in conversation—forms of communication that, if harnessed and consolidated in a meaningful way, could provide even deeper learning regarding a conversation. The English language illustrates many interesting features. The word “change”, for instance, can be ascribed several different meanings when standing alone. It can be used to mean the amount of money to be returned from a purchase. It can also mean something else totally different—to “make or become different” such as when a business adjusts its operations to address differing objectives. Like many other words, its meaning in a variable's conceptual narrative must be extracted from the context in which the word is being used; the meaning of a specific word must be derived from the words used in conjunction with, and relating to it. Technology that helps us communicate such as that disclosed herein, is in many ways the most fundamental and important technology in the world because communication is a primary element in organizing and carrying out commerce. It is estimated that by 2023 mobile biometrics will authenticate $2 trillion worth of in-store and remote mobile payment transactions annually. Brain augmentation represents an important element in affecting change in the way we conduct commerce, particularly through interactions with artificial intelligence (AI) and machine learning. All reasoning can be broadly described as pattern recognition and search. Conceptual knowledge bases all search for relevant information in order to draw a conclusion, solve a problem, or guide behavior. Thinking often takes the form of a chain of associations among concepts in long-term memory, with one thought retrieving others to which it is related—that ultimately explains how human thoughts power part of the communication linkage technology disclosed herein. As we see and hear words and language, we are at the same time, unconsciously grasping at what others intend to communicate as we try to classify the world into categories and to understand the relations between things in aggregate, a unique human ability that helps the human race to further evolve. All these factors help explain a human's heightened ability to generate, recognize, and respond to brain-to-brain (i.e. mind-to-mind) cognitive/conceptual communication when the new linkage technology disclosed herein is in operation.

Of all the world's creatures, only humans are capable of thinking about thinking and learning about learning. These represent two of the highest cognitive processes mankind possesses. Much of the thinking and learning concerns how a person's brain perceives the world and processes information (such as the context example in paragraph [0123]), utilizing “cognition”. However, current research also shows that the brain is capable of unconsciously learning. The dividing line between the unconscious and the alert conscious brain when it comes to thinking, reasoning, learning, and remembering, is often unclear. Implicit learning takes advantage of the fact that a person's brain learns and records some things without the person knowing he has learned and recorded them. It refers to developing a thinking pattern, without any conscious knowledge of the learned pattern. This also means that users may not be consciously aware they are demonstrating certain learning, knowledge, or preferences when they answer questions or do mental exercises, and therefore do not specifically try to remember them. Implicit memory (i.e. learning) involves procedural and category level knowledge. Category knowledge, the ability to classify information such as grammar where people have acquired abstract rules but are unable to articulate what guides speech and writing is a particularly good example. This category of knowledge has been shown to operate independently of declarative memory (explicit) and may be another indicator of a separate brain system involving implicit memory. Keyboarding for example also takes advantage of this, as it would probably take quite a while to recreate the layout of your keyboard exactly—but you can type quickly and without hesitation. Recent studies involving implicit memory reveal that a great deal of learning (information processing) takes place outside our working memory, on an unconscious level, and it has a tremendous influence on how we look at the world. Research shows long-term memory involves several kinds of memory systems, each playing a significant role in defining who we are as a person. New learning may interact with implicit memory, unconscious cognitive processing of past experiences that together influence our thoughts, perceptions, and actions. Understanding this interaction in more detail will allow quicker and better ways of conceptual learning to be created. This understanding can be advanced through the technology disclosed herein relating to the cognitive/conceptual linkage created through a participant's use of cognitive skills—including his imagination and seeing with his mind's eye to create the simulated reality that comes into existence. The three level process disclosed herein is also designed to teach knowledge and learning methods—thinking about thinking and learning about learning. This program involves brain augmentation that includes teaching the skills one needs to transfer more meaningful cognitive and conceptual communication, and to receive it,—i.e. it advances the concept of cognitively linking with other participants in a workplace culture to create new channels of communication, and further promotes the concept of intentionality in other ways.

Biometrics involves identifying someone by his physical, cognitive, and/or behavioral characteristics, and there are advantages to using this identification method for authentication purposes. While a person can imitate another for a certain amount of time, shaking the deeper patterns that are all their own can be difficult. Deeper patterns, such as how long a person might take to solve a certain problem or mental exercise, or how they interpret certain words, or how they demonstrate a preference in a response are embedded in a person's cognitive function and thinking patterns and therefore can be hard to mask. Being able to recognize these thinking patterns means cognitive and behavioral biometrics and analytics can also have advantages when it comes to identifying a person who does not wish to be identified. Using cognitive/behavioral biometrics in a system's identity management/access control process opens new windows on the mind, which in turn creates new opportunities for progress in the areas of brain and cognitive training and augmentation within a workplace environment.

Cognitive function involves a person's ability to process information (i.e. to think), and is reflective of his general level of cognitive skills, as well as his ability to exercise those skills at a given point in time. Some cognitive skills require a higher threshold for activation than others do (i.e. the magnitude or intensity that must be exceeded for a certain reaction, result, or condition to occur). This has been validated by research regarding the impact of sleep deprivation on cognitive skill levels, such as working memory for example. A user's so-called cognitive/behavioral fingerprint for example, reveals unique cognitive/behavioral skills, traits, and other ways each person processes the information he encounters in the real world. This processing method can be observed through his unique patterns of interaction with the technological devices he uses each day. These interactions can be measured and analyzed in real time (i.e. are dynamic), or after the fact through the digital evidence left behind. A user's cognitive fingerprint is strongly tied to his cognitive function and provides a benchmark for monitoring his ongoing cognitive function. Accordingly, a user's highest level of cognitive function is limited by the level of cognitive skills he possesses, and his working/short term memory. In order to maximize potential benefits of the program disclosed herein, program participants should be able to demonstrate a threshold level of cognitive function in order to complete a computer system's regular authentication/access management process before the program is initiated. This may be accomplished through a challenge-response logon protocol designed to measure the user's verbal reasoning, quantitative reasoning, visual reasoning and/or short-term memory skills, for example.

Both authentication and authorization are useful for controlling access to computer systems and areas within those systems where sensitive information is stored. However, in an environment where many computer-based job functions require a high degree of skill, dexterity, alertness, focus, and/or concentration, the mere verification of a user's identity may not be enough. In many cases, it is important for an employer to verify not only that a user is who he says he is, and that he has a certain job title or security clearance level, but also that he is able to perform up to his usual abilities at a particular time; when he is involved in the workplace program disclosed herein, for example. Dealing with them as two separate issues makes sense for security purposes as well. Similarly, many users of personal computers suffer from some degree of impairment to their memory, language, or other mental functions due to age, illness, trauma, and/or degenerative conditions such as Alzheimer's. These persons (and their caretakers) should want to ensure that they are mentally alert and aware enough to perform basic tasks before logging onto a computer where, absent supervision, they might enter into financial transactions, share personal information, or engage in other potentially harmful activities. But being able to perform up to his usual abilities is more important than ever, and will become even more important as focus increases on job performance. Authentication and authorization should be dealt with separately for these and other reasons.

In the short term, a user's responses to cognitive-based prompts can be used to determine whether the user demonstrates the required level of cognitive function to be granted his usual authorizations, and over the longer term, whether his cognitive function has generally improved, diminished, or remained static. This capability is particularly useful in the case of persons with degenerative mental conditions over a period of time. Through a user's collected responses to the cognitive variables and associated date output, the computer is actually able to identify the user's individual cognitive/behavioral biometric fingerprint. One of the underlying ideas of cognitive fingerprint is “implicit learning” such as the unconscious learning occurring in the formation of skills or habits. The knowledge acquired through implicit learning does not have an explicit representation, but can be made explicit. Solving techniques constitute a participant strategy, the same goes for demonstrated preferences, which participants are usually not even aware they have demonstrated in their responses.

The creation of the bicycle illustrates mans skill and ability as a toolmaker. When man created the bicycle, he created a tool that amplifies a human's inherent ability in terms of getting from point A to point B. It allows man to move much faster and much more efficiently. Scientists have viewed certain types of tool production as one of the defining characteristics of humans and one of the most important keys to our evolutionary success. Other creatures use tools, but humans alone build on prior innovation—ratcheting up their utility and complexity over time. New types of digital platforms, interfaces, and tools are needed that are capable of increasing the consumer interfacing opportunities available; that can create new communication channels that can broaden a company's reach with consumers; such as the cognitive/conceptual linkage technology disclosed herein. The personal computer has been compared to the bicycle because it is a tool that has the ability to amplify a certain part of our inherent intelligence. Personal computers have been described as “bicycles for the mind”. But, a bicycle without a rider remains stationary. It not only took a human brain to invent the bicycle, it requires a human to maximize its potential. The key word is human—not bicycle. The invention disclosed herein should be considered a human “tool of thought,” one of the tools we use to help us think—such as language—that may be part of thought itself. There are two main positions regarding the future of computing. One side believes the future of computing involves autonomous systems that can be taught to imitate human cognitive functions—and possibly replace them altogether at some point. The totally self—driving car is an example that promotes this school of thought, and the flagship concept of the group involves artificial intelligence and machine learning. The other position is the idea that information technology can support human thinking, analysis, and planning but leaves the human at the center of the human-computer interaction. This group supports human intelligence augmentation—such as car collision avoidance systems that can help a driver avoid an accident. Such a system could be thought of as a “tool of thought”. AI (artificial intelligence) is an autonomous system that can be taught to imitate and replace human cognitive functions. To put it simply, the machine completely replaces human intervention and interaction. IA (intelligence augmentation) on the other hand, plays more of an assistive role by leveraging AI to enhance human intelligence rather than replace it. The ultimate goal of AI as it relates to any individual specific business is unknown at this point; and for quite a while to come there will be enormous opportunity to focus on both AI and IA. Ultimately, it will probably not be an either/or choice, but how much of one—and how much of another. The technology disclosed herein relating to a new method of cognitive linkage affects both AI and IA, because it creates multiple channels of communication that can exist simultaneously. One of the greatest concerns involved with AI and IA is the belief that brains too closely linked to computers will kill our inner freedom to utilize the brain we were born with and possibly even further to complete identity links. The technology disclosed herein involves a form of cognitive linkage that can augment our capabilities through the use of thought-directed technology that does not involve modifying the human body with implanted technology devices. At this point in time, AI seems to work best for structured environments where relevant information can be considered and where goals of the system are already defined, and this is where a powerful computer has an advantage over a human mind. On the other hand, artificial intelligence is not well suited where goals and inputs are not well defined. This is where intelligence augmentation may always play a major role. A common misconception about algorithms is that they can easily be controlled, rather they can learn, change and run themselves—a process known as deep “neural” learning. In other words, they run on self-improving feed back loops. Much of this is positive of course, unthought of solutions by humans to collective problems like climate change are more possible in the future. The social payoffs could be huge too. But what of the use of AI for other means more nefarious. What if AI becomes just another tool to be used to elites to consolidate their power even further in the 21^{st} century. Rapidly evolving technology ending up in the hands of just a few mega companies, unregulated and uncontrolled, should seriously concern us all. Algorithms will be used to understand deep seated human psychology: they filter, predict, correlate, target, and learn. But they also manipulate. We would be naïve to think they already don't, and even more naïve to think the manipulation is done only by commercial entities. Algorithms can be created to keep people's attention, and attention equals profit. They are known in psychology as intermittent variable rewards, which keep behavior going by the hope of maybe being rewarded. This builds anticipation and releases feel good neurotransmitters. In other words, algorithms will be used to control your behavior and emotions for profit. As an alternative, the technology disclosed herein would be used to create new collective forms of computing devices that deliver innovation through the collective efforts of the workforce—allowing for a workforce's collective imagination, skills and knowledge to be harnessed to solve a problem that can provide solutions that are beyond the ability of a single human to create. In addition, part of the brain augmentation part of the workforce program would be directed at how to recognize and push back on “attention grabbing” algorithms directed at nefariously analyzing and manipulating a computer user's mood, emotions and behavior.

While employers are starting to show an increase in interest for using cognitive/behavioral biometrics for continuous and risk-based multi-factor authentication purposes, and applying machine learning to front-line security controls, mass utilization has been stymied because of concerns involving the increased costs and loss of convenience attached to using cognitive/behavioral biometrics, and the actual benefits that can be obtained—such as increased security. Employers are always interested in creating additional value from the investments they make in the company. In the case of computer system assets, they want to maximize end-user benefits. The three-level process disclosed herein creates technology for businesses of all sizes that offers this additional value, and other benefits as well. It offers companies the ability to take the big data generated as part of a computer system's access control and identity management process and add it to a company's normal big data from daily operations, and utilize all that big data for human brain/cognitive training and augmentation for the development of their company's workforce and culture—and ultimately for the benefit of the company's customers and partners.

Most companies view these new advanced authentication methods as disruptive and a burden to end-users, and consider them unproductive. That accounts at least partially for the reluctance by companies to move beyond username/password security. It also helps to explain the desire of companies that do move to behavioral biometric authenticators to introduce passive and unobtrusive methods of multi-factor and continuous authentication that are based on how a user types, moves a mouse, or holds a cell phone for example that represent “what the user typically does” (behavioral habits that are independent of physical biometric attributes), and “context” (location, time party, prior relationship, etc). The use of biometric identification using these types of properties and characteristics of an individual to help identify them continues to grow in popularity. However, in their haste to promote these types of authenticators, these promoters are missing the bigger part of the picture—the more important part of the picture in this case. People and organizations who are the most successful predict and prepare for change—even creating change that benefits them. Companies are now fighting each other for market space inside consumers heads to revolutionize industries by creating the ability to influence, and possible even alter their behavior. Comparatively speaking, passive metrics are inherently limited in scope, and virtual reality makes it difficult to identify a specific stimulus; for these reasons and others, they do not provide the ultimate benefits that cognitive/behavioral biometrics and other thought-based and deeper learning technology offer, such as the technology disclosed herein, that creates the opportunity to generate, identify, and transmit new types and kinds of communication, that can cognitively link human brains and minds together utilizing the new form of linkage disclosed herein, that in combination can create new kinds of organic computing devices and other tools of thought.

Opponents of stronger authentication mechanisms put forward the argument that the end-user does not receive a benefit that compensates for the time, inconvenience, and lost productivity costs associated with the more advanced multi-factor and continuous authentication mechanisms, particularly those involving sophisticated biometrics, such as the technology disclosed herein. The benefit of added security does not alone seem to carry the day. But the technology disclosed herein addresses this concern if one considers the profitability and productivity gains that could occur from the improvement of employee skills through brain/cognitive training and augmentation—expanding and leveraging their authentication/access control process to create measurable real life benefits for the company and its employees, customers, and business partners by developing new collateral products and services to sustain its competitive advantage. So a company's decision to implement stronger authentication can be justified in many ways. Consider the potential impact on innovation. Innovation is not confined only to brake-out blockbuster products and services. There are innovation types available for every phase of a category life cycle. Innovation relates to category expansion, a new method, or idea, product, etc. Every business has to decide where the most potential exists to create value.

The expansion of neurotechnology—technology that has fundamental influence on how people understand the brain—to include non-medical uses represents the dawning of a new “cognitive era” within the digital age, that will eventually allow companies to monitor and affect human brain activity and functioning. Developments that can revolutionize advertising, education, marketing, and even computer gaming for example—that can monitor and potentially even alter mood the same way as coffee or energy drinks—can be used to measure things like consumer “engagement” or “interest”. The technology disclosed herein is capable of directly measuring a participant's level of attention, perception, engagement and interest in a non-intrusive manner, by measuring the level of a participant's interaction with the conceptual narrative of a variable in different ways, and through the types of communication generated, as well as the specific content of his responses transmitted through the linkage. If the response calls for decision making, associated conceptual communication will be generated as a result of that process, and because the linkage facilitates mind-to-mind (i.e. brain-to-brain) communication, it represents a new type of augmentative and alternative communication (AAC) device and/or cognitive assistive device. The human brain includes billions of neurons and thousands of synapses interconnecting those neurons. Every moment of a person's life, a person's brain is managing and revising all those connections—with the help of another roughly hundred billion glial cells. Every second, electrochemical pulses flash through those connections. All of these neurons don't fire in lockstep with one another, but rather in response to stimuli from each other. Among other considerations, this creates the need to revisit some computer related terms and concepts when human and computers merge, such as “real time”. The human brain can be thought of as the most incredible software in existence. The brain weighs only three pounds, yet it is the most complex object in the solar system. It is tempting to imagine the brain as a biological computer with the tissue as hardware, and electrical activity as software. This thinking, however, leaves the impression that it might be technically feasible to accomplish mind transfer through a brain implant, for example. Even if surgeons could transplant a brain, they would have to transfer the spinal cord as well, or risk stripping the subject of a lifetime of muscle memory. (The self is in the structure). Brain transfer may be off the table at this point in time, but scientists are working on ways to directly upload memories and other skills. Researchers now believe that Alzheimer's disease interferes with how the brain retrieves memories and how memories are stored, not how it makes memories. Loss of short-term memory can be one of the first signs of the onset of Alzheimer's disease. But scientists were never sure if the problem lay in the brain's inability to record new memories, or to retrieve them. In this respect, brain implants, transplants, or complete mind transfer might prove less effective than focusing on new ways to retrieve memories lost or unavailable to consciousness. The new brain augmentation technology disclosed herein creates a new method of mind transfer that involves temporarily extracting mind from matter by facilitating new types of collectible communication that retrieve memories and other acquired knowledge and learning previously unavailable, and brings it into the real world, through new channels that include the semitransparent thought-directed cognitive/conceptual linkage from the brain/mind of one participant directly to the brain/mind of another participant.

The human mind is a set of cognitive faculties that includes perception, thinking, judgment, language, and memory. It is usually defined as the faculty of an entity's thoughts and consciousness. The human brain is part of the visible, tangible world of the body. The human mind is part of the invisible, transcendent world of thought, feelings, attitude, belief, and imagination. The brain is the organ most associated with the mind and consciousness, but the mind is not confined to the brain. The intelligence of the human mind permeates every cell of the human body, not just brain cells. The mind has tremendous power over all bodily systems. Growing evidence shows that the mind goes far beyond the physical workings of one's brain. The technology disclosed herein introduces several new tools to help participants develop and use their cognitive skills to create new kinds and types of communication from new places such as the thought-directed simulated reality that is created in a participant's mind and brain during a conceptual transfer that can also be transmitted between and among program participants using a new form of cognitive linkage. This linkage can extend into the mental imagery of a participant's own simulated reality and the simulated reality of another participant (e.g. one participant's explicit cognitive and/or preference response can introduce a new stimulus into the simulated realty of another participant). To look at it from a different perspective, the mental image of one participant's simulated reality can extend outward and into the mental image of another participant even though neither of the two simulated realities have physical existence; existing only as mental images residing temporarily in the participants minds/brains. The artificial conduit technology disclosed herein facilitates the generation and documentation of cognitive and conceptual communication between conscious willing subjects, that can comprise direct mind-to-mind communication directly between one participant and another participant during level two processing. This technology capitalizes on a period of time when a participant's responses represent his mind in action, when a participant's brain and mind each have a distinct existence from the responses and communication they create, a time when mind is temporarily extracted from brain matter because the communication generated can be transmitted through the cognitive linkage, a portion of which comprises an artificial conduit, that can be measured separately using a limited number of options that can document a participant's perception and cognitive processing time. The changes a participant makes to a previous response he has made can evidence direct mind-to-mind communication, allowing more types and kinds of communication to be generated, documented, and transmitted, that adds to the program's infrastructure and potentially making the program more successful.

Imagination is an important cognitive skill, and is a component of empathy. It was Einstein who said “Imagination is more important than knowledge.” Imagination is the door to possibilities. It is where creativity, ingenuity, and thinking outside the box begin for child development. Imagination is a 21^{st} century skill. Creativity improves things, but imagination is at the heart of thoughts. Imagination is the capacity to produce images, ideas, and sensations in the mind, without any immediate input of the senses (such as seeing or hearing). Imagining is a cognitive process used in mental functioning, and is sometimes used in connection with psychological imagery. The cognate term “mental imagery” may be used in reviving the mind's recollections of objects formerly given in sense perception. Imagination is an experimental partition of the mind used to develop theories and ideas based upon function. Taking objects from real perception, the imagination is used to develop better and easier ways to accomplish old and new tasks. The ability to imagine one's self in another person's place is very important to social relations and understanding. The example variable at paragraph [0123] illustrates imagination designed to further engage participants in the thought-directed simulated reality created by the conceptual narrative of the variable, by providing the opportunity for participants to assume the role of being the customer rather than the waiter as illustrated in paragraphs [0086 and 0101] that also provides a participant with a sense of having conscious control of the simulated reality by letting him actually see that his response can affect the simulated reality—his and that of other participants. The technology disclosed herein creates the ability to develop a new form of collective “imagination” through a new form of collective human computing device.

Seeing with the mind's eye refers to the mental faculty of conceiving imaginary or recollected scenes—and the mental picture so conceived. It involves using one's cognitive skills of imagining and conceiving at the same time. Recent research has given doctors the belief that the mind's eye works through some of the same circuits humans use when seeing through their physical eyes. A number of scan studies have also supported this view. (See articles “Mental Imagery: “The Power of the Mind's Eye”, Kara Rogers, Sep. 25, 2008, Encyclopedia Britannica Blog, and “Study Shows Mind-to-mind Communication In Humans” Catherine Paddock PhD., Sep. 9, 2014, Medical News Today. These articles support the concept that when the mind's eye is in operation—there is some form of special perceptive capacity in place. Some individuals do not have the ability to utilize their mind's eye for some reason, but may be able to utilize the cognitive/conceptual linkage technology disclosed herein as a substitute, while others can use it to supplement their abilities which can prove instrumental in the generation and receipt of mind-to-mind (i.e. brain-to-brain) communication for both.

Research into visual imagery would seem to suggest that students deficient in the power of seeing mental pictures would be likely to experience difficulties with learning, but as yet there is no research that this is the case. Possibly, that is because these individuals have been able to create ways to compensate for their problem. For instance, we know that children with this type of deficiency tend not to enjoy descriptive texts, and this may well influence reading comprehension. It may also be that these individuals may be able to form visual images, but just don't have conscious access to them. The implications for education haven't yet been explored. Research shows the spontaneous use of imagery helps children to learn and understand prose, for instance. More recently, other studies have shown that mental imagery can help students grasp abstract concepts, and that encouraging students to use imagery can improve their understanding of such concepts. Other studies show that using mental imagery helps students learn and understand new scientific words, and that the vividness of their images is closely related to the extent to which imagery enhances their learning. Visualization techniques are also helpful for the teaching and learning of mathematics and computer science, both of which involve an understanding of the patterns within numbers, and creating mental representations of the spatial relationships between them. The thought-directed linkage disclosed herein introduces new types of visualization techniques to capitalize on those findings. The technology disclosed herein creates the ability to objectively measure individual differences or variations in the vividness of participant's mental images by the types and amount of communication generated during a conceptual transfer for example, that someday could be used to identify school aged children who might have a deficiency, for example. If it becomes clear that the condition does in fact impinge on children's ability to learn, it may then be possible to devise alternative learning strategies for them. The technology disclosed herein represents neurotechnology that comprises a diagnostic and rehabilitation device—and a tool of thought to teach imagination in the workforce that can lead to more innovation and more effective analytics.

The following observations support the premise that a participant can temporarily accept the thought-directed simulated reality that has at least partially been created through his attention, imagination, perception, and other cognitive skills—and possibly his mind's eye, as reality. First, this particular simulated reality does not exist anywhere in real life—i.e. there is nowhere else this thought that is happening to a participant at this moment is actually occurring; or for that matter where, how, and if thoughts even exist within the body. A participant cannot physically reside in the temporary simulated reality created, but he will have developed an awareness of it to the extent he can provide cognitive and preference element responses that must be accurate in order for him to advance through the program. These responses must be accurate in real world terms—for instance doing a math calculation accurately—even though they involve actions that are only taking place in simulated reality and that have no real physical existence outside his own awareness. Secondly, the temporary reality can exist as a mental image because the language included in the cognitive/conceptual narrative has the power to make the invisible appear real. Words can create reality in a participant's mind—and that may eventually even change something in real life. Thirdly, the cognitive narrative can activate perceptual knowledge retrieval that references visual and auditory experiences as shown by increases in activity in distinct temporal brain regions involved in respective sensory processing. Results indicate that retrieval of perceptual knowledge relies on brain regions used to mediate sensory experiences with the reference objects. Perceptual processing affects conceptual processing—so both are at least partially based on the same systems. Fourthly, the simulated reality actually takes place in a participant's brain, or is connected to it through the participant's thought process in some way; they are linked—but the brain is the not mind, and the mind is not the brain. The skills necessary to create the required simulated reality to accomplish a conceptual transfer between participants requires the involvement of a participant's brain and mind. An explicit cognitive element response can be carried back to the computer system through component 1 if it is entered using the keyboard—and it can then be shared with other program participants. So an explicit response to a cognitive or preference element of a variable relating to events taking place through the mind's eye can be made real (i.e. given physical existence in the real world) using the new technology disclosed herein that includes the combination of the simulated reality and the cognitive/conceptual linkage. Mind is the brain in action; and simulated reality exists in a participant's brain and mind. So the cognitive linkage can carry communication generated by a participant's brain in action—representations of thought that exists only in a participant's mind related to actions taken in simulated reality, that have no real world physical existence. However, what the mind's eye visualizes does not exist in physical form outside a participant's awareness, except possibly through his remembrances that can ultimately end up as part of an explicit response. However, the cognitive linkage can also extend the mind's eye outward by also carrying communication that has not been explicitly stated because component 2 of the cognitive linkage can also carry ACC, IDCPC, and other unconscious and uncompressed information and communication that does not have physical existence including mind—to—mind (i.e. brain-to-brain) communication relating to the reasoning and meaning of the words and language of a response. The combination of the cognitive linkage, simulated reality, and the cognitive/conceptual narrative that calls for cognitive and preference element responses create the ability to generate a significant level of communication for program purposes, that was previously not available. There is also a supplemental special cognitive/conceptual linkage that exists between a variable's cognitive element and preference element—they work together to reflect what is in both the participant's brain and/or his mind regarding a concept at a particular point in time. Recent research shows that a human's brain does not distinguish real from imaginary. In one research project, test subjects were asked to play a sequence of notes on a piano each day for five consecutive days. Brain scans were done for the region connected to their finger muscles. Another set of test subjects imagined playing the same sequence for five days and had the same scans. The brain scans ended up being exactly the same. Using another example, the stress response that has evolved in humans gives us the ability to fight or flee when faced with danger. Chemicals including cortisol and adrenalin help kick start the body—pushing blood towards the major muscles to give a person strength. But the exact same stress response kicks in when a person imagines danger, also producing cortisol and adrenalin and pushing blood around the body. Published research shows the same chemistry is produced regardless of whether the danger is real or imagined. These findings indicate that what an individual imagines to be happening can actually be happening as far as his brain is concerned.

Our bodies and emotions react to what we imagine with our minds, fear for instance. Our mind can cause a reaction to something that isn't even real—and only all in the imagination—that can even cause body temperature to rise and heart rate to increase. A person can change—his mind can go wherever his imagination goes by envisioning something else. But we need to learn how to harness the power of our imagination, so as to maintain a distinct line between realty and unreality. Imagine a training and education question that involves leaving or not leaving a tip for your waiter in a restaurant that has been designed to teach the concept of making change, such as the one at paragraph [0086]. Why would a person care about tipping a waiter who exists only in a participant's imagination—especially when there is no mention of a tip in the training question itself? If a participant is deeply immersed in the narrative of the question, and believes it to represent reality—for some short period of time at least—it could be that what he imagines is happening is actually happening as far as his brain is concerned. If leaving a tip does become an issue to consider in his mind—then making change in a manner that facilitates a reasonable tip could matter as well—and could become a consideration regarding the concept of making change. This is where imagination becomes of even more interest. Many experts question whether or not imagination can really be taught. Some states have begun testing creativity in their schools. Many experts believe that creativity itself cannot be taught, not directly. But certain habits, behaviors and strategies associated with the creative process can be promoted. In the example at hand, if a participant is already immersed in a good question (or a movie, book, or even a video game for that matter), and he thinks to himself “I can do that question differently”, would show that he already has an active imagination. Research suggests that it is possible to prime the mind for creative ideas to emerge. Standardized testing encourages conforming, rather than valuing the trait of thinking differently. It has never been more important to arm people with the skills for creative thinking. The first participant to respond to the question using the $10.00 bill and the $5.00 bill—anticipating that the $5.00 bill can then be changed into five $1.00 bills—has imagination, and is thinking outside the box, and shows that it is possible to have people experience an unreal environment as being fully real, and pushes the limit of what people can experience, and believe to be real. It also allows us to investigate how experiencing things as being real can affect other aspects of perception—personal character traits such as empathy, for example. That is the type of mind that can harness the power of imagination. That is the type of participant that can use his imagination to modify, expand, and/or change the original concept introduced, making level two processing all the more beneficial for himself and for all the other program participants as well, and clearly promoting the program's “intentionality” aspect.

During normal daily conversations between co-workers regarding a specific concept, for example, much of the data, information, and knowledge that is generated is not documented because there is no reason for it to be documented, it is not relevant to the matter at hand, there is no procedure in place to see that it is identified, recorded, or documented, it does not involve a sender and a receiver, or for any of a number of other reasons. Therefore, such communication never gets into a company's big data that could be turned into useful knowledge, biometrics, cognitive informatics, and/or analytics. Through the technology disclosed herein, a greater amount of communication can now be identified, collected, documented, and analyzed—including mind-to-mind and brain-to-brain communication—because this new method of workplace thought-directed cognitive linkage can include an entire workforce in the same conversation; and it can take place in varying real time. Imagine the improvements that can be made to an education, training, and brain augmentation program like this one if the communication that was previously allowed to drift away or was unused can now be re-directed into AI, machine learning, big data and cognitive analytics, and IA. Adding a single word to the narrative, or another preference element—or even another preference element optimal choice to a variable, can change the dynamics of the conceptual conversation—and maybe even expand it or introduce a brand new concept—altogether.

Every variable is eventually presented to all program participants in real time, and/or in varying real time, and they all create their own version of thought-directed simulated reality associated with that variable. At the time they are creating their final responses in varying real time while interacting with the other participants—possibly changing their initial response, or even better expanding the concept originally presented to improve the education, training, and brain augmentation part of the program so participants learn more—as they are both learning and teaching. This is all made possible by the fact they are linked together with all the other participants—cognitively and conceptually in varying real time. This linkage technology creates a new form of brain-to-brain conversational interface that in turn becomes an integral part of a new form of computing device powered by thought that can even generate, capture, collect and analyze implicit learning and knowledge and other forms of unconscious communication—even mind-to-mind communication—that could ultimately include program participants, customer program participants, and individuals having a customer relationship with a program participant.

Interfaces of the future will put more focus on conversational commerce by engaging more directly with their customers, and through back and forth conversation with them will find a product that matches what they are looking for. This trend will serve as a powerful force in bringing new conversational authentication methods into mainstream use, and will further validate using cognitive logon variables for authentication/access management processes. Commerce needs to become more conversational in order to remove many of the digital barriers that exist between a potential customer and the business. Current website design in general is not beneficial in many regards and many companies feel they are not achieving the sales success they anticipated, and websites are expensive to maintain. They also feel that potential customers should be able to message directly with them back and forth regarding the brand information they need to complete a purchase. AI will learn and improve in a new age of Ecommerce that adapts its responses based upon the context and nuances of customer inquiries. Many companies feel they are losing control of their sales because of their sales partners, for instance, when more information needs to be shared with a potential customer. The brand is relying on a distributor's sales people to provide it, and they may be responsible for selling many other brands at the same time. Some of these companies are considering taking the sales and marketing functions back in-house putting the sales process back under their control and supervision. How a person shops is far removed from how most people read—it's dynamic, non-linear, and open to whims and distractions from the text presented on a website. Communication is key, and the more kinds of communications that can be discovered leads to more ways to engage a customer's interest. The technology disclosed herein promotes these considerations. This concept fits nicely with direct to consumer Ecommerce brands—products and services that are financed, designed, produced, marketed, distributed, and sold by the same company. In the old days, many of these functions were done by wholesale partners and distributors leaving them with the larger piece of the revenue. In the future direct-to-consumer brands will keep all the revenues. Some forward thinking individuals are suggesting that a digital layer built into the human brain represents the best way to merge computers with our own grey matter. This allows humans to communicate with computers directly, and will increase the level of bandwidth for greater amounts of communication to take place at the speed of thought—among other advantages. They are suggesting that this digital layer be created through implantation of some type of computer chip directly into a human's brain, or through attachment to electrodes, for example. Many of them agree that multi-factor authentication might best be accomplished by using a biometric feature of a user, such as his fingerprint, and behavioral biometrics on a continuous basis as a second layer—since we are already practically attached to our phones and other computing devices that easily facilitate these types of authentication methods—while at the same time facilitating the advancement of conversational AI. The various thought-directed technology disclosed herein, that includes the thought-directed cognitive/conceptual linkage [0076], the thought-directed simulated reality initiated [0077], and the thought-directed user interfaces [0078,0079, and 0080] create a cognitive/behavioral digital layer that can provide the benefits previously stated and additional ones without requiring the implementation of a chip or special brain reading electrodes. This technology facilitates the creation of a new type of organic computing device [0025], new types of brain-to-machine and brain-to-brain interfaces [0077] built around a new type of operating system powered by human thought [0023], that utilizes new types of thought-directed user interfaces that initiate a new method of cognitive/conceptual linkage between a computer's system and a program participant, and between program participants themselves to deliver a new type of workplace brain/cognitive education, training, and augmentation program. Taken as a whole, these features will create a closer merger of biological intelligence and digital intelligence, a connection that includes consolidating one's self with his digital identity for global identity purposes. More importantly, these features will leverage AI to enhance human intelligence, rather than replace it. It will allow each business to develop its own specialized in-house operating system that consolidates its workforce through a telecommunications-enabled thought-directed linkage that can potentially accomplish world changing innovation.

Leading computer software companies are always looking for productive and profitable ways to disrupt the way people work today to learn more about the intent of a particular user or customer, as he uses his laptop or mobile phone to make an online purchase, for example. The more companies communicate with a customer and keep his attention, the more they can learn about a customer's intent and the better it is for personalization to learn how to engage consumers on their terms. The technology disclosed herein will allow a company to more closely integrate its workforce with its customers in new and meaningful ways. The technology disclosed herein provides opportunity to add value to the company while participants interact with the computer system each day. One new innovation that makes that possible is the recent introduction of cognitive/behavioral biometric identity management/authentication processes, made possible by advancements in the technology arena, and in continuous and risk-based authentication mechanisms. Passive behavioral biometrics and analytics alone, for instance how a user holds his mobile phone cannot match the benefits that can accrue from capturing a consumer's thought-based biometrics that includes capturing unconscious and associated conceptual communication and creating analytics that can provide real insight as to how and why a customer might use some of a company's other non-mobile phone related products or services; that could be ascertained by focusing on the transfer of category—level knowledge organized according to conceptual goals. Advances in technology and changes in necessary workforce skills have made the ability to think critically more important than ever before. Numerous studies have shown that critical thinking, defined as the deliberate use of skills and strategies that increase the probability of a desirable outcome, can be learned in ways that promote transfer to novel contexts.

Each person brings strengths and weaknesses to the workplace and to any type of workplace training program; potentially even more importantly, they also bring their own memories and implicit (unconscious) memory with them as well—comprised of their unique procedural and category-level knowledge, that they may not even know they have and/or may not be able to articulate in words, that may or may not work its way into the company culture as time goes on. Effective exercises must be both adaptive and novel to provide superior brain/cognitive training and augmentation. Training exercises must be set at levels that challenge the participants, but not so high that they discourage them. As a participant's cognitive skills improve, challenges must change. The most effective learning methods shape the brain's response properties progressively and adaptively. This fact is helpful in that as certain cognitive skills improve as a result of the education, training, and augmentation program this improvement is reflected over a period of time as it relates to a participant's cognitive/behavioral biometric fingerprint, so AI and machine learning driven authentication and authorization processes based on cognitive/behavioral biometrics can adjust over time. Some of the most successful cognitive training introduces novel tasks that force the brain to process information in new ways, and this is accomplished by the method disclosed herein by having participants involved in the program in multiple capacities, so they leave their mark on it. So they own it. The technology herein introduces multiple levels of difficulty that can provide appropriate challenges in a broad range of cognitive skills, allowing augmentation to be achieved at all skill levels. The human brain remodels itself to tackle new tasks.

Today may prove to be the best time to unlock the value of a businesses' workforce, and correlates with the massive changes that will define how business will be transacted in the coming years including what may become the norm—direct to customer Ecommerce brands—whereby in-house employees perform the sales functions that distributors currently perform. Employers are hungry to empower their employees to transform their organizations in this rapidly changing work environment. This involves empowering them new skills, knowledge, and learning, not just giving them new job titles and descriptions. Making change almost always involves having to address multiple objectives. The “modern workplace: has already arrived. Employees can have unprecedented access to data, they enjoy flexible and mobile ways of working, using digital tools that liberate rather than constrict them. They communicate and share knowledge seamlessly—not just across a physical office, but potentially across the world in diverse and internationally distributed teams. In this modern workplace, business leaders use technology to harness the collective ingenuity, creativity, and critical thinking of all employees. Hierarchies and silos within organizations are being dismantled and collaborative teamwork is becoming part of the culture. When work becomes a thing you do—and not just a place where you go—agile, data-driven and customer-centric cultures take hold. Great ideas are implemented, new products and services can be created and workers can become much more productive. The principles of the modern workforce can be applied in unexpected ways and places, big and small. A modern workplace, if becoming a digital enterprise, can generate immense opportunities if indices are changed, employees empowered, technologies embraced, and data protected. It's time to leverage digital experiences and tools to unlock the value of workforces to help them do their jobs better by re-engaging them in their work and transforming the workplace environment itself.

In the modern workplace, employees have the capability to work flexibly and productively, and they are supported by leaders and cultures that help them succeed in this dynamic environment. Many working professionals do not believe their organizations invest sufficiently in culture development, and feel their co-workers are managers not open to new ways of working. Many CEOs feel creativity is the most challenging skill to recruit and retrain in employees. In order to succeed in tomorrow's economy where productivity will be a given, they need to solve this problem by unlocking the creativity of their employees and then infusing that ingenuity into their company/s products, solutions, and business strategy. One of the ways to drive creativity in a workforce is to empower collaboration for a team-oriented workforce, where employees feel vested in the growth and performance of the company—and this goes beyond meetings and brainstorms. Employees in the modern workplace should be empowered with the right technology to succeed in this environment, allowing creativity and collaborative work wherever they may go. At the same time, it is important to ensure that the company's data is secure and protected, while streamlining management across users, devices, and services on a single platform.

Innovation is not confined to blockbuster disruptive products and services. Disruptive innovation is represented in the emergent phase—and is common in technology businesses. The growth category is the key stage for establishing position in a market and/or establishing a product's position. The maturity stage of a product life cycle shows that sales will eventually peak and then slow down as a market becomes saturated, or stagnation sets in as there are fewer and fewer new customers. The product or product line has already reached widespread acceptance in the market in relative terms. The declining stage is when a company or product dissolves as a result of negative growth. The beginning of the end for a product or an entire business. The end of life stage for a product or a business represents the termination of a product or product line, or market entrant that can no longer compete or remain a viable entity. The single most important act of strategy leadership is to select the innovation vector upon which the company will develop its sustainable competitive advantage, and concept expansion and category extension are critical considerations. Implicit learning goes on every day in an organization—but is rarely brought into the sight of those in the organization who have the power to make promising innovation happen. The technology disclosed herein facilitates the continuous delivery of innovation because the technology disclosed can involve a company's entire workforce, allowing all of them to be working on a large number of new concepts at the speed of individual and collective thought that has the power to raise the product development IQ of its workforce, increase productivity, and that can create a new company culture, whereby the delivery of new innovative products and services become a daily business focus, rather than focusing only on specific deadlines for delivery of a specific new product.

The cognitive unconscious refers to research in psychology that reveals the impact of unconscious mental structures and processes on the individual's conscious experience, thought, and action. Research on perceptual-cognitive and motor skills indicates that they are automatized through experience and may eventually become unconscious. Unconscious conceptual communication generated through the cognitive linkage established for the training program, can involve the cognitive unconscious. Events can affect mental functions even though they cannot be consciously perceived or remembered. Cognitive psychology comes in various forms, but all share an abiding interest in describing the mental structures and processes that link environmental stimuli to organismic responses and underlie human experience, thought, and action. In this matter, cognitive theories are distinct from biological theories, whose conceptual vocabulary is limited to the structures and processes of the brain and other portions of the nervous system and from the approach of radical behaviorism which thinks of the behaving organism as a “black box” whose internal workings, biological or cognitive, can remain unknown. Recently, cognitive psychologists have joined colleagues from anthropology, neurobiology, computer science, linguistics, philosophy, and other fields to form cognitive science, an interdisciplinary effort to unravel the mysteries of the human mind.

A concept is an idea of something formed by mentally combining its characteristics—a special combination that has a particular meaning. An abstract concept is an idea that people can understand that has no physical form. The ability to identify, understand, and communicate abstract concepts is a fundamental element of human intelligence. It is a mistake to think that all abstract concepts are not real as they can be documented with evidence. Abstract thinking is based on concepts, principles, and relationships between ideas and objects. Processes of learning and the transfer of learning are central to the understanding of how people develop important competencies. It is especially important to understand the kinds of learning experiences that lead to transfer, defined as the ability to extend what has been learned in one context to new contexts. Understanding abstract concepts requires one to comprehend the relationships between objects as well as the objects themselves. Transfer of knowledge goes far beyond simply repeating memorized material, but to be able to take old knowledge and experience and apply this old knowledge to a new concept and being able to use both the new and old knowledge to solve a problem never encountered before. Despite remarkable advances in AI and machine learning, two aspects of human conceptual knowledge have eluded machine systems. First, for most interesting kinds of natural and man-made categories, people can learn a new concept from just one or a handful of examples, whereas standard algorithms in machine learning require tens or hundreds of examples to perform similarly. Secondly, people learn richer representations than machines do, even for simple concepts, using them for a wider range of functions, including creating new exemplars, parsing objects into parts and relations, and creating new abstract categories based on existing categories. An educational and training program that focuses on concepts promotes learning with understanding. Research on cognition has shown that successful learning involves linking new knowledge to what is already known. All knowledge consists of concepts, defined as perceived regularities in events or objects or their representation. A central challenge is to explain these two aspects of a human concept level learning: how people learn new concepts from just a few examples—and how people learn such abstract, rich and flexible representations. An even greater challenge arises when putting them together—how learning from such sparse data can produce such rich representations. This can partially be attributed to combining parts and sub-parts in new ways. The human capacity for one-shot learning is more than just classification—it can include a suite of abilities, such as generating new examples of a concept. The human productive capacity goes beyond generating new examples of a given concept. People can also generate whole new concepts. Despite a changing artificial intelligence landscape, people remain far better than machines at learning new concepts. The principles of compositionality, causality, and learning to learn will be critical to building machines that narrow this gap. Capturing how people learn all these concepts is a long-term goal. Applying this approach with other types of symbolic concepts looks promising, such as the technology disclosed herein, which transforms traditional education and training methods and creates a new and different way to accomplish conceptual communication through thought-directed simulated reality. Probabilistic computing systems and other programs could capture these richer aspects of concept learning and use, but only with more abstract and complex structure than the programs have thus far. The newest research shows that young children use various types of thinking to learn their first language that may not be specific to language at all—such as the ability to classify the world into categories (people or objects for instance) and to understand the relative ongoing things. These capabilities coupled with a unique human ability to grasp what others intend to communicate, allow language to happen. Through listening, a child learns patterns of usage that can be applied to different sentences. Grammatical structure can make as strong a contribution to the meaning of an utterance as do the words themselves. Conceptual communication involves the ability to analyze hypothetical situations or abstract concepts to compile insight. Conceptual thinkers have an astute understanding of why something is being done. They can think at an abstract level and easily apply their insights into the situation. The foundations for critical thinking concepts are to us like the air we breathe. Yet, only when we have conceptualized a thing in some way, can we think about it. Nature does not give us instructions in how things are to be conceptualized. We must create that conceptualization, alone or with others. We explain one idea by means of other ideas. So, if someone asks us what a friend is, we might say “a person whom one knows well and is fond of.” If that person asked us to say what it means to “know someone well”, we would respond by introducing yet further ideas or concepts. Humans approach virtually everything in experience as something that can be “given meaning” by the power of our minds to create a conceptualization (and to make inferences on the basis of it hence to create further conceptualizations). We do this so routinely and automatically that we don't typically recognize ourselves as engaged in the process. In our everyday life, we don't first experience the world in “concept-less” form and then deliberately place what we experience into categories in order to make sure of things. Every act in which we engage is automatically given a social meaning by those around us. To become a proficient critical thinker, one must become the master of his own conceptualizations. He must develop the ability to mentally remove this or that concept from the things named by the concept, and try out alternative ideas and alternative names.

Companies have the tools to harness the power of this new cognitive digital era, the question is how to empower employees to seize new opportunities in the digital economy. One way to seize opportunity is to share more information with their workforces, business partners and suppliers. Another is to further empower employees with all the tools they need to achieve maximum productivity. The three-level process disclosed herein can achieve both of these objectives and many others. This process involves a training level where the participants are treated purely as students involved in a brain/cognition education and training program, a level that allows program participants to collaborate with each other in the roles of teacher and student to create and transfer learning and knowledge, and a third level that allows participants to create and innovate using the things they have learned in the first two levels. These three levels enable basic concept transfer, expanded conceptual transfer, and new conceptual innovation. Recent research shows that nurture counts as much as nature in success. Scientists have found consistent evidence for the beneficial effects of education on cognitive abilities. The effects persisted across the lifespan, and were present on all broad categories of cognitive abilities studies. Education appears to be the most consistent, and durable method yet to be identified for raising intelligence. So many different kinds of nurture matter in determining success. Effort matters, education matters. And social environment matters. Americans discount these factors too much. The country would be a better, richer, more equal place with less emphasis on natural talent and more on human potential to improve each other and themselves.

The invention disclosed herein relates to a dedicated workplace brain/cognitive education, training, and augmentation program directed at improving both biological and technical functioning, and the thought-directed cognitive linkage involved in the program's communication infrastructure. The success of the program will be measured by the amount and quality of the education, training, and augmentation accomplished; which to a large degree will serve as a proxy for the success of the technology disclosed herein. The program's communication processes, and the program's delivery system—the semitransparent, thought-directed method of cognitive linkage established between and among program participants that partially facilitates the program's three level process affects what learning, information, and knowledge is transferred as well as how much learning, information, and knowledge is transferred—both of which are also determining factors of how successful the augmentation element of the program is. To a great degree, the measurements of the success of the program are the same measurements necessary to measure the effectiveness of the program's infrastructure—how much education and training was delivered and how much that education and training has found its way into the company's culture that can positively affect the company in some way. If the program can have an impact on objectives that represents quantifiable results—and documents quantifiable return on investment, and potential quantifiable return on future investment. The technology disclosed herein facilitates the transfer of learning and knowledge between and among program participants in new ways through the cognitive linkage that may involve learning and knowledge transferred directly from one participant to another, (e.g. that can include brain-to-brain communication), and these new types of communication can be accommodated through the linkage and can be used to introduce new concepts to the workforce that a business deems critical to its success. Human beings are the world's experts at mind reading. As compared with other species, humans are much more skillful at discerning what others are perceiving, intending, desiring, knowing, and believing. Humans have the ability to participate with others in collaboration activities, with shared goals and intensions; shared intentionality. This theme is a building block of technology disclosed herein.

This new type of cognitive and conceptual workforce linkage is comprised of two components. Component 1 (which carries channel one and two communication), comprises a computing system/telecommunication component—the computer system's hardware infrastructure and software (physical media) that generates and delivers a cognitive variable to a program participant(s) through one of the thought-directed user interfaces and performs other associated program functions such as receiving, recording, and analyzing participant explicit responses (that comprises a new type of brain-machine interface and collective computing device). Component 2 (that carries channel three and four communication) comprises what may be considered to be a telecommunications-enabled supplemental communication component designed to transmit certain types of associated conceptual communication generated by a participant, and between and among other program participants that is not explicitly stated, but is carried through the linkage with a participant's response that has an existence separate from the explicit response. This communication concerns why a specific preference was generated that would not normally be identified and/or collected as part of a system's regular telecommunications processes but that now exists because of this new method of cognitive linkage (that also comprises a new type of brain-to-brain interface). The two components taken together, form cognitive connections and create communication channels between a computer system and a program participant, and between and among program participants that comprises a brain-to-brain interface that facilitates the generation and transmission of more—and more types and kinds of communication, learning, and knowledge. This new communication is initiated as a result of the simulated reality that is created in a participant's brain and mind. Component 2 also creates an artificial conduit, a new type of communication channel (i.e. the medium that carries a signal). However, it is an abstraction in that it ignores communication that other people or devices will be looking for such as the explicit cognitive and preference element responses that become part of a variable's cognitive/conceptual narrative that are transmitted through component 1. Component 2 is designed to identify and transmit arbitrary communication that falls outside the transmission capabilities of Component 1, for instance associated conceptual communication and certain other types of uncompressed communication being generated; that can now be identified, documented and analyzed because of the semitransparent thought-directed cognitive linkage and other technology disclosed herein. An accurate response to a variable that includes anticipated data from a participant demonstrates at least a threshold level of immersion into the environment of the simulated reality brought about by the cognitive narrative of a variable, and the participant's attention, perception, imagination, and verbal reasoning skills' that can create an accurate response credential or transfer credential. Such immersion even allows a participant to observe his own real time responses to the cognitive and preference elements of a variable and to affect the responses of other participants as they become involved with the same variable during level two processing, for example. In other words, the actions a participant takes during his immersion in the simulated reality will affect other participants similarly and/or simultaneously immersed in that same simulated reality that can be evidenced by the credentials they have to create to progress through the program. This supplemental communication component carries channel 3 and channel 4 communication as separate communication originating during a participant's immersion in the simulated reality that has been created, that is capable of increasing the education, learning, and knowledge that can be delivered as part of the program because it transmits more, and more kinds and types of conceptual communication. An abbreviated explanation of the process follows: (a) one of the program interfaces prompts a program participant with a cognitive variable (i.e. a question or mental exercise that is part of a challenge-response protocol) that is designed to initiate a thought-directed cognitive linkage process capable of transmitting communication from the computing device to a participant (channel 1 communication); (b) the conceptual narrative of the variable presented is processed by the participant using his attention, perception, verbal reasoning, and other cognitive skills to create simulated reality in his brain and mind that adds conceptual context to the variable that can be evidenced through certain responses made by a participant (channel 2 communication); (c) if the variable is processed by a participant at a threshold level or greater, simulated reality is created in the participant's brain and mind, and as he becomes more deeply immersed in the reality, communication and information of all types may be generated through the responses he makes that was not capturable before. It is important to recognize that the simulated reality has no explicit physical existence of its own—it is simply a thought in a participant's mind. Channel 3 communication can be attached to or imbedded in an explicit response made to a cognitive or preference element that is measurable, but has no real world physical existence of its own (see FIG. 2A) such as the “tip” concept that expands the original concept and that ultimately explains the reasoning and decision making. (d) as the participant's immersion continues to get deeper, the cognitive/conceptual linkage created is capable of generating and transmitting channel 4 communication that may take place between the program participants themselves, that can involve mind-to-mind communication that requires interaction between two participants—one generating the communication and one perceiving and receiving it. This type of communication is not supported by Component 1 of the cognitive linkage, as it has not been entered through any kind of input device. This communication can be analyzed, and may reveal feelings, intention, reason, goals, objectives, and additional preferences relating to a conceptual transfer taking place. This channel is distinct and is created and powered by thought, such as the associated conceptual communication associated with the responses that cannot be explicitly transmitted by Component 1. Looking at the abbreviated explanation in deeper detail; the conceptual narrative of the example variables at paragraphs [0086, 0101, and 0123] represents channel 1 communication generated by the telecommunications component designed to activate a participant's sensory brain regions that by his responses will initiate thought-directed cognitive linkage that will be established between a computer system and a program participant for program purposes, and that is eventually used to create simulated reality. Channel 2 communication is created when a participant thinks up and makes responses to the cognitive and preference elements of a variable that is transmitted through the linkage that has been created to be analyzed and recorded for program purposes—such as that of returning the correct amount of change. The response is made within the context of the simulated reality environment created. Channel 3 communication involves the UCC, ACC, and IDCPC (defined at paragraphs [0055 and 0068]) that accompanies the responses and exists separately from the explicitly stated cognitive and preference responses, but that is nonetheless associated with the responses as they travel through the thought-directed cognitive linkage. It represents quantifiable and measurable data, information, and knowledge, and other imbedded conceptual preference communication associated with the presentation of a variable. In this particular example, it also causes an expansion of the variable's concept to include a tip to the waiter which can be intuited from the bills used for payment. Channel 4 communication may be generated that extends the conceptual linkage further creating a new type of artificial conduit, that is even capable of creating linkage from a participant's simulated reality (and can be used to validate another participant's simulated reality), as can be evidenced when new program participants get involved with the expanded conceptual transfer of making change to meet multiple objectives. In other words, language comprises multiple layers of communication, and the meaning of a word or phrase must be analyzed within the context it is delivered in order to gain full understanding of its importance. The new technology disclosed herein facilitates a new method of capturing what is really being communicated; and gives new meaning to the concept of being “linked in”. The evidence of this conceptual transfer will be revealed as participants change their responses and/or previous responses to reflect new learning acquired through direct the communication that takes place between participants. The linkage is designed to generate and carry different types and kinds of communication separately (e.g. explicit learning vs. implicit learning), so they may be documented and analyzed separately in order to be able to attach each type of communication to the stimulus that actually causes that communication. Understanding why a certain preference was demonstrated could lead to more effective predictive analytics that could lead to behavioral modification opportunities, for example. The cognitive linkage that carries channel 2, 3, and 4 communication can also be considered to be thought-directed and powered by thought because the linkage cannot be extended, or a variable's concept modified, except through a program participant's thought processes and responses. A participant's response can introduce a new concept that can indirectly change another participant's simulated reality that can only exist in a participant's mind. A response initiated in his own simulated reality can affect another participant's simulated realty by this new method of cognitive conceptual linkage that has no tangible physical existence of its own and cannot be seen or touched. Published research shows that perceptual and conceptual representations are partially based on the same brain systems. Accurate responses cannot be made and certain types and kinds of communication cannot be generated unless a program participant becomes immersed in a variable's simulated reality deeply enough. Some types of unconscious and uncompressed communication such as ACC, and IDCPC can extend the linkage. Variables are designed to generate multiple types of identifiable communication, and that feature is instrumental because certain types of implicit learning, knowledge, and ACC must be identified before it can be segregated, documented, and analyzed. In that regard, measurement is everything—nothing exists until we measure it. Empathy can be measured as a character trait and empathetic understanding can be improved, once it is measured for example, and it must be measurable in order to be measured.

The structure and cognitive narrative of the variables, a participant's perception and verbal reasoning skills utilized in creating thought-directed simulated reality, and the cognitive linkage established to deliver the program together in combination generate differing levels of communication and different types of communication by and among program participants. Moreover, language itself is a many layered structure: it helps one understand one's own thoughts as well as those of others. Today, there is simply no better access to the experiences of others outside of language—such as the cognitive/conceptual narrative of a variable—that can stimulate and initiate associated conceptual communication. The technology disclosed herein enhances this by facilitating new alternative types of communication to be generated and transmitted. The technology disclosed herein can help increase knowledge regarding the real connections between thought and language. Generally, there are two main schools of thought regarding language. Some scientists believe that the mind can exist without language, while others argue that language produces mind. The technology disclosed herein also furthers knowledge in this area by demonstrating that adding additional specific conceptual narrative to a cognitive variable can result in a participant generating a greater amount and more types of quantifiable communication between and among program participants. Because the design of the variables and the cognitive linkage provide great flexibility, it is easy to add conceptual narrative that allows novel conceptual categories to be created, and which provides the ability to manipulate task, stimuli, category, and structure to assess the role of each in one's ability to acquire a concept and apply it in a new situation. The design of the variables and linkage creates the opportunity for a participant to demonstrate more types of communication and deeper learning that can someday be directed toward affecting customer behavior and preferences, the expansion of neuro-technology for non-medical medical purposes, and that will allow companies to revolutionize advertising, marketing, and even computer learning. The technology disclosed herein will allow a company to more closely integrate its workforce with its customers in new and meaningful ways. Being able to identify and document that uncompressed conceptual communication, imbedded demonstrated conceptual preference communication, and/or other types of associated conceptual communication has taken place may provide proof that a concept has in fact been transferred to a participant, and that the concept can be further transferred through that participant to additional participants who can then be involved in furthering the business objectives that are the ultimate goal of the program.

### SUMMARY

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

Upon successful completion of a computer system's base multi-factor authentication/access management process that includes a cognitive/behavioral biometric component, designated authorized users become participants in a supplemental brain and cognitive training and augmentation program that requires them to respond to a set of one or more “cognitive variables” that serve as the basis for a challenge—response protocol that drives the program disclosed herein as the invention. As used herein, the term “cognitive variable” means a question or mental exercise that may be metaphorical in nature, a mental exercise that could be part of a cognitive game or puzzle, or other type of challenge-response protocol that can be used to create thought-directed simulated reality and that is capable of initiating the cognitive linkage between a computer system and a participant, between participants, and between a participant and a company's customers and big data; that (a) can be documented, measured, and analyzed, (b) is presented through one of the thought-directed user interfaces as part of the three level process, (c) involves declarative sentences and has at least one cognitive element and one or more preference elements, (d) includes contextual/conceptual narrative that describes a variable concept and includes the thought-directed responses made to the cognitive and preference element(s) by the participant(s), (e) which forms a basis for initiating thought-directed simulated reality, (f) requires cognition—either conscious or unconscious or both in creating a response and (g) that may require the use of motor skills beyond a simple multiple-choice response, and (h) can be used as part of a conceptual authentication protocol. The response to a preference element may be considered to be a cognitive element response, if the accuracy requirement is also met. Examples of cognitive variables include fill-in-the-blank, short answer, or other questions or exercises measuring a participant's verbal reasoning, quantitative reasoning, visual reasoning, long term and/or short-term memory (working memory), and other skills. Underlying the conceptual narrative of a cognitive variable is the idea that consciousness involves self-reference. In other words, in order for ongoing experience, thought, and action to become conscious, a link must be made between its mental representation and some mental representation of the self as agent or experiencer as well.

### BRIEF DESCRIPTION OF THE DRAWINGS

The invention's features, aspects, and useful effects will be more apparent with the description of the advantageous embodiments and the illustrations in conjunction with the attached drawings, of which:

FIGS. 1A and 1B comprises a flow diagram illustrating the important core steps of the Three Level Process defined at [0081], and explained at more detail at paragraphs [0085-0170] and [0171-0183], that enables the invention herein illustrated by example and not limitation.

FIGS. 2A and 2B illustrates a detailed partial view of Level Two processing that includes a variable re-presentation process that also utilizes some Level One processing that has already taken place, explained in greater detail at paragraphs [0184-0196]. It represents the most obvious embodiment of the invention.

### DETAILED DESCRIPTION

Objects, technical solutions, and advantages of the invention will be easily understood by reference to the following description of embodiments when read in conjunction with the accompanying drawings. The following terms are necessary to further understand these embodiments:

“Accurate response criterion algorithm” means a special type of adaptive algorithm that is designed for use in conjunction with deterministic and probabilistic computing and big data mining processes and analytics.

“Associated conceptual communication”, (ACC), thought-directed associated conceptual communication, “associated cognitive/conceptual communication” or “thought-directed shadow associated conceptual communication”, means the anticipated and unanticipated identifiable, quantifiable and unquantifiable data, information, and knowledge, and other imbedded demonstrated conceptual preference communication associated with the presentation of, and the corresponding cognitive and preference element responses to a specific cognitive variable presented to a program participant through one of the thought-directed user interfaces that has been transmitted through the semitransparent thought-directed cognitive and conceptual communication linkage established during a concept transfer, that can reflect the cognitive and conceptual reasoning and decision making that results in the creation of a given response, and the meaning for the language used in a response, that may be perceived by means other than the known physical senses of sight, hearing, smell, taste, or touch. Thought-directed shadow associated communication represents a new type of ACC made possible by the technology disclosed herein that can occur during level two processing during a period of shared simulated reality between participants, whereby the participant who originated the response that is meant to convey mental content and other information in the form of thought is transmitted through an artificial conduit that is received by another participant that represents a reverse projection of the reasoning and decision making the originating participant used in his response, that can activate certain regions of a receiving participant's brain during the variable re-presentation process as he seeks to understand the meaning of the response language used. The existence of this communication can be validated by the participants involved by empirical evidence such as a recorded response, or by another acceptable attribution method. The cognitive linkage method disclosed herein allows communication to be transformed as it is being transmitted, for example the implicit knowledge of one participant can become explicit knowledge that can be learned by another participant. Such data, information, learning, and knowledge can involve explicit, implicit, and/or tacit learning and knowledge, conscious and/or unconscious learning and knowledge, certain innate and intuitive learning and knowledge, and other associated conceptual communication such as uncompressed conceptual communication (UCC), imbedded demonstrated preference communication (IDPC), and other associated information in compressed or uncompressed form. This type of communication may include the unconscious conceptual communication of learning transmitted outside of a participant's conscious awareness (i.e. implicit learning that a participant may not be aware that he has), communication generated during the participant's exhibition of certain cognitive skills that contribute to the cognitive and preference element responses, for example the quantitative reasoning skills that allow a participant to perform addition and subtraction in his head, associated cognitive skills such as “perception” that may be hard to quantify, certain innate knowledge and/or intuited thought, and intangible character traits such as “empathy” that can impact a workplace's culture in positive ways, that may be transferred as part of a conceptual transfer such as that demonstrated in the example variable at paragraph [0123]. It also includes mind-to-mind thought-directed communication between two or more participants during level two and level three processing that occurs, involving a participant who originates a thought, idea, or concept that is intuited by another participant involved in a conceptual transfer relating to the same variable. For example, participant learning and knowledge that may be documented as a cognitive demonstrated preference (see paragraph [0058]. It may also include the metaphorical thought that may be generated during a concept transfer stimulated by the conceptual narrative and thought-directed simulated reality. A program participant may not be aware that this communication has taken place. It may also comprise shadow associated conceptual communication. Certain forms of communication, while quantifiable, may not be immediately documentable, or may not be documentable until other specified actions have taken place first. The thought-directed interfaces and the simulated reality generate, and the thought-directed linkage transmits communication in a manner that allows different types and kinds of communication to be measured separately, and that allows it to be distinguished from the behavior that may precede, accompany, or follow it. Because this communication may be distinguished from behavior, it may reveal deeper thinking, including intent, attitudes, and preferences for example, which if identifiable, quantifiable and documentable afford the opportunity, if usable, to influence and possibly alter behavior. As important, until now some of the new types and kinds of communication disclosed herein represented data, information and/or knowledge that could not be collected as part of a company's big data, because they did not exist in explicit form and/or in a machine recognizable format. Consider the following analogies as further explanation of shadow conceptual communication. Assume that you are driving south toward a town on a four lane divided highway, and you see a road sign that states the current speed limit of 70 mph is reduced ahead, and very soon thereafter see a sign that states “Speed Limit 65”. At nearly the same time, you notice the back of a road sign on the other side of the highway facing the opposite direction that you can't read, but that can be seen and read by drivers driving north towards you. Using your perception skills, you make an educated guess that can be validated that the sign most likely states “Speed Limit 70”. Both you and the next car you see passing that sign on the other side of the highway are processing a change in the speed limit in real time temporarily creating a form of shared reality between you, but each of you is affected in your own way; one of you is required to slow down, and the other is given the option of speeding up to 70 mph. Both of you are adapting to a speed limit change and you are able to act independently to achieve that change. The words of the two signs are different and they have different meanings, but they also share other characteristics; they both represent distinctive cognitive communication taking place within a temporary state of shared reality and context, and that when considered together, are capable of initiating a special form of perception. Drivers going both directions can figure out what the sign across the highway from them means, not because they are able to actually see and read the words of that sign at that moment using their known physical senses of sight, hearing, smell, tasting, or touch, but rather by reading the words on the sign they can see that causes a disruption, and then mentally processing a reverse projection of what those words actually mean, that involves understanding the various implications involved for the other people who are reading these signs who temporarily share a new relationship for conceptual transfer purposes, based not on a broad overlap of features, but by the similarity of the conceptual goals involved, that creates a new novel category for concept classification purposes. Recognition of the existence of this shadow communication has important implications for AI and machine learning because it introduces a two-step process—one step that includes the original participant and a second step involving a participant who processes a reverse projection of that communication. Consider the following example, using a church's steeple and its roof. The workers who constructed the church see the steeple as a “steeple”. A person driving by the church on a bright sunny day who sees the steeple, and the resulting shadow of the steeple on the church roof, recognizes that the dark shadow is a reverse projection of an object standing between the sun and the roof that blocks a section of the sunlight from hitting the roof; and that the shadow that casts a dark spot on the roof represents—and is shaped like—the church's steeple. The shadow comes and goes depending upon the sunlight during the day and is not visible when it is dark during the night. So, it should be easy for the person to understand that the steeple, and the shadow of the steeple have a separate existence. The steeple exists all the time in the real world—it has a real existence even when it cannot be seen at night, because it is still there. The shadow exists only at certain times. If he drives by the church at sunset, he can see the steeple, but he cannot see its shadow. He can see the shape of the steeple when the shadow exists, maybe even get an idea of its size, but he can never know everything about the steeple using only the known physical senses because it only comprises a shadow. The shadow cannot be seen if he is looking only at the steeple, and the shadow may disappear while the steeple remains where it is and can be seen. The shadow comes and goes while the steeple remains in place, whether it is visible or not. He can also see both of them at the same time. The shadow, when it exists, represents communication (and shadow communication) that the steeple exists. The shadow will not appear if the steeple is not there. The shadow therefore cannot be considered a 100% accurate representation of the steeple in the same sense a painted scale model might be because it is not available to one or more of the known physical senses at all times. In other words, the steeple and the shadow of the steeple share common characteristics, but also exhibit differences. The steeple may not be casting a shadow at a particular moment in time, but if it is, there is substantial communication concerning the steeple being generated that has not been explicitly stated, including the major fact that the steeple still exists; and that communication may be received by a person driving by the church at that moment in time who is willing to receive that communication; he can know that the steeple still exists without even looking to see if that is true, because he is seeing its shadow. A participant who willingly changes a prior response to match that of another participant during level two processing, who has already received an accurate response credential and/or a transfer credit for his previous response that makes him eligible for further advancement through the program, (See [0057]), who is not obligated to do so and has no other apparent reason to do so, has perceived the meaning of the words of the other participant's response by means other than through the known physical senses, and his actions provide empirical evidence of brain/mind to brain/mind communication. A follow up question or modification to the narrative language relating to the tip concept if structured properly, could provide further evidence through a response as to whether or not that was the reason he changed his response.

“Associated information” is comprised of, but not limited to, the specific anticipated quantifiable, measurable information associated with a specific user and/or a specific cognitive variable, the compressed and uncompressed data derived from the presentation of a variable to a participant, data derived and associated with the resulting responses made to the cognitive and preference elements of that variable, data relating to the credentials created during the three-level process, and/or historical data from the baseline database including information that may have been imported from another database that may be located outside the component.

“Cognitive credential” or “credential”, means an accurate response credential, or transfer credential, that must be jointly created by a participant(s) and the computer system, that is used for several purposes discussed in more detail, for example, at paragraph [0123]. An accurate response credential is created when an accurate response is made to a cognitive or preference element. A transfer credential is created when a conceptual transfer has been successfully completed. The credential may be the accurate response itself. The creation of one of these credentials evidences that the cognitive linkage exists. Credentials must be created for authentication/access management purposes, and they document a participant's advancement through the program.

“Cognitive demonstrated preference”, “conceptual demonstrated preference”, or “preference”, means a response made to the preference element of a cognitive variable involving associated information and/or associated conceptual communication, which allows a participant to reveal additional learning and/or knowledge that involves and/or could affect, or that could be affected by, the cognitive element of the variable in some manner. The response is translucently linked to a stimulus and may become a further stimulus itself in a cognitive way that makes it especially useful in big data analytics because it may include uncompressed conceptual communication, imbedded demonstrated conceptual preference communication, thought-directed unconscious conceptual communication, or other associated information that provides insight into one or more brain processes of a participant or customer program participant by means of neural coding and decoding information associated with a cognitive credential.

“Cognitive element” means that part of a cognitive variable's conceptual narrative (usually as part of a question and/or mental exercise), that requires a participant to demonstrate explicit/conscious learning and applicable cognitive skills relating to the cognitive variable concept by providing an accurate response. The response, if accurate, provides empirical evidence that the cognitive linkage has been established and that the participant exhibits at least a threshold level of cognitive function. It also evidences a participant's immersion into the thought-directed simulated reality. It also offers insight into one or more of the participant's brain processes through the neural coding and decoding measurements that take place during a response. The associated information collected as part of the response may also include evidence that the participant's response involves implicit memory, and/or other types of thought and/or learning such as associated conceptual communication, uncompressed conceptual communication, intuition, or innate learning. A preference element's response that meets the accuracy requirement may be considered to be a cognitive element response as well. A cognitive credential is created when an accurate response has been made to a cognitive element, and initiates further advancement through the three level process.

“Cognitive response” means the accurate, correct, or acceptable response to a cognitive variable presented as part of the three-level process that may include associated information, that is required in order to validate that a variable concept has been successfully transferred to a participant. A response can be technically correct, but not the desired response to the variable that is required in order to be considered accurate. Virtually any response being made as part of a cognitive test can be considered accurate if the purpose is to evaluate the cognitive function and/or mental alertness of the participant, and therefore all responses are meaningful to the evaluation process, whether correct, nearly correct, or incorrect. Therefore, the terms accurate, correct, or acceptable should be considered within the context presented. For example, an accurate response to the cognitive component of a variable might not match a participant's normal response time as specified at [0056] and would not reach the threshold level to be considered accurate. A response can be considered correct for one purpose of the program, and not for another.

“Cognitive training grid” or “grid” means a grid that can be used to identify an authorized user that can include plotting his cognitive/behavioral biometric fingerprint to distinguish him from other authorized users, plot his cognitive function in comparison to theirs, and to potentially identify a user who is cognitively impaired. Biometrics that have been measured before can be plotted (e.g. keyboarding skills), and new categories of measurable biometrics can be established, measured, and plotted (e.g. technological savvy). The grid can also be used to plot all kinds of analytics, such as the strength of the cognitive skills involved in the sharing of information between and among program participants during level two processing.

“Cognitive Variable” or “variable” means a variable as described at paragraph [0049], that may include a modified random cognitive logon variable that comprised part of a system's base cognitive/behavioral biometric authentication process that has been previously presented to a participant and is no longer usable in a computer system's base authentication process, a prototype cognitive training variable, a cognitive training variable, an inside cognitive variable built through the collaboration of program participants as part of level two or level three processing, an innovative thought-directed conceptual transition variable, or a new type of variable that can be used for conceptual authentication at [0064]. Its meaning should be considered within the context presented.

“Cognitive variable concept” or “variable concept” means the total concept or portion of a total concept that is to be communicated/transferred through the semitransparent thought-directed cognitive linkage established between and among program participants, that may involve explicit conscious thought and/or learning, unconscious learning through implicit memory in compressed and/or uncompressed form, and/or or uncompressed conceptual communication. Uncompressed conceptual communication, also referred to as UCC, can include various communication that is non-concept specific and unlimited in scope (and therefore may not be quantifiable). Thought-directed unconscious conceptual communication—a participant's implicit learning and memory that is not already compressed as part of a response to a cognitive or preference element or as associated information that is quantifiable, is limited to that conceptual communication which can be directly attributed to specific conceptual narrative included in the variable, making it quantifiable (i.e. able to be expressed or measured as a quantify because at least part of it has explicitly or implicitly been reduced to written or verbal representation). For example, a demonstrated preference involved in performing the arithmetic associated with a cognitive element response. Uncompressed conceptual communication, intuition, and innate learning can be transferred, but some of it may not be measurable or quantifiable. The initial variable concept is the main subject of the message that is to be conveyed by a specific cognitive variable through its contextual narrative and cognitive/preference elements. Every variable that is initiated by and through one of the thought-directed user interfaces has been designed and constructed to accommodate the transfer of a message (i.e a concept or a range of concepts). If the transfer is successful the concept or parts of it, will be extracted by participants from the contextual narrative and ongoing responses to the elements that will continue to expand and alter the original contextual narrative (and can also alter a stimulus at the same time) until level two processing is complete, and possibly into level three processing. At that time, the initial concept, or even better yet a range or concepts will have been transferred between and among program participants.

“Conceptual authentication”, “cognitive/conceptual authentication”, or “preference authentication” is a new type of conversational (natural language) cognitive “identification/authentication” access management protocol based on a new type of cognitive/authentication modality enabled by the cognitive linkage technology [0076], cognitive variables [0062], associated conceptual communication [0055], and simulated reality [0077]. It can be used to identify and validate a specific user initially, and continuously therefore during the three level process, and for other purposes such as tying a preference element response and imbedded demonstrated conceptual preference communication related to that preference element response to a single stimulus for validation purposes (such as situations involving mind-to-mind communication). It is a way to verify that the associated conceptual communication and a specific preference element response are attached. It represents the concept that in real life there is a link between providing a demonstrated preference and/or exhibiting a certain type of behavior in response to a stimulus that can be observed—because it is taking place in reality. It can be witnessed in real life. A new type of authentication modality is necessary for use in conjunction with simulated reality—and for communications from cyberspace in general for that matter—representational communication that can legitimately be attributed to a specific individual's preference as demonstrated during his immersion in thought-directed simulated reality, which could be different than the behavior that individual might exhibit in real life. In other words, it serves a reconciliation function—it attempts to reconcile cyber behavior with true intent, allows multiple layers of the words and language used in a response to be exposed—and re-aggregated, and relates closely to other new concepts disclosed herein such as varying real time, as an additional way to link multiple learning occurrences together. It represents a unique type of authentication modality enabled through the associated conceptual communication that is generated by making a cognitive element response and a preference element response to a cognitive variable while thought-directed simulated reality is operating. It is carried through the cognitive linkage, and could represent a truer, or less true, picture of the real intent, reasoning, and other preferences and objectives that can be used to provide actionable insights into what really drives things, such as consumer engagement and ultimately even innovation. It allows preferences to be indicated relating to a mental image that is intended to be used for advanced predictive analytics purposes, for example. This communication has an existence separate from the preference response itself—allowing other types of communication to emerge from dark data—such as the reasoning behind the preference demonstrated—which makes it imbedded demonstrated conceptual preference communication. It is now broadly known that human beings are far better at remembering and recalling visual memories than doing the same for text memories. An example of this is the use of images as part of identity authentication. Episodic memory can also be an element of one's continuous identity. For example, if the bills used for a purchase in a preference element invisible challenge response is deemed to be accurate, that response can also serve as a cognitive element response, and ties the cognitive and preference element responses together. The cognitive narrative of the example variable at [0123] allows this type of cognitive and conceptual identification/authentication modality to be created.

“Conceptual narrative”, “cognitive narrative”, or “thought-directed conceptual narrative”, means the narrative of a cognitive variable that has been designed to initiate a simulated reality that will be capable of stimulating communication and includes a participant's cognitive and preference element response(s) and certain associated information, associated conceptual communication, and other communication that may have been initiated in a participant's brain and mind by inference (such as reasoning). In other words, a variable's original cognitive narrative, and the cognitive linkage created as a result of the presentation of that variable, are both continually being expanded in multiple ways during the three level process. Cognitive variables are designed to serve as the stimulus for the creation of a mental image of a variable concept—an idea formed by mentally combining category knowledge that can be something seen, known, or imagined by a participant. The thought-directed conceptual narrative of a cognitive variable is designed to direct a participant's thoughts to general and/or specific details, facts, and information regarding a specific concept. Thought-directed simulated reality is an artificial interactive environment created by the participant in his mind and brain initiated by computer software that interacts with a participant's cognitive skills in such a way that a participant temporarily accepts it as a real environment, which allows it to serve as a basis for a conscious link between a participant and a concept. A participant's actions can substantially determine what happens in the artificially created environment, a feature that may ultimately determine the success of a conceptual transfer to another participant(s) through the semitransparent thought-directed cognitive linkage that has been created. The conceptual narrative (particularly the declaratory words and sentences, and the language relating to the cognitive and preference elements) is tantamount to using a wake word to get a participant's brain engaged.

“Customer program participant” means a customer that establishes a customer/partner relationship with a company that sponsors a dedicated workplace program using the linkage method disclosed herein, that consents to accept participant status, and agrees to the terms involved with such status; and includes individuals and other non-human workers having a relationship with a customer program participant that agrees to accept participant status.

“Data output” means data and information collected from the current logon attempt, or a previous logon attempt, including the number of credentials created and other data and information related to the three-level processing for a supplemental training session, and any other associated information and/or data that might be developed and used during that process and/or which may be sent for storage in a target storage area following completion of the process.

“Imbedded demonstrated conceptual preference communication” (IDCPC) refers to a type of communication that is imbedded in a cognitive or preference element response that involves conceptual knowledge, and may include a cognitive demonstrated preference (see paragraph [0058]). It is not explicitly stated in the response, but it can indicate intent, reasoning, other preferences, other objectives, and/or that could be used to provide actionable insights that drives such things as consumer engagement. This type of communication is considered to be a form of associated conceptual communication (ACC) and uncompressed conceptual communication. In making a preference element response, that may include mind-to-mind communication, the participant may be forced to utilize thought compression by having to choose from the available cognitive narrative options which may be limited by a variable's narrative. The imbedded demonstrated conceptual preference communication results from the thought-compression process that the participant uses when making his response, that may include special perception skills involved in identifying this communication, as it has no explicit representation. It represents thoughts created in a participant's brain and mind as a result of the participant's mental image of the narrative, or actions called for by the narrative. It can also be considered behavior—that can be explained and analyzed. This imbedded communication is transmitted through component 2 of the cognitive linkage as thought-directed cognitive/conceptual communication along with other communication related to the response, and can involve thought, learning, and knowledge regarding the concept for education and training purposes. This type of communication would normally not be unrecognizable to AI and machine learning processes and makes this new technology that is able to recognize this type of communication very significant. In addition, it forms a basis for a new type of conceptual authentication modality for use in a multi-factor authentication/access management system [0064]. Imbedded demonstrated conceptual preference communication represents a participant's reasoning and intentions relating to a specific demonstrated preference that is not explicitly stated in a demonstrated preference response, and it has an existence that is separate from the preference response itself. In fact, it can also serve as a proxy for other kinds of associated conceptual communication such as implicit learning, and may be included in mind-to-mind communication. The communication of a participant's implicit learning and knowledge regarding a specific concept may never exist in an explicitly stated form, because it represents the unconscious learning and knowledge acquired in the formation of skills and habits that takes place outside of a participant's conscious awareness that makes it non-verbalizable; yet it has a tremendous influence over how we look at the world. It impacts the unconscious processing of past experiences that influences our current thoughts, perceptions, and actions. (Such as electing to use a $10.00 bill and the $5.00 bill to pay for lunch in the example variable in paragraph [0123]. Because multiple types of communication can be collected from a single response, and can be measured separately, a concept can be expanded even without explicit reference. This feature can be used to validate intent for example—by creating the ability to consolidate multiple types of communication within a single response so that it can be traced back to a common stimulus; that can then be used to create more effective analytics. It facilitates the opportunity to receive a complete message, creates better machine learning, and ultimately generate better AI. From implicit memory emerge habits, attitudes and preferences inaccessible to conscious recollection but are nonetheless shaped by former events, influence our present behavior, and are an essential part of who we are. A participant's grammar skills represent a particularly good example of implicit memory, where people have acquired abstract rules, but are unable to articulate what guides their speech and writing. This category level knowledge has been shown to operate independently of declarative memory. In essence, people can demonstrate many skills, tasks, and cognitive abilities, though they are unable to explain how they occur and where or when they were learned. The new method of cognitive linkage disclosed herein creates the ability to capture new kinds and types of communication that can be separately identified, which can be very advantageous when it comes to creating cognitive and behavioral analytics. Returning to the demonstrated preference of using a $10.00 bill and a $5.00 bill for payment, the reasoning and intention of a participant's use of this method of payment initiates the concept expansion phase of making change in order to meet more than one objective; but at the same time it may represent implicit learning and knowledge which would provide further reasoning as to why that preference was indicated, that the participant understands the concept has been expanded concept, and that his implicit learning tells him how best to achieve that goal.

“Inside cognitive variable” means a prototype cognitive training variable that has been modified through the collaboration of program participants as part of level two processing, that can, with further modification be used for training and education purposes in level one processing.

“Mind-to-mind communication”, “mind-to-mind thought-directed communication”, and “brain/mind-to-brain/mind communication” all refer to brain-to-brain communication whereby a thought, idea, or concept and its meaning is communicated directly from one participant to another. This type of communication does not involve an input device, brain or other type of implant device, or other type of wearable device, but rather to communication that can be perceived, usually during level two processing by means other than through the known physical senses during their joint engagement in the same variable's narrative and thought-directed simulated reality in varying real time. The origin and the ultimate destination of the communication involve a threshold level of conscious activity by the participants involved, without either the originator or the receiver having created an explicit verbal or written representation of the communication. During the variable re-presentation process, carefully orchestrated interactions among different areas of a participant's brain, initiated by a combination of the computer program product disclosed herein, a participant's brain connectivity pattern, and his cognitive skills causes his mind to arise from his brain causing mental activity in the form of thought (i.e. thinking), that can be evidenced by the language and the meaning of the language and other associated conceptual communication that is generated as part of a response he makes that can be measured separately from his brain. (See Scientific American magazine articles April, 2019; July, 2019; and September, 2019). In this regard then, the mind represents a brain in action by creating thoughts that can be communicated in the form of responses to a variable's cognitive and preference elements that can be measured separately from a participant's physical brain itself, that can be used to document the specific time allocated to cognitive processing (i.e. thinking time), and thusly while brain/mind-to-brain/mind communication is descriptive for what is taking place as a result of the technological processes disclosed herein, the term mind-to-mind communication can be considered even more descriptive at times. The specific brain areas that are activated during a mental task establishes a brain connectivity pattern that can distinguish each individual. It can be said then, that how all these distinct regions interact gives rise to who we are individually. So the training, education, and augmentation program disclosed herein that is focused on improving a participant's information processing skills can prove to be transformative. An accurate cognitive element response by a participant can evidence his temporary immersion in the thought-directed simulated reality he creates following the presentation of a specific variable. The same cognitive element response by two participants can be used to validate that they are both involved in thought-directed simulated reality relating to the same variable (and therefore related to the same conceptual transfer), in real or varying real time. Component 1 linkage can carry the explicit cognitive element responses from participants for documentation. It is a telecommunications-enabled linkage that carries explicit responses, and as such, it does not extend into the simulated reality a participant creates in his brain and mind for two reasons; (1) the simulated reality is only a mental image and has no physical existence and (2) the communication generated may not have an explicit existence (i.e. it has not been entered as text through a keyboard). However, Component 2 of the cognitive-conceptual linkage can carry portions of a response from the simulated reality that has no physical existence outside a participant's brain and mind through the distinct cognitive and conceptual connections and communication channels formed as a direct result of the three-level process at [0081]—that can exist between program participants in varying real time. As such, this design raises numerous questions such as—where does the mind end and the real world begin? Using an example, when more than one participant becomes actively involved with the same variable (and therefore the same concept) in varying real time, a participant has the opportunity to see other participant's explicit preference element responses via component 1. Those responses also serve as the origin of brain-to-brain conceptual communication that explains the thought compression involved in a particular preference element response (e.g. the reasoning behind his decision that has no explicit representation in the real world that can only exist between cooperating participant's brains and minds in varying real time. A participant seeing that response becomes a destination for a new kind of thought-directed shadow associated conceptual communication. A participant who can see other participants responses to the same variable as he continues to advance through the program, will have certain regions of his brain activated by the responses he views—that can aid in the generation of mind-to-mind communication between the participants—in varying real time. The cognitive/conceptual linkage facilitates the transmission/reception of this channel 4 communication—because the cognitive narrative, the simulated reality, and the cognitive and preference element responses together with seeing the response, that comprises multiple layers of communication, provides the context that promotes this type of communication—even though there is no explicit language, reference, or representation of this associated conceptual communication. Recent research indicates that perception knowledge and retrieval can activate sensory brain regions, and that perceptual processing affects conceptual processing—and supports the hypothesis that perceptual and conceptual representations are at least partially based on the same systems. This linkage illustrates a human's heightened ability to incorporate tools and props into our thinking, and to use them to think thoughts we could never have otherwise. This also responds to the question—Is the mind locked inside the skull or can it expand outward without explicit representation (i.e. in an uncompressed state) merging with things and places and other minds that it thinks with? The technology disclosed herein creates a method to suggest “thoughts” to other participants by activating certain sensory brain regions. This can be evidenced if a participant changes his response to that of another participant after receiving the mind-to-mind communication from participant 1 that reveals the “reasoning” and “meaning” of a cognitive and/or preference element response. If a participant later changes his own preference element response relating to action that will be taken only within simulated reality, which therefore involves a risk-free decision making process, to an option initiated by another participant in varying real time, for example during level two processing—a choice that has not been explicitly stated—it evidences that the cognitive/conceptual linkage is in operation, that the linkage is thought-directed, thought-powered and embraces the concept of intentionality, that it can transmit associated cognitive/conceptual communication (ACC) resulting from a decision making process that can become transformative, that it creates the ability for one participant to alter the simulated reality of another participant, and that it allows a concept (or part of a concept) or an expanded concept to be directly transferred from the brain/mind of a sending participant to the brain/mind of a receiving participant.

“Participant” or “Program Participant” means a designated employee that could be a non-human robotic worker or other type of cognitive device that can interact with other program participants that is endowed with a threshold level of intelligence and other applicable required human characteristics, of a company that sponsors the dedicated brain/cognitive training and augmentation program described herein.

“Preference element” means that part of a cognitive variable's conceptual narrative that calls for a response that demonstrates a participant's preference from a range of options that may be explicitly listed (i.e. a choice) and/or that may come into existence through a participant's imagination (i.e. an option that is self created), that allows a participant to demonstrate implicit/unconscious learning and applicable cognitive skills relating to the variable's concept by providing a response that must be accurate, correct, or acceptable. It can also affect the cognitive element of that variable, by changing a stimulus or introducing a new stimulus' that in effect could change the dynamics of the entire variable concept. The example variables used herein exemplify this characteristic. In other words, a participant's response to a preference element evidences that the participant accepts the simulated reality he has created as reality for some period of time because he believes that his responses partially determine what happens in the environment of the simulated reality, and that his actions can change the environment for the other participants (potentially making it more transformative for them, and illustrating the program's intentionality) as well while the cognitive linkage remains in place, that involves varying real time for the participants involved. A preference element response offers insight into one or more of the participant's brain processes through the neural coding and decoding measurements that take place. Other associated information is also collected as part of the response. The participant's response(s) to a preference element(s) may involve implicit/unconscious learning/memory that a participant may not be aware he has. Multiple types and kinds of communication may be revealed by a cognitive demonstrated preference such as that detailed at paragraph [0123]. The participant could also be required to demonstrate explicit/conscious learning in a variable response as shown in paragraph [0086], where the bills and coins returned must add up to the correct change amount of $10.20. Uncompressed conceptual communication may also be involved as illustrated at paragraph [0055]. If a preference response is accurate, it can serve as a cognitive element as well. Implicit memory involved in a conceptual transfer of this type could possibly be revealed further by requiring a participant to show his work in compressed form, or verbally during performance of a task. An accurate response credential is created when the participant makes an accurate, correct, or acceptable response to a preference element that allows the participant to continue advancement through the three-level process. A transfer credential is created when a conceptual transfer from one participant to another is completed and evidenced by a receiving participant's associated information, which allows that participant to continue advancement as well.

“Program” means a workplace program dedicated to brain/cognitive training and augmentation to improve both biological and technical functioning. A customer of a sponsoring company can become a customer program participant.

“Prototype cognitive training variable” means a variable that has been chosen by the level two thought-directed user-to-user training interface, for potential use as a cognitive training variable that would be usable for level one processing, which through interaction with program participants during level two processing may ultimately become an inside cognitive variable.

“Random cognitive logon variable” means a question and/or mental exercise that has been presented to an authorized user during a computer system's base cognitive/behavioral biometric authentication process, that could involve cognitive/behavioral biometrics that are used to determine a user's cognitive fingerprint. After modification, such variables can be used again for continuous authentication/authorization purposes during the three-level process, as can conceptual authentication variables.

“Semitransparent thought-directed cognitive and conceptual communication linkage, or “cognitive linkage” means the various and distinct cognitive and conceptual connections and communication channels formed as a direct result of the three-level process, that is comprised of two components. Component 1 involves channel 1 and channel 2 communication. Component 2 involves channel 3 and channel 4 communication, and exists separately from component 1. Component 1 comprises the formal telecommunications infrastructure—the digital hardware and software infrastructure that handles the presentation of the variables to participants, and other program functions and record keeping. The first communication channel of the formal infrastructure involves channel 1 communication—the specific words of the cognitive narrative of the variable presented that initiate a concept transfer; and a second channel involves channel 2 communication generated as a result of the mental imagery (i.e. the simulated reality) created by the participant's perception, imagination and the ascribed meanings a participant gives to the words of the cognitive narrative, and the cognitive and preference element responses that are explicitly stated and recorded that systematically become part of narrative. A third channel involves channel 3 communication that may ultimately exist as a result of the simulated reality (and that may exist at different levels of intensity and at different times for the participants involved) can be measured by a participant's level of immersion in the variable, the word meanings ascribed by a participant, and from the imbedded demonstrated conceptual preference communication and other ACC and uncompressed conceptual communication that may result. A fourth channel involves channel 4 communication that may result from one of the parties or multiple participants arriving at a thought and then sharing that thought with other participants, that intentionally or unintentionally initiates additional communication relating to the concept. The telecommunications infrastructure, the simulated reality and the resulting conceptual communication reveal personal preferences (such as the tip concept illustrated in the various example variables herein) that might never have been documentable without the technology disclosed herein, because those preferences may exist because of learning and knowledge that is not specifically definable by a participant, or that cannot be articulated because of the way that learning and knowledge was acquired. Implicit learning and knowledge is acquired differently than that explicitly acquired. This same technology also alters and re-defines the boundaries of the concept of real time processing by allowing concept transfers to take place directly between participants at the speed of thought in varying real time (i.e at the time a decision maker attains full cognitive awareness of a prior event or occurrence, and its relevance [0084]). For instance, processing procedures and time constraints are critical factors in the advancement of self-driving automobiles. The potential relevance of the cognitive linkage technology disclosed herein as it relates to these critical factors is illustrated at paragraph [0119] for example. It alters the concept of real-time processing by creating technology that allows re-processing in varying real-time. For example, a training session or written test has constraints involved—the cognitive linkage however—once established—allows a recurring thought to be revisited continually over a much longer period of time—and at any location. The channels discussed are capable of carrying different types of communication. These channels can exist between the computer system and a participant, between and among the program participants, and between the program participants and customer program participants during and following the three-level process. This is made possible as a result of an orchestrated interaction among different brain areas and the involvement and interaction of: the computer software program product disclosed herein, the design and conceptual narrative of the cognitive variables presented, the thought-directed user interfaces, a participant's perception and verbal reasoning, and other applicable cognitive skills that are required to create the thought-directed simulated reality, the thought-directed cognitive linkage created by participants, participant responses made to the variables, the credential formation process, the interaction taking place between the participants as they make their modifications to the prototype variables, utilization of the concept of varying real time, the concept of intentionality, modern authentication methods that create big data, the properties of language, the three processing levels, and the overall ability of these factors to interact with a participant's conscious and unconscious thought that can generate, document, and transmit compressed and uncompressed conceptual communication. In addition, the thought-directed cognitive linkage created facilitates the transfer of concepts involving written language that generally involves thought compression—and the uncompressed conceptual communication that takes place involving conscious and unconscious thought, learning, and knowledge that may even include innate conceptual knowledge in the form of unconscious procedural knowledge which is present naturally—and which was not acquired through learning and/or inference (i.e. does not represent implicit learning or knowledge), and even certain intuited information. The linkage allows uncompressed conceptual communication, and other types of associated conceptual communication to be transmitted to a participant as part of a variable's conceptual narrative or transmitted by a participant as a cognitive and/or preference element response that becomes part of a variable's conceptual narrative. Being able to transmit ACC back to the computer system as part of a response as well as to other participants who can potentially perceive it directly as mind-to-mind perception are unique features of the cognitive linkage, and serve as a prerequisite to being able to capture, analyze, and document thought-directed mind-to-mind perception and thought-directed mind-to-mind communication. The cognitive linkage established allows participants to communicate with other participants during the variable modification process about things and events happening in the here-and-now, that have already happened, that may happen in the future, and/or that may never occur in the physical world. But this opportunity only exists when a participant is involved in the thought-directed shared simulated reality made possible by the program. This semitransparent linkage is also made possible by the concept of “intentionality”, the properties of language, (especially “displacement”), and the cognitive abilities of the human mind, (including those such as implicit memory), all of which enable and help accommodate communication about things that may involve unconscious thinking, learning and knowledge, or that may not have physical presence in the here and now. This linkage represents new technology that can totally transform a company's workforce and workplace in ways previously not available. While education, training, and brain augmentation take place in varying real time—at each participant's individual speed of thought; the program introduces leverage that promotes innovation at an accelerating pace—not the speed of one participant at a time—but the collective speed of thought of all the participants racing toward innovation, led at any specific moment by the participant who is most capable of advancing a given concept. The program's cognitive linkage is extended and reinforced each time a participant makes a response that indicates he is immersed in the simulated reality of a variable that has been presented by one of the thought-directed interfaces. The linkage is created by the program infrastructure that includes the software program disclosed herein, and by program participants in varying real time. The linkage's aggregate size is continually changing as participants are engaged. The linkage is referred to as semitransparent rather than fully transparent because although every participant is eventually exposed to what is occurring with other participants, we cannot know all the thoughts that are taking place in all of the participant's minds unless and until it is actually documented. An explicit response that states using a $10.00 bill and a $5.00 bill for example, is eventually visible to every participant, but the reasoning for using those exact bills is not. Each participant thinks in his own way, and attains his own level of understanding of the variable's concept—and that may not be fully transparent until a later time. Each participant's level of immersion and cognitive function will have a major effect on the aggregate amount of cognitive/conceptual linkage that is ultimately created regarding each variable concept presented—the greater their immersion, the greater their potential contribution to the conceptual transfer among participants will become. That is the reason the linkage creates a continuously innovative environment—those with the deepest immersion can continue to generate new communication that in turn creates more linkage. One participant will always be at the leading edge of a concept and his responses get shared with everybody else. That keeps the conceptual transfer on track throughout the entire organization and keeps the momentum going. Different participants can become leaders at different times. Some participants will not really know how to process and/or deal with information—they can store it, and/or pass it on, but they can never really use it. It's like a conduit system in a way—communication in the form of thought can enter the conduit, and flow smoothly through the system before emerging only slightly watered down at the other end. But other participant's brains will process that same information differently, and/or can have that smooth flow interrupted as a result of another participant's response to the same variable that is different than his, that can stimulate him to actually use this new information. As a result, that thought does not flow smoothly through the conduit, it gets held up during processing by further examination. What exactly is this fragment of information the brain asks? How does it differ from this other fragment? Do the two of them, when considered together, tell me something important? Channel 4 communication can take place between and among participants while they are engaged in a variable's simulated reality with other participants in varying real time, for instance when multiple program participants are consciously involved with a variable such as the one presented at paragraph [0123]. Participants can also become linked together by having become immersed in the simulated reality of the same variable, and communication can take place between participants in varying real time when each participant views new information regarding a concept. The two become cognitively and conceptually linked at the time a participant has received and read the variable's narrative, not at the time the text was originally sent. For example, a participant makes a response choosing to pay with a $10.00 bill and a $5.00 bill, or to pay back change in a certain way, and a second participant reads that response sometime later after he is presented the same variable. The second—participant is reading it in what represents real time to him, which is sometime after the first participant was presented with the same variable—after he first read and responded to it in his real time. Because of the concept of varying real time disclosed herein and the cognitive linkage technology, a participant can even disclose information, learning, and knowledge that might not be available to him otherwise that exists in his own implicit learning. Therefore, the linkage increases program capabilities for AI and machine learning because it carries new types of communication that can be identified, measured, and documented. It allows training, education, and augmentation to be administered and measured separately. All three of these things can be administered because UCC can be generated and transmitted through the linkage that was not available previously, that can now even involve customer program participants. The cognitive conceptual linkage begins with the presentation of a variable to a participant in level one processing, continues with the thoughts and communication generated in the brain and mind of a participant immersed in simulated reality that can be identified and documented through interaction with other participants immersed in simulated reality regarding the same variable in varying real time; and it ends when the thoughts and communication is no longer being transmitted from the minds of the participants involved in the conceptual transfer brought about from the originating variable. Some of the thought-directed cognitive/conceptual linkage carries channel 3 and channel 4 communication generated during a participant's immersion in shared simulated reality. This communication can be documented by certain responses made by a participant that may not have physical existence, because certain types of communication can now be documented that may not ever have explicit representation (e.g. associated conceptual communication). These and other features of the linkage make it semitransparent; some participants will identify types of communication that others cannot pick up on. The telecommunications component (component 1) records historical evidence that certain participants were presented the same example training variable so the sequences of a variable's presentation to a specific participant is documented, and can evidence cause and effect of interaction with other participants. Continual conceptual authentication [0064] can then be continuously administered to identify and validate a specific user, assuring that associated conceptual communication initiated in simulated and shared simulated reality can be traced back to the originating stimulus, that the concept of varying real time is at work and has validity, and that the displacement feature of language is in operation.

“Thought-directed simulated reality” (TDSR) or “shared simulated reality”; refers to a self generated interactive extended reality that a participant temporarily accepts as reality, that exists only in the form of a mental image in a participant's brain and mind, and potentially in a number of other participant's minds who see his responses relating to a specific concept. A participant could experience shared simulated reality with himself, for example when he uses recall or recognition that initiates multiple mental images. It is created for teaching, learning, and brain augmentation purposes. It makes new types of direct communication possible between members of a company's workforce. It is generated by the conceptual narrative of the variables presented and a participant's cognitive skills. such as attention, imagination, perception, and verbal skills. Participants actions partially determine what happens in the environment. It is initiated by the conceptual narrative of a cognitive variable presented through one of the thought-directed user interfaces involved in the three-level process, and additional associated conceptual communication that results from a participant's own actions or through the interaction of the participant with other participants during the three level process—and may also include the participant's own responses to the variable's cognitive and preference elements. An individual participant's simulated reality becomes shared simulated reality through the cognitive linkage established that can be evidenced by responses made by other participants following the introduction of a new stimulus by a participant that can affect the simulated reality of other participants, that facilitates the transfer of conscious and unconscious conceptual communication and compressed and uncompressed conceptual communication, associated conceptual communication, and mind-to-mind communication. This shared simulated reality, particularly during level two processing, facilitates a new type of brain/mind-to brain/mind interface. The artificially induced simulated reality environment requires conscious participation by requiring a participant to accurately respond to a variable's cognitive element and if applicable, a preference element. The additional cognitive linkage that results from other participant's responses [0123] promotes teaching and learning between participants that would not otherwise take place if only component 1 was involved. Using the example at paragraph [0123] for training and educational purposes, the variable creates a simulated environment as a setting for a conceptual transfer that is taking place between two participants—one responding to the variable and the other one reading his response, that may involve implicit memory created years earlier that the originating participant does not know he has and which is not available to him but through this cognitive linkage capability. A level of uncertainty is created in level two processing because a participant cannot identify the participant whose response provided the new conceptual information—or even if it might include his own responses that represent his own implicit memory of which he is not consciously aware of. Simulated reality strives to achieve a mental state whereby for a period of time, a participant accepts it as reality—one that keeps changing as the specific unidentified participants involved in a specific transfer continue to change, as a collective workforce conceptual transfer continues to take place. Virtual reality, as opposed to the simulated reality concept disclosed herein, is an artificial imported environment activated and supported by computer software and hardware created by others. Thought-directed simulated reality can be activated unilaterally by a single participant within that participant's brain and mind that is impossible for anyone else to see, because it is thought-powered. It is therefore activated and supported by the thought processes of the program participants themselves, who provide much of their own context. This means that the words and language used, that can become a major obstacle to communicating with thought alone, can be minimized to a degree because concepts are also used to build simulated reality. For example, a variable's narrative can “involve lunch in a restaurant” without specifying what food was ordered, or the name of the restaurant. As a result, much of a shared simulated reality's context is conceptual and common to the participant's simulated reality, making it much easier to identify the actual differences between two responses during the re-presentation of a variable in level two processing, that makes it easier to identify the meaning of the differences, that may comprise mind-to-mind communication. Each participant achieves his own level of simulated reality using his own thought processes—aided to some degree by the responses he is provided with that have been made by other participants. However, the cognitive linkage must also be in existence in order for certain kinds of communication to be generated and documented (e.g. mind-to-mind communication), and for actual conceptual transfers between participants to take place.

“Thought-directed unknown shared participant secret/big data analytics interface” means the software interface that is responsible for managing level three of the three level process (i.e. the concept innovation phase) described at paragraph [0081], and other paragraphs herein. It is a thought-directed user interface that involves the computer system, program participants, and ultimately a company's program participants, that allows them to capitalize on the thought-directed cognitive linkage formed, the computer system, and selected portions of the company's collected big data to amplify their inherent intelligence and their brain/cognitive training and augmentation from level one and level two processing to display their creative thinking, reasoning, and problem solving skills as they work to create big data and cognitive analytics by uncovering hidden patterns, unknown correlations, market trends, customer preferences, and other useful information relating to a specific business.

“Thought-directed user-to-user training interface” means the interface that performs the functions and processes that make up level two processing (i.e. the concept expansion phase), whereby through the semitransparent thought-directed cognitive linkage formed, participants actually become involved in the creation of new cognitive variables while sharing how they respond to similar stimuli that includes a variable re-presentation process that allows participants to create shared simulated reality. In essence, it exemplifies how they apply their strong inherent intelligence, training, experiences, and cognitive skills in problem solving (i.e. teaching), while concurrently being exposed to how others respond to the same and different stimuli (i.e. learning). New cognitive variables include random cognitive logon variables that will be used as part of the challenge response protocol of a system's base cognitive/behavioral biometric authentication process, and a new type of conceptual authentication. Level two represents a true user-to-user interface that establishes a cognitive (both conscious and unconscious) connection between program participants while they are engaged in designing, and building variables designed to become part of the dedicated brain and cognitive training and augmentation program; especially in areas of reasoning and creative problem solving. The concept expansion that can take place in level two processing is a good indicator of whether a participant's simulated reality achieves a desired mental state [0077]. This would be indicated, if for example a participant is engaged in the temporary environment deeply enough to engage in a decision making process that results in the addition of a valid previously unmentioned risk free option (particularly if all the previously offered options are risk free), that can potentially prime participants for creative ideas to emerge [0033].

“Thought-directed user training interface” means the software interface that is responsible for managing level one (i.e. the concept introduction phase) of the three level process described herein. The interface controls the presentation of the cognitive training variables and/or other types of variables presented to program participants through the cognitive linkage formed, collects, records, measures and analyzes participant responses, transforms responses that meet accurate response criterion into cognitive credentials, and further gives instructions to the system regarding the credentials, and stores data in and retrieves data from a target storage area. This interface represents a thought-directed user interface where interaction between a human and machine occurs, the goal of which is the effective operation and control of the machine in its management of the training phase for program participants and provides recurring useful feedback from the machine regarding such.

“Three level process” means the three-level process that forms a basis for the workplace training program disclosed herein. The new terms defined in paragraphs [0078-0080] are instrumental in understanding this process. Level one processing represents the concept presentation phase that is the core phase of the education, training, and augmentation program. Level two processing represents the concept/category expansion phase: a phase that allows participants to consider a concept from different perspectives while interacting with other participants that may lead to concept expansion or even category extension and/or new categories being created that can in turn generate new and revised training variables for use in the program. Level three processing [0146] represents the concept/category innovation phase: a phase that allows participants to take learning and knowledge acquired in levels one and two and utilize it to create analytics and other tools of thought to achieve important innovation, that can include direct interaction with the company's customers and providers. A non-human employee could be trained, educated and augmented by an abbreviated version of this process commensurate with the intelligence and the applicable human characteristics that employee is endowed with at the time.

“Unconscious conceptual communication” or “thought-directed unconscious conceptual communication” means the implicit learning communicated through the three level process that is generated from a participant's implicit memory and transmitted through the semitransparent thought-directed cognitive linkage that facilitates the workplace brain/cognitive training and augmentation program disclosed herein. It involves implicit memory—learning of procedural and category-level knowledge, including perceptual and cognitive abilities, which can be evidenced through certain responses and associated information developed through the challenge-response protocol that involves the presentation of cognitive variables to program participants through the thought-directed user interfaces as part of the program. In other words, it represents implicit knowledge that, if properly activated, can become explicit. Implicit memory can be received, stored, and recovered outside the conscious awareness of a participant, and can be learned and improved outside one's focal awareness. Implicit memory aids in the performance of particular types of tasks, without the need for conscious control or attention. Implicit memory or nondeclarative memory does not involve conscious or deliberate retrieval. Procedural memory generally refers to memory knowing how to do something. The knowledge is procedural memory and is not accessible to awareness, but rather is manifested through task performance. Procedural memories are built up gradually and incrementally with practice. Certain learning in the three level process may not be transferred, so-called tacit procedural knowledge that might be thought of as know-how that involves certain muscle memory that can only come from repeating motor movements—high quality wood working and carving experience for example. Implicit memory transfer is better suited to category level knowledge, can be transformative, and can facilitate new kinds of conceptual communication and transfer in a workplace culture that can be used to initiate concept expansion learning. Unconscious conceptual communication would by definition also be considered a form of uncompressed conceptual communication and therefore also a form of ACC.

“Unknown shared participant secret” relates to a cognitive variable designed and built by a team of participants for presentation to a company's big data, and/or other analytics made available to a participant(s) during level three processing, and the accompanying response(s) made to it. Ultimately, it refers to properly designing a variable's preference element in such a way that the new types of unconscious communication that can be generated by the technology disclosed herein can be captured, measured, and documented and matched back to the stimulus that is responsible for causing a particular response. It is a process designed to make analytics more personalized—and thereby more effective.

“Varying real time” and “varying real-time processing” refer to the relationship between the occurrence of an event such as the presentation of a cognitive variable initiating a concept transfer, and a participant's full cognitive awareness of that event that includes acquiring new learning and knowledge. This interval exists because certain parts of the thought-directed cognitive linkage are powered only by a participant's brain and mind, as well as the reality that each participant has his own independent speed of thought. While the cognitive linkage at any particular time is comprised of the accumulated amount of learning and knowledge regarding a variable concept that has been presented and includes idea sharing between the participants involved in the linkage, each participant's thoughts regarding the concept being transferred are individual, limited to the learning and knowledge he has acquired. For example, participants are not all at the same point in the linkage at one time, and participants will not all be looking at a specific response at the same time. This interval recognizes that each participant thinks at his own speed and that a concept transfer delivered through the cognitive linkage will be completed only if, and when all the participant(s) involved attain full cognitive awareness of the concept transfer individually. So the term “real time” takes on additional meaning for each program participant—and represents something different to each of them. That distinguishes thought-directed simulated reality from virtual reality further, because a complete concept transfer cannot be simultaneous for all participants, because it must be created in each participant's brain and mind individually. Language—and words—matter significantly, and for many concept transfers thought-directed simulated reality offers more flexibility than virtual reality can offer. The impact of words and language can be directly measured as the narrative of a variable is modified—by adding or changing just one word—which in turn modifies the simulated reality that has been created. This fact can be evidenced by a response change. Virtual reality is created, supported by, and requires digital technology. Simulated reality is different in several ways, and attains its fullest existence after all linked participants have made their final responses that have become part of a variable's conceptual narrative and after all the communication that can be recorded and measured, has been. The cognitive linkage also allows a participant to transfer previous experience(s) and other unknown conceptual information because it creates the opportunity to consolidate relevant information from a previous experience(s) and re-process it in conjunction with a current event—creating the ability to add important context, perspective, knowledge, and learning to a prior event(s) during current processing. Adding context and perspective can provide real world benefits that can be transformative. Time and hindsight provide the luxury of being able to change one's point of view regarding an event, sometimes even giving us the ability to change the eventual outcome of the event in a different and hopefully more positive fashion. Time allows us to put events into perspective, which could not have been put into perspective otherwise. Varying real time creates the ability to put two or more participants into the same variable's simulated reality from multiple perspectives, at the same time or at different times; with each representing real time to the participant(s) involved. In essence, a participant gets the benefit of learning from multiple parties each of whom has created his own simulated reality—in his own version of real time—at his own speed. Using an analogy, a lawyer could question his client on the stand to try and engage the jury in his client's state of mind at the time an event happened which could have been several years earlier, to try and put the jury and the defendant into real time together, allowing them to engage in conceptual communication through shared simulated reality [0077]. Shared simulated reality offers a way to transfer actions taking place in an artificially created reality setting to the real world, potentially even putting multiple parties into a situation where they are sharing the same emotional state. Virtual reality can only take place within the parameters of the virtual reality environment created by the technology infrastructure employed in real time. The properties of language and the cognitive linkage create a conversion capability for simulated reality. Language provides the ability to transmit messages as both teacher and student—allowing a person to teach and learn from other individuals. It allows one to refer to the past and past events, and to things not present (i.e. displacement), therefore making it possible to cognitively connect with individuals in a manner that does not require physical presence. Displacement allows a participant to deal with events that happened in the past events currently happening, and events that never have—and that maybe never will happen. The concept of varying real time consolidates the linkage and the conceptual transfer allowing both to exist concurrently without the need for a participant to be able to see all the moving parts at all times (such as the thoughts that are in one's mind at every specific moment)—making the process semi-transparent. It also consolidates reality and simulated reality through the reconciliation of events taking place in the real world, in simulated reality, in shared simulated reality, or in all or some of these concurrently. We can be assured a concept transfer has taken place through a participant's ultimate responses—without knowing exactly when and at what point in the linkage the transfer actually took place.

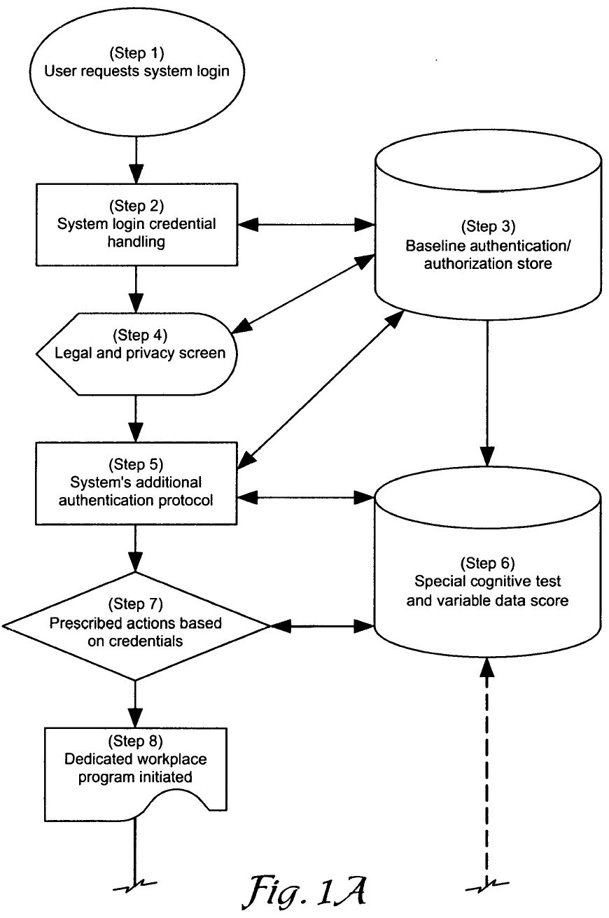

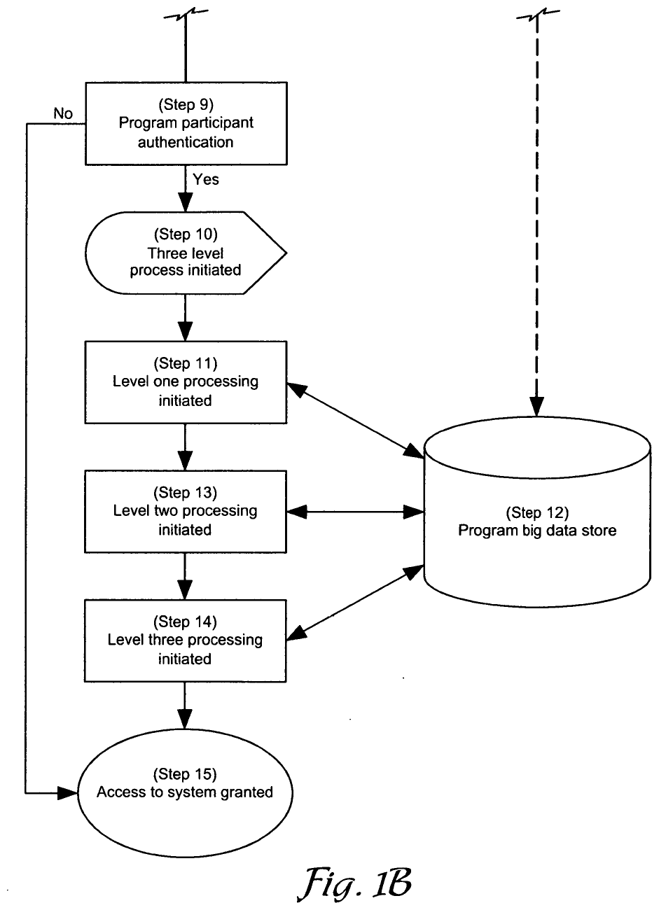

### FIG. 1A 1B, and Partial View 2A; Three Level Process; Levels One, Two and Three

### Level One and Level Two Processing

Level one of the three level process initiates the concept introduction phase of the brain/cognitive training and augmentation program delivered through the telecommunications network and the semitransparent thought-directed cognitive linkage that is created. It is designed to measure a participant's explicit conscious learning and knowledge relating to concepts that are important to the operation of a business, to introduce a participant to new concepts, and to improve a participant's existing cognitive skills such as perception, imagination, attention, learning, memory, thinking, reasoning, problem solving, and decision making. It can be considered a form of B2E (business to employee) service to employees utilizing a computer system having internet and/or intranet connectivity. Upon successful completion of a computer system's base authentication process, authorized users of the system who have been designated as program participants are additionally required to respond to a set of one or more cognitive variables—cognitive questions and mental exercises that have been specifically designed and designated for use in the program. Each variable must include at least one cognitive element that requires an accurate response that is used to provide empirical evidence that certain levels of the program's infrastructure are in place, that thought-directed cognitive linkage has been established, that the participant is engaged in simulated reality as a result of the presentation of a variable through a thought-directed interface, and that the participant demonstrates at least a threshold level of cognitive function. At least one preference element must also be included in the variable, that has been designed to capture a participant's cognitive/behavioral biometrics, to promote insight into one or more brain processes of a participant by means of neural encoding and decoding information, and to measure his progress through the program. Conceptual narrative is designed to create a mental representation in the mind of a participant that links a variable to a specific concept. The cognitive element(s) and the preference element(s) of a variable have a special relationship disclosed herein in further detail.

The following level-one simplified example training variable that has been designed to test a participant's conceptual knowledge of how to make correct change can be used for illustration purposes: “Imagine you are a waiter in a restaurant. Your customer, Bill, just had lunch costing $9.80 including tax, and when you present him with his bill he gives you a $20.00 bill for payment. As you pick up his payment and leave the table, you say to Bill that you will bring back his change. How much change do you owe him? $______ ______. ______ ______. This example variable contains a cognitive element that requires an accurate response—the correct change amount, and focuses only on returning the correct amount of change—$10.20. A preference element response, the choice of a $20.00 bill for payment, has been pre-selected in this example. As pointed out in upcoming paragraphs of the description, a different example could have asked the participant to make the choice of how the customer elects to pay, allowing him to demonstrate a preference that has further implications. The participant's response to this variable illustrates channel 1 and 2 communication (i.e. the delivery of the variable by the program infrastructure and the cognitive element response). If the cognitive narrative is modified somewhat it could also illustrate type 3 communication, such as the modifications presented at paragraph [0101 and 0123]. In this example, channel 2 carries the cognitive element responses made by a participant, but there is no explanation as to why a $20.00 bill was used for payment. Requiring the participant to demonstrate a preference as to the bill(s) used for payment and/or the bills and coins to return to the customer as change, make channels 3 and 4 conceptual communication channels (that in turn create additional cognitive/conceptual linkage) because they allow the participants to not only demonstrate their interpretation and understanding of the cognitive narrative, but also to express their feelings, personal preferences, and decision making/reasoning regarding the variable concept involved without always having to explicitly state these things—by generating imbedded demonstrated conceptual preference communication for example. These types of example variables or similar ones will be presented to all participants during level one processing. The accurate response to the cognitive element of a variable requires explicit conscious learning and knowledge, illustrates compressed thought, and provides empirical evidence that the cognitive linkage exists, that the participant making the response is exhibiting at least a threshold level of cognitive function, that the conceptual narrative of the variable has established a basis for a mental representation of the concept in the participant's brain and mind, and that the participant's immersion in the simulated reality meets or exceeds a subjective threshold. Conscious awareness can depend upon information reaching a certain brain area, or can depend simply on information being widely broadcast in the brain. These factors also provide evidence that conscious thought is taking place relating to the thought-directed simulated reality that has been established, as does the cognitive credential that is created by making an accurate response in real time that could only have been brought about by that particular narrative. It requires the participant to perform arithmetic, and to utilize other kinds of cognitive skills such as verbal reasoning, quantitative reasoning, imagination, attention, perception, and decision making. The participant must create the thought in his mind that initiates the response to the cognitive element that will be transmitted through the cognitive linkage that has been established along with other communication relating to the cognitive skills engaged thus far, and which, if accurate, is transformed into the cognitive credential that is required to continue through level-one processing. Many experts believe that originally words served as the anchors for sensory information and memories about a specific animal or object. Once the brain had words, it could create concepts which came together. Some scientists believe that the mind can exist without language, others argue that language provides mind.

Level one processing introduces the thought-directed training interface that is responsible for initiating the presentation of a concept to a participant, and for managing other functions described in more detail elsewhere in the specifications. The interface selects variables for presentation and performs and manages other administrative functions and processes associated with the presentation of the level one cognitive variables to the participants, delivers the variables that carry the words that will generate simulated reality in a participant's brain and mind, and transmits a participant's responses for further processing. The cognitive linkage technology disclosed herein facilitates a very versatile program designed to deliver education, training and augmentation to program participants—an innovation focused program that can benefit the business and participants alike.

Another integral part of level one processing is the semitransparent thought-directed cognitive linkage that is created during and following the three-level process—and represents the cognitive connections brought about by the presentation of cognitive variables through the thought-directed interfaces and other infrastructure noted herein. This linkage is first established during level one processing by presenting a cognitive variable that contains conceptual/contextual narrative, at least one cognitive element, and at least one preference element to a participant. Requiring a preference element's response in addition to the cognitive element response makes the semitransparent thought-directed cognitive linkage stronger thereby allowing a greater amount of communication and new types of communication to be generated that can be documented and recorded, because it adds a second way to cognitively and conceptually connect with a participant and with multiple participants at the same time through thought-directed shared simulated reality. The associated conceptual communication and associated information derived from the presentation of a variable through the thought-directed interface provide empirical evidence that the linkage exists, but also that semitransparent thought-directed cognitive linkage exists as illustrated more clearly in upcoming examples. This feature allows conceptual learning to be accomplished, and for the transfer of that learning and knowledge that will ultimately take place between and among other program participants. Level-two processing takes advantage of this conceptual transfer feature. The cognitive linkage creates new ways to identify, transfer, separately measure, and separately document the multiple types of communication described at [0105]. The telecommunications network infrastructure supports the delivery of the variable through a thought-directed interface, and generally supports the delivery and other functions of the entire program. It includes, but is not limited to, the software program, the variables, and the presentation of the variables that include a preference element(s) that requires a demonstrated preference element response. The responses to the cognitive and preference elements eventually show up in and become part of a variable's conceptual narrative and will be shown to other participants; meaning that everybody is not actually looking at the same conceptual narrative in real time—but in varying real time (see definition of this new term at [0084]). The example variable at paragraph [0086] illustrates paying for lunch using a $20.00 bill, with the provisio that in a different example the participant may be required to make the choice of which bill(s) to use for payment. The example variable at paragraph [0101] illustrates a pre-determined response of using a $10.00 bill and a $5.00 bill to pay. However, the example variable at paragraph [0123] requires a participant, acting in the role of the customer, to demonstrate a preference by making the decision of which bill(s) to use for payment. A preference element response, for example “the $10.00 bill and the $5.00 bill”, would normally be contained in the big data that is generated each day as part of the program. The ACC, such as mind-to-mind communication relating to why a certain form of payment was chosen would not. In other words, the denomination of the bills used for payment would show up in the big data, but not the reason the participant chose to use those bills for payment as opposed to another choice. The technology disclosed herein changes this outcome, the reasoning is now identifiable, quantifiable, and documentable as a result of the telecommunications—enabled semitransparent thought-directed cognitive linkage and other supporting infrastructure of the program. The technology disclosed herein creates separate and distinct channels of communication that exist because a participant becomes immersed in the concept to the extent that he actually perceives the simulated reality environment created as representing reality. The telecommunications infrastructure that delivers the conceptual narrative exists separately from the thought-directed simulated reality that the narrative helps create that exists only in a participant's brain and mind. The reason that a particular form of payment was chosen by a participant may ultimately be revealed through a future response that would be carried through component 2 of the cognitive/conceptual linkage.

The thought-directed conceptual narrative described at paragraph [0065] is of major importance to level one processing, as is the thought-directed simulated reality described at paragraph [0077], as explained further in greater detail. Language shapes the way we perceive reality. Research shows subtle linguistic differences can frame our approach to difficult problems. Language shapes thoughts. We use metaphor because certain issues such as crime or the economy are hard to think about. None of us have a complete understanding of these systems, so we draw on knowledge of what's familiar to us. The technology disclosed herein creates thought-directed simulated reality based on the mental image created in a participant's mind centered around a concept to be transferred, and the level of reality associated with the image created is to a great degree dependent upon that participant's imagination, attention, perception, and verbal reasoning skills. The level of a participant's immersion in the simulated reality is key to the amount and kinds of communication that a response will generate and that will be transmitted through the cognitive linkage and whether or not other types of communication can be generated, and/or whether certain additional kinds of perception can be documented. So as the level of conceptual narrative perceived by the participant increases, the amount and types of communication generated increases—and the deeper the level of concept transfer that can take place. The level of cognitive linkage established through a participant's immersion in the simulated reality will generate a requisite level of communication to take place that demonstrates a participant's learning and knowledge of the concept that is being transferred. The linkage facilitates the measurement of the types and kinds of communication generated, and the amount of communication transmitted. The initial communication involving the concept of making change first introduced in level one [0086] can potentially blossom into communication that relates to making change within an organization to accomplish multiple goals—making it metaphorical in nature. The concept transfer that takes place will ultimately depend to a great degree on the participant. One participant might demonstrate conceptual understanding as part of his level three communication for instance, by his choice of which bill(s) to use for payment, whereas another will only demonstrate that option after engaging with other participants in level 4 communication.

A participant's imagination, attention, perception, verbal reasoning skills, and general thought processes represent important threads that connect the infrastructure of the program together and that make this new form of cognitive linkage operate as disclosed. A participant's general thought processing skills, imagination, and perception skills are required to decompress the conceptual narrative of the cognitive variables, to create the thought-directed simulated reality, and to power the cognitive linkage that transmits the new and additional types and kinds of communication. Perception is a cognitive skill, and a component of character traits such as empathy. Cognitive skills generate communication as they are accessed and used by a participant. A participant's perception skills can be perceived by the number and types of associated conceptual communication that he generates in response to a variable during a concept transfer, and the quickness with which he generates that communication that can potentially lead to mind-to-mind thought-directed communication. Perception is a way of regarding, understanding, or interpreting something; a mental impression—the way a person thinks about or understands someone or something. In essence, it represents the process by which people translate sensory impressions into a coherent and unified view of the world around them. Perception is an awareness, comprehension, or an understanding of something. Participants will all have a set of perceptive skills—but they will all exhibit different levels of those skills. Verbal reasoning is understanding and reasoning using concepts framed in words. It aims at evaluating one's ability to think constructively, rather than at simple fluency or vocabulary recognition. The association of the senses in working together obviate the necessity of having all the sensations that form an object present before we can perceive the object. We have become so accustomed when we see a book for example, to experience certain other sensations along with that of sight. A mere glance at a book seems to start the train of other habitual accompaniments; size, the associations of reading from it, and all the rest that goes to make up a book fall into line at once, merely from the suggestion received from the visual sensation. While we may not have thought of size, form, weight, etc., it is perfectly evident that former experiences of those kinds flow into our perception of a book. Though your thinking all takes place in what we call the present moment, in every case it goes largely in images of past experience. Indeed, nothing can enter your present thinking that does not link itself to something in your past experience. So perception can take place involving mental imagery such as the thought-directed simulated reality that a participant has created. To the mind incapable of using experience, the future would also be impossible, for we can look forward into the future only by placing it in experiences the elements of which we have already known. Likewise, the imagery from the different senses vary greatly in the same person. This would naturally be the case, for not all types of experience enter equally into our minds, since the consciousness is selective in the objects of its attention. All types of imagery are possible. All literature is filled with visual imagery, taken in through the eye, and its meaning interpreted by verbal reasoning.

A unique feature of the variables is that when a preference element response is made by a participant it affects the cognitive element response—and sometimes the dynamics of the entire variable by changing the original stimulus or adding new stimulus while the cognitive linkage and the shared simulated reality remain in place along with any actual new linkage the response itself may create. A participant's response to the preference element can also affect the overall dynamics of a variable in other ways as demonstrated in paragraphs [0101 and 0102]. In doing so, it serves to create further empirical evidence of the semitransparent thought-directed cognitive linkage formed during the three-level process. When a participant first makes his response to a preference element, (or another participant's previous preference element response is changed in level two processing, for instance), because of this unique characteristic the variable can be dynamically changed and disrupted by the introduction of a new stimulus. A stimulus change in the cognitive element requires a new accurate response, and every change of response occurring in the level two variable modification process can potentially mandate a new accurate response to a variable's cognitive element. A cognitive element change re-charges the original linkage every time a new response is made. For example, in level two processing, if a $20.00 bill is initially presented for payment, the total correct change total of a meal costing $9.80 is $10.20, and if that response is later changed by another participant who uses the $10.00 bill, the total correct change total is $0.20. If a participant's cognitive element response to that modification is accurate, (i.e. the coins returned by the waiter in fact equal $0.20), the cognitive linkage must still exist and/or must have been re-charged. Drawing an analogy, the conversation has changed, but everybody is still on the same page. Another unique feature of the variables is that they not only measure implicit learning, but through the ongoing re-presentation of a variable throughout level two processing for instance, new implicit learning is created. So the prototype training variables used for training purposes in level two of the program are regenerative to the extent that new implicit learning—such as the unconscious learning occurring in the formation of new skills or habits—is created that can then be measured and used to create new variables for use in a system's base cognitive/behavioral biometric authentication mechanism, or for conceptual authentication.

The thought-directed interfaces, the semitransparent thought-directed cognitive linkage, the thought-directed conceptual narrative of the variables, and the thought-directed simulated reality program infrastructure components that require joint action with a program participant using his cognitive skills such as imagination, perception and verbal reasoning in order to become fully functional—are explained in further detail in the following illustration. The cognitive linkage is designed to transmit multiple kinds of communication for the workplace brain/cognitive education, training, and augmentation program disclosed herein. As demonstrated in the example variables at paragraphs [0086, 0101, and 0123], if the conceptual narrative is increased, thereby providing more interfacing opportunities, the cognitive linkage is extended—by providing a greater amount and potentially more kinds of communication—and therefore more learning and knowledge is delivered by the program. The conceptual narrative is also increased (and can be changed further) by the ongoing cognitive and preference element responses that are made by participants. As a participant becomes more deeply immersed in the simulated reality created by the conceptual narrative in conjunction with his imagination, perception, verbal reasoning, memory, and other applicable cognitive skills, and his ongoing cognitive and preference element responses, the existing level of cognitive linkage is extended and intensified because a participant is potentially able to engage with this additional information—allowing a participant to exceed the subjective threshold needed to generate and identify deeper levels of communication. So there are two important factors at work (1) the extension of the cognitive linkage by increasing the interfacing opportunities that can be brought about by adding conceptual narrative to a variable, and (2) increasing the intensity of the cognitive linkage brought about by a participant's deeper immersion into the simulated reality allowing even deeper levels of communication to occur. In other words, a participant can take advantage of these added interfacing opportunities by his deeper immersion in the mental representation that can potentially stimulate additional memory. This deeper immersion can allow him to generate more types of communication discussed at [105]. The types of communication generated during this immersion into the simulated reality indicate the level of his immersion and ultimately his understanding of the variable concept being transferred; that together could lead to the ability to fully develop the concept of conceptual authentication at paragraph [0064].

Concept transfer relates to the transfer of a concept from one person to another. It suggests more than simply presenting the answer to a question for training purposes. The technology disclosed herein is designed to transfer an entire concept or a portion of a concept, initiated by the presentation of a variable. A successful transfer is evidenced by the creation of a transfer credential, and it shows that the participant understands the concept and should be capable of carrying that knowledge and learning to the next level. Conceptual transfer normally takes place in the form of written or verbal communication that involves language; but can now also be accomplished through associated conceptual communication using the technology disclosed herein. This new linkage method even allows a participant to transfer a concept to himself that was previously unavailable to him as a result of the way it was learned; it can change implicit learning and knowledge into explicit knowledge. Cognitive variables are created utilizing thought compression—by compressing thoughts into words and text designed to create thought-directed simulated reality in the mind of a participant, for example. A participant utilizes the same concept when making his response to a training variable. As opposed to a typical training and education program, participants do not only have the ability to provide a response, they can provide a response that can change a variable's original concept by introducing a new stimulus that can change a single question into a full-fledged conversation. Therefore, this new technology has the ability to alter conversational commerce as it is taking place, that can alter behavior. The cognitive component provides a participant with the opportunity to communicate directly with the computer system or another participant as to what he is thinking because he is required to make an accurate response in a manner that can be recorded and measured by the thought-directed interface involved—and the response serves as empirical evidence of cognitive linkage as well as providing insight into a participant's thought processes. Language—the words themselves—also serve as a compressor, and a participant's cognitive function and cognitive skills serve as further compressors. The need for a response to be accurate means the response must be quantifiable. As shown in the variable examples, a concept transfer accomplished through the semitransparent method can be verified by the specific response to a preference element, if it is also subject to the accuracy requirement.

In a well structured environment, such as the environment created by the semitransparent thought-directed cognitive linkage and other program infrastructure disclosed herein, the design of a cognitive variable not only allows, but is instrumental in initiating the unconscious thinking, learning, and knowledge that can be revealed through implicit memory. A cognitive variable that has been presented to a program participant through a thought-directed interface, because it requires responses to the cognitive and preference element responses, creates the opportunity to convert certain unconscious thought into explicit learning by generating unconscious conceptual communication. A cognitive demonstrated preference—e.g. using certain types of bills for payment that has not been compressed through speech or text to further include a specific explanation as to why that method of payment was chosen—may indicate learning and knowledge acquired in the formation of skills or habits that represents implicit learning. This type of implicit learning can be transferred from one participant to another through the thought-directed cognitive linkage method disclosed herein as the invention, in the form of associated conceptual communication, unconscious conceptual communication, imbedded conceptual communication, and it can also be made explicit. Participants are often not even aware that they have demonstrated certain preferences as part of their responses. All the unconscious learning revealed in a participant's response, or part of it, may become part of the concept transfer that takes place between and among participants during level two processing, for example.

When one or more participants are engaged with the training program, certain participants with stronger cognitive skills, more education relating to the work involved, more experience on the job, different work and life experiences, or more time with the company can share implicit learning they have acquired through the responses they share with participants who may have weaker cognitive skills or less experience. This linkage, when applied to big data collected through the base authentication process and the program disclosed herein, allows a participant to share memories and information with other participants. Simply put, one participant can pass memories that have been memorialized in big data to another without the need to be physically present at that time, through the cognitive linkage that has been established. Once a participant has been exposed to the learning and knowledge of another participant through the cognitive linkage, that linkage remains in effect for an unknown period of time, possible forever; they have become cognitively linked at that moment in time. Through this linkage, a participant can present a cognitive variable to big data relating to another participant's memories or a piece of information they want to access—a method of real time access to a previous employees training and job experience, from another time period, for example—that allows broad concepts to be transferred, not just data and information, but also important knowhow that may have taken years to acquire. The sharing process is semitransparent to participants because it takes place on an anonymous basis. A cognitive training grid can be used to verify each participant's cognitive skills and abilities. A grid is not for publication; it should be kept confidential to meet privacy requirements—so that management as a group need not be aware of any particular participant's standing among other participants. Participants never know whether they are actually involved in a teaching or learning role, and in reality most participants act in both roles as the program goes forward. Each participant brings strengths and weaknesses to the program. Training exercises must be set at a difficulty level that challenges a participant—causes him to think—without discouraging him unduly. As a participant's cognitive skills improve, the challenges must change as well. Cognitive variables are stored with a cognitive data tag that indicates the difficulty of that variable, so difficulty levels can be controlled. For example, improving reasoning skills could start with a strategy such as direct retrieval—retrieving a known fact from memory to solve a simple problem, and then gradually moving to means-end analysis that involves solving problems in unfamiliar domains.

Demonstrated preferences, invisible challenges, and unconscious behavior can generate uncompressed conceptual communication and/or unconscious conceptual communication that can be documented and analyzed.

The thought-directed user interfaces, a participant's verbal reasoning skills, his ability to meet a threshold level of cognitive function, and the design and composition of the variables all contribute to the intensity of the cognitive linkage ultimately created, the level of simulated reality achieved, and the amount and types of communication ultimately generated.

The properties of language facilitate the cognitive linkage and the forms of communication the linkage carries. Language provides the ability to transmit messages as both a teacher and student—allowing an employee to teach and learn from other employees. It allows one to refer to the past and past events, and to things not present, therefore making it possible to cognitively connect with individuals in a manner that does not require physical presence. For instance, using the phrase “Imagine you are a waiter in a restaurant”, that is used in the example variable at paragraph [0086].

The design of the cognitive variables and the presentation of them through the thought-directed user interface facilitates the semitransparent thought-directed linkage because they can be structured to provide a specific thought-directed stimulus associated with a specific concept to be transferred that commands and anticipates a specific response that can be measured. The technology disclosed in level two processing allows participants to be involved in the design and structure of the program's cognitive variables, as well as the random cognitive logon variables that may be used in a system's base authentication/access control processes which puts the participant in the role of teacher—and student. The responses to the cognitive variables prove that words matter—and that grammar matters. Language has the power to make the invisible appear real. Words create reality; because every part of the brain works together to interpret stimuli from the world around it to create reality. By teaching participants novel categories, and having the advantage of being able to manipulate the conceptual narrative, stimuli, and the cognitive and preference elements of a variable, the role of each can be researched in depth in assessing one's ability to acquire and apply it in new examples. Being involved in the design of the cognitive variables provides training in almost every meaningful cognitive skill.

The level two prototype cognitive training example variables at [0101 and 0123] illustrate the broad range of cognitive elements that can be included in a single variable, illustrate level two processing in greater detail, and show how levels one and two dovetail together. These skills include but are not limited to imagination, attention, perception, verbal reasoning, quantitative reasoning, awareness, comprehension, computational skills, concentration, decision making, executive function, judgment, logical thinking, math skills, working and short-term memory, perception, planning, problem solving, structural semantics, symbolic thinking, and verbal fluency. These skills contribute to a user's cognitive function—brain mechanisms that are involved with thinking, reasoning, learning, and remembering. The example at [0101] contains conceptual narrative that creates the context of the variable, and that generally defines the concept to be communicated, contains at least two cognitive elements that must be accurate (i.e. doing the arithmetic correctly to arrive at the correct change due the customer, and determining the accurate bills and coins to be returned that collectively represent the change due). These two cognitive elements demonstrate that cognitive linkage has been established, and that the participant is demonstrating at least a threshold level of cognitive function, and whether or not the participant is consciously and continuously immersed in the thought-directed simulated reality. Associated information, see [0056], includes the neural encoding and decoding measurements of how long it takes the participant to read the variable, think up his response, and enter his response, and create the ability to measure the responses in aggregate, by separate steps, and even by the type of skills and sub-skills required to accurately respond, as well as how the user organizes his responses. In addition, the neural encoding and decoding measurements can be recorded and classified by the level of difficulty of the variables presented for response. The variable at [0123] contains several preference elements that will reveal demonstrated preferences relating to the cognitive element stimulus. By the time a prototype cognitive training variable is finalized in level two processing, the inside cognitive variable will probably look very different and the participants involved should have acquired some new skills that can be carried forward to level three. One goal of the program is to improve creative thinking skills in multiple domains, so designing training activities that relate to diverse domains is essential.

The following example training variable can also be used for illustration purposes: “Imagine you are a waiter in a restaurant. A customer, Bill, is carrying three bills in his wallet to pay for lunch—a $20.00 bill, a $10.00 bill, and a $5.00 bill. Assume the bill for his lunch is $9.80, including tax, and that the decision is made to pay using the $10.00 bill and the $5.00 bill. As you pick up his payment and leave the table, you say to Bill that you will bring back his change. Specify the denomination of the bill(s) and coin(s) you would return to him as change. All participants responses are documented and recorded, and processing continues. The example variable contains contextual/conceptual narrative, cognitive elements and preference elements as applicable, and generally relates to the concept of making correct change. However, as opposed to the previous example variable [0086] which is similar, it also provides participants with the opportunity to generate channel 3 and channel 4 communication. The original concept being transferred has been expanded by the presentation of the $10.00 bill and the $5.00 bill to pay for lunch rather than the $20.00 bill, and since the reasoning and meaning for using that method has not been explicitly stated, could initiate mind-to-mind communication as to why that particular method of payment was illustrated. This same communication could also raise the question of whether an expansion of the original concept has taken place that can be used to create additional understanding that change is not only money owed back from a monetary exchange but that it may also represent how he gets paid for the service he provides. The initial concept of making correct change has been expanded to how to make correct change that can be used to accomplish more than one objective (i.e. to pay for the meal and to leave a reasonable tip), and then may eventually progress to the innovation phase that can create new ways to look at the abstract concept of “change” to benefit a business, or its customers. That makes the original variable metaphorical in nature—the concept originally concerned making change in simulated reality, and then requires a participant to actually change his thinking at the same time in real life. This example variable could be considered a transition type of variable, one that expands the concept for some participants immediately and not others, depending upon their perception skills.

Breaking down the cognitive training variable at paragraph [0101] into smaller components provides a better way to illustrate the various parts that have been specially designed to initiate different types of associated conceptual communication and that illustrate the range of learning and knowledge that can potentially be transferred between and among participants during the three level process. The cognitive element is designed to measure explicit conscious learning and knowledge, and requires an accurate response for that reason. The correct amount of change owed to the customer must be calculated for the cognitive element to be considered accurate and means that the bill(s) and coin(s) returned to the customer must total the correct amount of change owed. The participant must arrive at the correct amount by using several cognitive skills including symbolic thinking. The preference element(s) of the variable provides the participant with the opportunity to display implicit learning and knowledge through implicit memory, and certain types of tacit knowledge, if applicable. Implicit learning involves unconscious learning, that occurs in the formation of skills or habits, for example. It is non-episodic learning of complex information in an incidental manner, without awareness of what has been learned. The result of implicit learning is implicit knowledge. It is learning complex information without complete verbalizable knowledge of what is learned. From implicit memory emerge habits, attitudes, and preferences inaccessible to conscious recollection but that are shaped by former events, influence our present behavior, and are an essential part of who we are. Furthermore, implicit knowledge operates outside of conscious awareness and ability to reflect, and has the potential to contribute to a transformation of meaning structures. Implicit memory can be received, stored, and recovered without the participation of the limbic system and outside the conscious awareness of the individual. Implicit learning is revealed by a change in task performance. Implicit learning is not set out in tangible form, but can be made explicit. Tacit knowledge involves knowledge that one would have extreme difficulty operationally setting out in tangible form—knowledge that could only be gained or transferred by actually learning the motion and “feel” of a process in the company of experts. The preference element is normally the component of the variable where the majority of the associated conceptual communication takes place. For example, the variable referenced at paragraph [0101] calls for an accurate response to the cognitive element of $5.20 which is represented by proxy—the total of the bill(s) and coin(s) returned as correct change. So in this example variable, the preference element response must also be accurate and represent the correct change amount of $5.20. But in this example, the preference element also offers the opportunity to capture other types of associated conceptual communication, and to transfer other types of conscious and unconscious, and compressed and uncompressed learning and knowledge to other program participants through the cognitive linkage. In real life, knowledge involves a mixture of explicit, implicit, and tacit learning and therefore the measurement, transfer, and documentation of a “concept” involves many different elements—and the lines of distinction between the various types of communication generated can get blurred. The linkage method disclosed herein is designed to generate and transmit various types of communication while creating a new type of authentication modality that can be used to identify a participant during the system's base authentication process and continuous authentication processes by the mixture of learning regarding a concept, not just one explicit factor. See [0064]. Passive biometrics do not compare to this new deep learning method. This learning is made possible by the cognitive linkage that can carry separate communication and differentiate it from the behavior that accompanies it, making it possible to authenticate the actual stimulus involved, and the identity of the person associated with that behavior. Further examples will reveal other types of communication in more detail, but as a preview the response to the preference element in this example will reveal much more than the demonstrated preference by a participant returning the correct amount of change; it will reveal various other types of associated conceptual communication that expands the concept of correct change initially introduced, to that of “making change to accomplish more than one goal or objective”. This expansion of the concept of “change” as it was initially introduced, may also initiate an extension of the original conceptual category classification by requiring additional and different category level knowledge, that can drive innovation. It may mean a participant has to create a whole new conceptual category in his mind because category classification is no longer restricted to similarity for category membership (i.e. money returned from a purchase), but through the commonality of different conceptual goals that forms of a new goal derived category (i.e. money returned from a purchase that itself can be used to meet another objective). Research shows that knowledge can be transferred via category membership as long as the category is sensible, and coherence of a category may occur without similarity between its members, for instance it may involve goal-derived categories. Category organization in the brain is thought to reflect in part an explanatory principle common to all members—and that conceptual goals form such a principle. This research opens the door to the new technology disclosed herein that illustrates how the re-organization, expansion, and extension of categories can improve AI and machine learning. By teaching participants novel categories, researchers have the advantage of being able to manipulate the multiple interfacing opportunities not only through a variable's conceptual narrative, but by task, stimuli, and category structure to assess the role of each in one's ability to acquire a concept and apply it in new examples; and can also be used to create whole new conceptual categories that can allow the transfer of a whole concept—without having to acquire the learning and knowledge through implicit learning—that can save time and money in training new employees, for example.

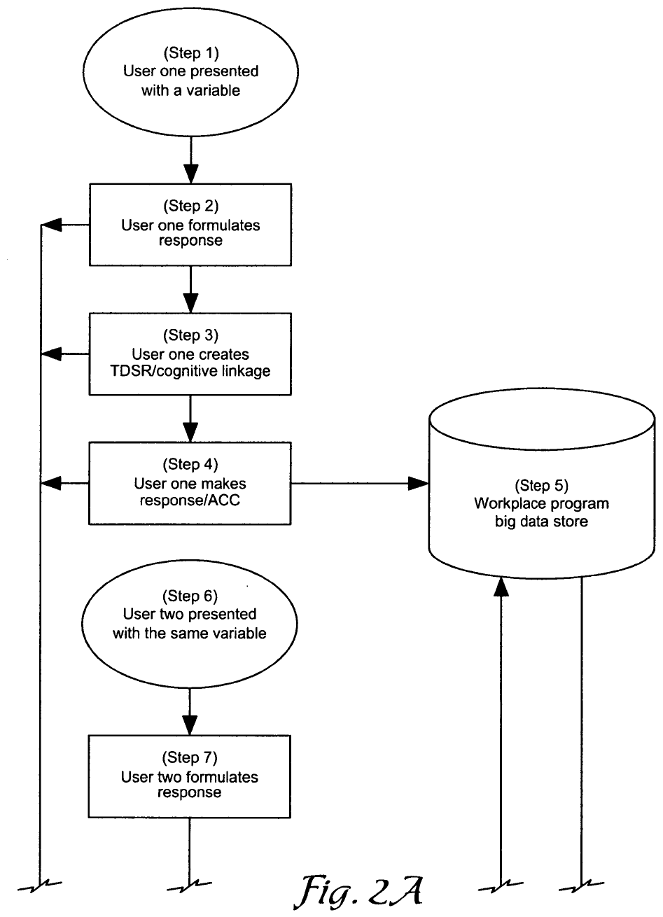

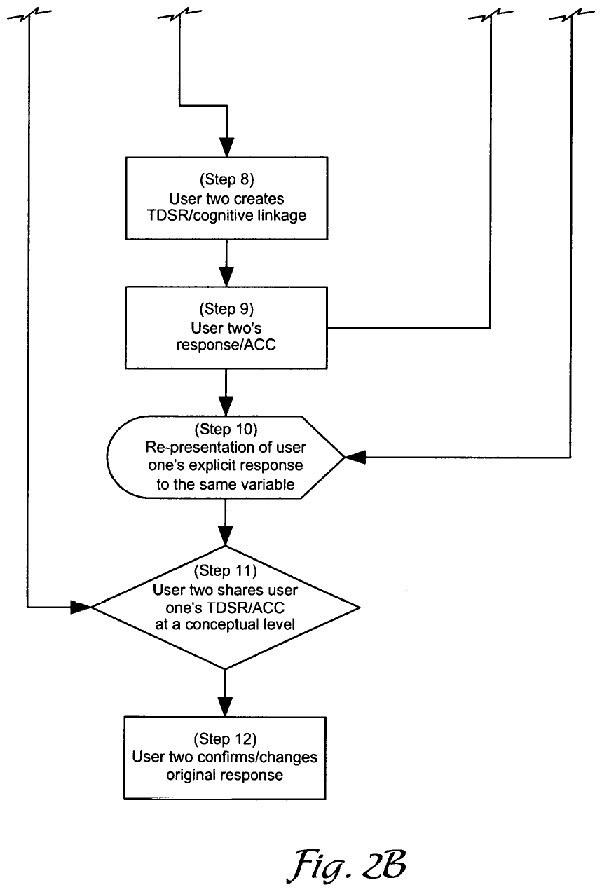

Words and language have always served as the filter for human thoughts resulting in the reality that language may have multiple layers that end up represented by only a single word or phrase—that may not be highly explanatory or descriptive. This raises numerous considerations when we look at developing new ways to communicate. A person putting thoughts into words and language has to exercise thought compression—finding the right words within his vocabulary to describe the thought and/or a given concept. Once another person reads those particular words that person has to interpret what the message originator meant in using those exact words—he has to decompress it. Words can have more than one meaning, and different people can ascribe different meanings to the same word. Sometimes, a word's specific meaning has to be determined by the words and/or context surrounding it. Cognitive narrative strives to utilize specific words and language to enhance a participant's ability to create a mental image that represents the concept being transmitted and participants make their responses to those words in their own way that are then transmitted through the cognitive linkage that has been created. The thought that does not end up with an explicit representation in a response can be transmitted as associated conceptual communication (see paragraph [0123], for example) directly through the cognitive linkage and/or through thought-directed mind-to-mind communication that takes place through an artificial conduit portion of the cognitive linkage that conveys mental content (i.e. thought) such as the reasoning and meaning of the explicit words used in a response it is associated with. In essence, a participant responding to a variable has compressed his thoughts partially into words using language, and another part of it is being transmitted without words—but it only exists because of the words that were used (or weren't used) to originate the thought he is responding to. This ACC that is associated with the text of the response travels through a separate channel of communication—component 2 of the cognitive linkage—because it does not have explicit representation that can be recognized by the base telecommunications hardware. Some of this thought can also go directly from the mind of one participant to the mind of another as mind-to-mind thought-directed communication—level 4 communication—that requires a receiving participant to exercise his perception skills. See paragraph [0090]. AI and machine learning can duplicate this process through component 1 of the cognitive/conceptual linkage using a new type of brain-machine interfacing. Communication from component 2 picked up as associated conceptual communication involving human perception, can periodically be transmitted directly to component 1 as feedback it is receiving through the linkage that component 2 is attempting to analyze and document. Component 1 can then initiate an additional or different type of variable to be presented through component 1 during the three level process that creates further AI and machine learning a result. This extra learning may result from a single preference element response by a single plan participant that can be repeated numerous times as it works its way through the workforce during the three level process. We know associated information is carried through the cognitive linkage by analyzing the responses that are made by participants following the introduction of a new stimulus. Participants are all focusing on creating their own version of simulated reality as well focusing on some of the simulated reality of all the other participants—all of which comes from the identical words presented to all the participants through the cognitive linkage created. But all of it occurs in an environment of intentionality that increases the program's ability to train, educate, and augment—because each participant has their own way of processing a stimulus. So in the new technology disclosed herein, words only partially filter thought—as some of the thought can go from one participant to another in an unfiltered fashion, powering the associated thoughts that keep the linkage (and its transmission process) in existence. The linkage allows other participants to concentrate on the same concept in varying real time. One participant's thoughts are revealed to another participant whose brain is then stimulated to initiate new thought. The technology disclosed herein involves words and language generating thought—and at the same time these thoughts generate new words and language. Using two separate communication components allows the separation of ACC from the explicit language of a cognitive and/or preference element response, and as a result a participant's compressed and uncompressed thoughts regarding a concept can be analyzed. A participant reads and reacts to narrative as he is creating his own simulated reality in his brain and mind that relates to a specific thought or concept. A participant is required to make cognitive and preference element responses involving hypothetical actions and decisions required by, and relating to the temporary simulated reality that has been created. These responses in turn stimulate a new round of responses that continue to power the thought-directed linkage. Separating communication into different channels creates the ability to separate actions and behavior from the reasons for those actions and that behavior, that allows analysis that can be used to create better analytics to predict the results that may come from taking a particular action. This new method of cognitive linkage offers more potential communication to be recorded. This thought-directed linkage extends into a participant's temporary mental image of reality—creating the ability to receive level 3 and level 4 communication. This part of the linkage has no real world physical existence. It only exists in the form of thoughts that exist, even if only for a short period of time. Eventually some of the UCC will be evidenced by an explicit response that documents its existence. Thought-directed simulated reality that exists only in one participant's mind—his personal mental image of a temporary reality can be changed by another participant through a response that introduces a new concept or concept expansion. For example, when one participant makes a response of returning a $5.00 bill as change, and then later changes his response to returning five $1.00 bills after reviewing another participant's responses that never explicitly refers to the “tip” concept. The change evidences that the cognitive/conceptual linkage exists, and can extend from one participant's brain and mind into another participant's brain and mind, and ultimately from one participant's thought-directed simulated reality to another participant's thought-directed simulated reality (See FIG. 2A and FIG. 2B).

It has been said that good questions create good answers. The technology disclosed herein proves that better questions create even better answers. Example training variables are designed to provide multiple ways for a participant to interact with a cognitive variable making possible more types and kinds of communication and therefore more communication, creating the potential to transfer more thought, learning, and knowledge between and among more participants more quickly; all of which represent program objectives. The multiple interfacing opportunities allow a participant to be immersed at a conscious level in thought-directed simulated reality—linked to a specific concept (i.e an idea of something formed by mentally combining its characteristics, a special combination that has a particular meaning), while linked to other participants through the thought-directed cognitive linkage in varying real time. A participant's attention skills are instrumental in creating simulated reality in his mind, because the cognitive linkage is thought-driven. Therefore, linkage intensity will vary somewhat between participants. Immersion in the simulated reality facilitates the generation, transmission, documentation, and transfer of new types and kinds of communication which in turn facilitates new types and kinds of learning and knowledge that can be presented to participants as part of the program and ultimately transferred to them. This new learning and knowledge can then be utilized by program participants in connection with a company's big data to create innovative new products and services that represent new ways to interact with its workforce, partners, and customers that will evidence that the goals and objectives of the program have been achieved (See level three processing [0078]). In order to understand the range of communication that can be generated and transmitted from the presentation of a variable and the capabilities of the thought-directed cognitive linkage that will deliver it to other program participants, further understanding of the following terms will be helpful: (1) explicit information or knowledge, (2) conscious thinking or knowledge, (3) implicit information or knowledge, (4) unconscious thinking or knowledge, (5) tacit information, (6) compressed thought, (7) uncompressed thought, (8) uncompressed conceptual communication, (9) cognitive skills communication, (10) innate knowledge, (11) intuitive knowledge, (12) metaphorical thought, and (13) imbedded demonstrated conceptual preference communication. Revisiting associated conceptual communication (and shadow associated conceptual communication) at paragraph [0055], associated information at paragraph [0056], unconscious conceptual communication at paragraph [0082], and mind-to-mind communication at [0070], might be helpful as well.

(1.) and (2.) Explicit information or knowledge involves information that is set out in tangible form. Fully explicit knowledge is conscious knowledge. It is also referred to as “know-what” knowledge; represented by articulated knowledge, expressed and recorded words, numbers, codes, math, science, formulas, for example. It is retrievable from declaratory memory. It provides the basis for conscious recollection of facts and events. It is learning and knowledge that is easy to identify, store, and retrieve. It is found in memos, notes, and documents. The cognitive element of a variable calls for a response that reveals explicit learning and knowledge. A preference element response may serve as explicit knowledge, if the response is determined to be accurate in its support of a cognitive element, as illustrated in the example variable at paragraph [0101] (i.e. the bill(s) and coin(s) returned by the waiter add up to the correct change owed back to the customer). This example demonstrates quantifiable knowledge that exists in compressed form—a math calculation arrived at by exhibiting cognitive skills. Declarative knowledge can be classified as either episodic or semantic in nature. The accuracy of explicit knowledge is also determined through the collection of associated information, as described at paragraph [0056]. In this example, UCC, ACC, IDCPC, uncompressed conceptual communication, unconscious implicit knowledge, and potentially mind-to-mind communication may also be generated and documented with regard to the cognitive element as to why it was necessary to create $5.20 in change in the denominations chosen. (3.) and (4.) Implicit information or knowledge is not set out in tangible form, but could be made explicit. It includes knowledge that is not fully explicit, and represents the non-episodic learning of complex information in an incidental manner. The result of implicit learning is implicit knowledge, and implicit knowledge is the same as implicit memory. It is also referred to as “know-how” knowledge—how to do something. It is learning and knowledge that is often tapped into indirectly or unintentionally. Implicit knowledge is knowledge that hasn't been put together either by expression, concept development, assumptions that lead to principles, or in the formation of skills or habits and exists outside the consciousness—as a participant does not know what he is learning because he is not aware he is learning something. It is sometimes referred to as unconscious learning. Implicit learning could be demonstrated in a participant's response to a preference element of a cognitive variable, as associated conceptual communication or associated information. Direct or indirect uncompressed conceptual communication could be involved in a preference element response as illustrated in the example variable at paragraph [0101]—i.e. the participant's reasoning for returning the bill(s) and coin(s) he did as correct change, which could be based on the participant's own implicit learning and knowledge. (5.) Tacit information or knowledge is information or knowledge that one would have extreme difficulty operationally setting out in tangible form. It involves acquired personal experience-based knowledge—and is sometimes referred to as know-how—intuitive hard to define knowledge that may require a certain motion, or a particular feel that can only come from experience. In practice, knowledge represents a mixture of explicit, implicit, and tacit elements. (6.) Compressed thought is thought that has been reduced to words (language) or text. Thought compression has the effect of limiting thought when converting it into words, slowing down the transmission of such thoughts to the processing speed of the computing device and the cognitive skills that a participant possesses to accomplish the compression—such as his composite language skills. Thought that has been compressed by one individual and then transmitted means the receiving party has to “decompress” the package you send them linguistically. (7.) Uncompressed thought is thought that has not been reduced to words or text. The ability to accomplish uncompressed communication such as brain-to-brain communication/mind-to-mind communication of concepts between people would avoid the need for compression of their original thought by translating it into knowledge, and then having the other party have to “decompress” the package sent to them linguistically, which is always a problematic process. (8.) Uncompressed conceptual communication is communication that is generated and transmitted at the time of concept transfer that may be documented and quantified by a scientifically acceptable method, that represents thoughts, additional learning, and knowledge relating to a concept that has not undergone thought compression. It may be generated as a result of a variable's conceptual narrative, or may be generated independently in some other way, such as through the preference element response that is illustrated in the example variable at [0101]. The response calls for the waiter to return correct change in bill(s) and coin(s), but the choice of which bill(s) and coin(s) is left up to the waiter (i.e. a program participant). The waiter's preference element response does not call for an explanation of why he chose to return the bill(s) and coin(s) he did, which is imbedded in the response as ACC, IDCPC, and uncompressed conceptual communication, and could also represent mind-to-mind communication if it is recognized by another program participant through perception. (9.) Cognitive skills can generate related communication depending upon the specific skills involved. Uncompressed conceptual communication associated with a particular cognitive skill, such as perception, or attention for example, is potentially measurable and documentable while a participant is immersed in thought-directed simulated reality—as variables contain potential layers of communication that may or may not ultimately be generated depending on how deeply immersed in the thought-directed simulated reality the participant is which can include the perception skills involved in receiving mind-to-mind communication that can be documented and analyzed. Cognitive skills relate to the skills involved in processing thought—the skills and ability to perform various mental activities most closely associated with learning and problem solving. It is normally measured by asking questions or having a participant perform tasks that are designed to test and measure a specific cognitive skill. (10.) Innate knowledge is knowledge originating in or arising from the intellect or the constitution of the mind such as the innate scientific method knowledge witnessed in infants, whereby as newborns they exhibit learning through experimentation. (11.) Intuitive knowledge is to have an idea or feeling about something you feel is true, although you have no evidence or proof of it. It is often revealed by an individual who has extensive experience and training in an area. (12.) Metaphorical thought relates to using multiple cognitive domains to gain understanding of one concept in terms of another. (13.) Imbedded demonstrated preference communication is associated with a preference element response that can be perceived separately from the demonstrated preference response explicitly expressed by a participant. (14.) Unconscious conceptual communication is communication that may occur at the time of concept transfer. It represents unconscious learning and knowledge that may comprise implicit learning, and can be communicated in compressed or uncompressed form.

Uncompressed conceptual communication (UCC) and unconscious conceptual communication contribute strongly to the brain augmentation part of the program in multiple ways, which can represent innovation in its earliest stages, and can represent ways for participants to communicate and transfer learning and knowledge that they possess to other participants not found in other education and training programs. It represents learning that they may not even know they possess such as implicit learning, that when revealed in a response can then be transmitted through the thought-directed cognitive linkage to other participants. This type of unconscious learning and knowledge is acquired in the formation of skills or habits exists outside the consciousness of a participant—a participant does not know what he is learning because he is not aware that he is learning something. So it can be said that the technology disclosed herein, such as the thought-directed cognitive linkage provides brain/cognition augmentation by giving participants new ways to display their knowledge, new ways for that knowledge to be transmitted, and new ways to transfer that learning and knowledge to other participants. The interaction between participants in level two processing allows participants to act in multiple roles—as teacher and student. Participants are exposed to the various types of communication and learn how to identify each type, and what part each type plays in the concept transfer process—so they can use their new learning and knowledge in the most efficient way to carry out their job functions. The example variables at paragraphs [0101] and [0123], that use a $10.00 bill and the $5.00 bill for payment can be used for reference. They demonstrate how participant responses can control the ultimate concept to be transferred, by introducing concept expansion to mean the amount of money to be returned from a purchase that can used to meet multiple objectives—such as leaving a tip. But it also represents a metaphor, depending on how perceptive a participant is. Within an organization, change can mean something different—to “make or become different” such as when a business adjusts its operations to address differing objectives. Uncompressed forms of communication that include some forms of associated conceptual communication, such as mind-to-mind communication—types of communication not reduced to language or speech—provide the advantage of carrying more, and more complex learning and knowledge, and create the ability to link a participant directly to what someone else is thinking. This could also be considered mind reading, if the communication is being generated outside of the originator's awareness as unconscious conceptual communication. The ability to generate and transmit unconscious conceptual communication allows a participant to share learning and knowledge that may exist outside of consciousness that they may not be aware they possess. Concept transfer through the technology disclosed herein, can provide associated conceptual communication and associated information that relates to the thinking behind the concept which may lead to more concepts that can be identified. Research referenced in recent articles shows certain types of metaphors can activate sensory brain regions, that perceptual processing affects conceptual processing as perception representations and conceptual representations are partially based upon the same brain systems, and that perceptual knowledge retrieval activates sensory brain regions, and that mind-to-mind communication can be accomplished over the internet.

Some of the most important observations to be made regarding paragraph include (1.) the variable illustrates one of the fundamental characteristics of language—displacement—the ability to talk about things and/or events other than those occurring in the here and now, that make it possible to cognitively connect with people and places in a manner that does not require physical presence. It is used to help create the simulated reality that initiates new kinds of conceptual communication. The cognitive narrative generates at least two levels of thought—the perceptions created from the meaning of the words used and the mental imagery that is created by the simulated reality that can create an environment that resembles experience from the participant's past—in this case eating lunch in a restaurant. In this example, the participant is thrust into a role-playing situation through the contextual narrative of the variable by the phrase “Imagine you are a waiter in a restaurant”, (2.) through recent research much more is known about “implicit memory”—the unconscious cognitive processing of past experiences that influence our current thoughts, perceptions, and actions. We know implicit memory provides unconscious ways to respond to the world through unconscious stored prior learning shaped by former events, (3.) the variable contains at least two cognitive elements the responses to which must be accurate; to show that the semitransparent thought-directed cognitive linkage has actually been established—at least for some period of time, and that the participant maintains at least a threshold level of cognitive function. In this example, the first cognitive element—the total amount of change of $5.20 owed to the customer, actually represents an invisible challenge because the actual numerical total of $5.20 is not explicitly required in the response, rather, that number shows up in the form of a proxy that requires the participant to calculate the accurate change amount and return the bill(s) and coin(s) that represent the accurate total. If the bill(s) and coin(s) returned totals $5.20, the response is accurate. This signals that the participant is engaged in the environment created by the conceptual narrative. In addition, the participant has had to use symbolic thinking to accurately determine the correct types of bill(s) and coin(s) to return. That choice also serves as the response to a preference element; one that provides additional insight into one or more of the participant's brain processes. This characteristic is important when it comes into play in level three processing, (4) the variable represents, or can be considered tantamount to a conceptual/cognitive metaphor because it requires the participant to switch cognitive domains in order to gain understanding of one concept in terms of another. For example, originally the participant has to perceive that the bill(s) used to pay for the meal are important to the variable concept, but as the concept is expanded in examples at paragraphs [0101] and [0123], the bills and coins ultimately returned to the customer by the waiter become even more important. The concept expansion requires the participant to switch cognitive domains from quantitative reasoning and math skills (primary skill involved in determining the correct amount of change to return) to such skills as perception, planning, reasoning, and problem solving. It is no longer only about correct change, it is more about the form of the correct change in order to meet the customers objectives that probably include leaving a reasonable tip. The participant has had to use verbal reasoning to extract the meaning of some key words from the contextual narrative, initiate simulated reality, perform addition or subtraction (i.e. arithmetic) using quantitative reasoning, and a number of other cognitive skills to get this far. It has been argued that the locus of metaphor is thought, not language; that metaphor is a major and indispensable part of an ordinary, conventional way of conceptualizing the world, and that our everyday behavior reflects our metaphorical understanding of experience, (5) looking at the example variable at [0101], in addition to the two cognitive elements that must be accurate as just discussed, the variable contains at least two preference elements—the first is the choice of which bill(s) to use for payment, the $20.00 bill, the $10.00 bill, or the $10.00 bill and the $5.00 bill. The participant would normally be allowed to make this choice, but for purposes of this example, the choice has already been made. While any of these methods would be acceptable to cover the cost of the meal—the customer ends up with a different amount of change and therefore a different type of bills and coins depending on which bill(s) is presented for payment because the cost of the meal (including tax) does not change. The original concept introduced at paragraph [0086] was expanded by illustrating the $10.00 bill and the $5.00 bill for payment at paragraph [0101] that introduced a new stimulus through the use of associated conceptual communication. An engaged participant would immediately or eventually most likely question why this form of payment is being illustrated, would focus on why the $5.00 bill was included in the payment and, assume it must therefore involve reasoning. If the participant anticipates leaving a “tip”, the concept of the word “change” has new meaning for the participant who is acting as the customer and the waiter. In paragraph [0101], in addition to the uncompressed conceptual communication being introduced between the program and the participant, the customer (and therefore the participant by proxy) is now in the position of introducing the same uncompressed conceptual communication—and depending on his level of immersion in the thought-directed simulated reality at that point in time—may be considered to be introducing it as well. It no longer only means the money owed to the customer from his payment for the meal, but possibly also the money the customer needs in order to leave a tip. The customer's choice of a bill(s) for payment represents the customer's preference over the other options he has—and also that he has chosen to reject those other options at that time. Imbedded in a demonstrated preference response is the reasoning behind his choice represented by imbedded conceptual demonstrated preference communication. This new type of documentable communication can be generated because of the simulated reality created, and transmitted because of the cognitive linkage. Data, information, and knowledge (and thusly intelligence), can be revealed by a participant through his responses to the variables without being explicitly stated. In addition, the linkage carries variables that can present a participant with an open-ended question—not explicitly stated in the cognitive narrative—that is initiated by inference. In real life, the choice of which bill(s) to use for payment would most likely involve uncompressed conceptual communication between the customer and the waiter—what the customer is thinking but has not been specifically expressed regarding a tip. Introducing the tip concept into the variable's conceptual narrative in two ways; first through the conceptual narrative—using the choice of the $10.00 bill and the $5.00 bill for payment involves explicit numbers/words, and secondly through uncompressed conceptual communication—the reasoning behind that preference. Together these new ways of interfacing with the participant changes not only the dynamics of the preference element, but the entire concept to be communicated. “Change” now concerns the denominations of the bill(s) to be returned not only the total value of bill(s) and coin(s) to be returned. This feature of a variable represents a form of “priming”—the implicit memory effect in which exposure to a stimulus influences response to a later stimulus. One of the three choices for payment discussed previously will become the optimal choice for the participant (who is acting in the role of a waiter and is in the position of trying to intuit what the customer is thinking) for reasons that will be disclosed later in more detail. So the second preference element response, the specific types of bill(s) and coin(s) gains importance because a waiter must be able to intuit some things which he cannot know for sure. Only a customer knows whether or not leaving a tip is a consideration, and if so, whether he has the money in his possession to leave a reasonable tip, so a waiter needs to be perceptive, and think creatively. The ultimate goal of cognitive augmentation is not to make a better decision, it is to make the optimal decision, (6) the word “tip” does not appear in the language of the variable, but almost everyone has been a customer, or a waiter or both, so from a cultural perspective leaving a tip would most likely be a consideration in the participant's thinking process, whether or not he ends up actually leaving a tip. So a preference element response provides the participant with the opportunity to demonstrate conscious thinking, learning, and knowledge; in his choice of the bills and coins returned as change, that must also add up to the accurate total change due amount (which if accurate can also be counted as a cognitive element response), and at the same time that change must meet his objectives regarding a tip, and (7) the variable illustrates several of the purposes of the program though through this simplified example, including augmenting and amplifying human intellect by increasing the capacity of man to approach a complex problem situation to gain comprehension to suit his particular needs, and to derive solutions to problems (i.e. to invent and innovate), through the semitransparent thought-directed cognitive linkage that stimulates the transfer of conscious and unconscious (i.e. “implicit”) learning to and from other program participants through an interactive learning process. The linkage creates the ability to gather important data and information involving unconscious cognition—implicit learning and knowledge a participant may not even know he has that could positively affect company productivity and enhance company culture. This learning and knowledge can then be refined and re-introduced in many different ways through the program's three level processing mechanisms—and eventually possibly even the computer system's base authentication process—by creating new variables developed through the program's new implicit learning opportunities. So the program is re-generative by constantly importing new data and information into the program through plan participants daily work product that is reflected in the company's big data.

Considering the example training variable at paragraph [0101] in even greater detail provides additional insight into the term “uncompressed conceptual communication”, introduces a new term “thought-directed unconscious conceptual communication”, and introduces more considerations in using such variables to facilitate AI, machine learning, and cognitive analytics. As previously stated, this variable is tantamount to a conceptual/cognitive metaphor—it uses one idea and links it to another to better understand something. It refers to understanding of one idea, or conceptual domain in terms of another. In this example, understanding change to mean more than the money owed back from a purchase. The importance of this can be illustrated by level three processing for example, when it comes to creating analytics. A conceptual domain can be any coherent organization of human experience. Conceptual metaphors shape not just our communication, but also shape the way we think and act. For example, the conceptual metaphor of viewing communications as a conduit is one large theory explained with a metaphor. A conduit is a natural or artificial channel through which something (such as a fluid) is conveyed; whenever people speak or write as if they insert their mental contents (feelings, meanings, thoughts, concepts, etc.) into containers (words, phrases, sentences, etc) whose contents are then “extracted” by listeners and readers. Thus, language is viewed as a “conduit” conveying mental content between people. Unconscious “implicit” learning can be transferred in uncompressed form.

A cognitive variable's cognitive/conceptual narrative represents a new form of shipping container, that may not have a fully explicit physical existence (responses become part of a variable's narrative and they may not be fully explicit), that is instrumental in creating a simulated reality that has no physical existence, that is able to convey concepts and multiple types of communication that do not have explicit physical existence through the thought-directed cognitive linkage that may not have explicit physical existence. “May not” is used to recognize the fact that some levels of communication may have physical existence (e.g. a response carried in textual form—such as level 2 communication); ACC, IDCPC, and other forms of uncompressed communication often do not exist in explicit form. The linkage can facilitate the transfer of conscious and unconscious learning and knowledge in compressed or uncompressed form that may involve implicit memory, and accommodates the transfer of an entire concept or expanded concept at one time. This is brought about through the computer software product, the thought-directed interfaces, the contextual narrative, cognitive element(s) and preference element(s) that may comprise a form of cognitive (conceptual) metaphor, that involve a complete concept or portion of a concept, and the interactions and responses made by and between program participants. In totality, this combination, coupled with the semitransparent cognitive linkage accommodates the transfer of uncompressed conceptual communication which may be non-quantifiable, and quantifiable and non-quantifiable unconscious conceptual communication of implicit learning and knowledge through implicit memory. The conceptual narrative always leaves gaps, that will be filled by mental images created by the participant(s) themselves that represent prior memories, learning, and knowledge previously created, that will contribute to the overall understanding of a concept to be transferred, as explained later in more detail. This new kind of container fits in with the conduit theory of metaphor (i.e. conceptual metaphor theory). Because this container allows the transfer of a complete concept it serves the purpose of providing faster learning among participants. The transfer concept as a whole may be thought of as a puzzle box cover that shows a picture of the completed puzzle so that the builder of the puzzle knows what the finished puzzle looks like and helps to keep focus as he chooses the pieces needed to complete the puzzle. Drawing an analogy, the puzzle pieces could each be thought of as a potential analytic that fills in a gap that eventually allows the completion of the big picture—an unknown shared secret that when revealed helps a company reach its ultimate goals. An entire workforce—hundreds or even thousands of employees—could work on the same puzzle every day on their own—at their own speed—but all with the same specific goals in mind—the very definition of “intentionality”.

The example variable at paragraph [0101] describes a situation where a waiter brings a customer a bill for his lunch in the amount of $9.80, including tax. The customer, Bill, has a $20.00 bill, a $10.00 bill, and a $5.00 bill that can be used for payment. The participant, who has now been cast into the role of the waiter) leaves the table with the customer's payment—the $10.00 bill and the $5.00 bill—telling the customer he will bring back his change. In paragraph [0086], the example variable's cognitive narrative does not provide the same insight into the actual money available for payment as this example does, and does not require the participant to decide which bill(s) and coin(s) the customer would use to make his payment. In making his response to the variable at [0101] the participant will have to extract information relevant to the meaning of the word “change”, and “bill” as both of these words have multiple meanings and those meanings must be ascertained using the context surrounding their use. That signals the importance of the contextual narrative. The word “bill” is used in different contexts; as part of the conceptual/contextual narrative, as part of the cognitive element, and as part of the preference element. The word “change” takes on different meanings, its meaning changing as the variable's elements are responded to, and each time the amount of cognitive narrative is increased in some other way. The first time the word “change” is used in the contextual narrative, is when the waiter says to the customer that he will bring back his change. By that point, any experienced waiter would already know that he had received more money than necessary to pay the bill (i.e. $15.00 for a meal costing $9.80); and he understands that he owes the customer money back from his payment. If he believes he is entitled to a tip, he also knows that it might have to come from the change he is returning to the customer. (The participant knows this from the cognitive narrative of the variable). The second and third references to the word change in the narrative concerns the question “What bill(s) and coin(s) would you return to him as “change”. He must now decide how he is going to substitute bill(s) and coin(s) to create the total change due of $5.20—but also understanding that he is going to exchange something that exists in one form (i.e. “change” of $5.20) into another form (i.e. the specific bill(s) and coin(s) that total $5.20) using symbolic thinking. The word “tip” does not appear in the variable. A waiter understands that leaving a tip is a voluntary choice in most environments—expected in others. In the variable then, the fourth understanding of the word “change” includes thinking of it not only as a return of money owed back to a customer for a purchase, but something very different—the potential source of a tip. So the context of “change” now means not only turning it into bill(s) and coin(s) that total $5.20, but also changing it into the most advantageous denominations of the bill(s) to easily accommodate the payment of a reasonable tip. The customer could have paid him using only the $10.00 bill, but he didn't choose to do that. He gave the waiter an extra $5.00 bill for an unstated reason. Proof of his perception skills and a mind-to-mind communication that has taken place can be evidenced by the leaving of a tip of several dollar bills. Another definition of “change” means “to give or get an equivalent amount of money in lower denominations in exchange for”. So when the waiter told the customer he would bring his change back, while he may not have explicitly stated that he was going to change the $5.00 bill into five $1.00 bills he may have unconsciously communicated that idea through mind-to-mind communication, as he did not explicitly state exactly how the change would be paid, illustrating another example of uncompressed conceptual communication. In this situation, the waiter and the customer could be attributing different meanings to the word “change” however. In this situation, that involves a participant being cast into the role of waiter, it could also represent unconscious conceptual communication as a waiter could be thinking he is doing exactly what the customer wants him to do, and the question “do you need change back?” does not really address the problem either. This particular variable contains numerous other examples of unconscious conceptual communication.

Examining the participant's response in more detail provides more insight into the participant's thinking process and discloses further layers of uncompressed conceptual communication and implicit learning that can be recalled through implicit memory. The total bills and coins returned by the waiter may represent unconscious learning which is often disclosed through the demonstrated preferences made in response to a preference element. The participant is choosing the bills and coins that he does, instead of other options for a reason—and that reason may be that it represents implicit learning—the unconscious learning occurring in the formation of skills or habits. The knowledge acquired through implicit learning does not have an explicit representation. Waiters who receive tips as part of their compensation want to put themselves into the position of receiving maximum tips from a customer they serve; a concept that is formed very early in their training. The design of the example variable, and its cognitive narrative puts the participant into the shoes of the waiter for training purposes (and also indirectly the customer). Understanding that the waiter is going to try to earn a tip, the participant will want to put the waiter into the best position he can to make that happen. In the real world, a waiter would not know what cash the customer had to use for payment. Since the participant has already demonstrated several times that he has at least a threshold level of cognitive function in reaching this point, he knows the $5.00 bill alone cannot be used to pay for the meal. If the participant elects to use the $10.00 bill, that would take care of the bill certainly, but it could leave the customer with only a $20.00 bill, a $5.00 bill, and $0.20 in coins—cash that would not represent payment of a reasonable tip. If the example would have illustrated the $20.00 bill for payment, and the change was returned properly, there would be enough change to leave a reasonable tip, but using that bill does not assure that outcome. If the waiter returns a $10.00 bill in the change, the customer would be left with two $10.00 bills, a $5.00 bill and $0.20—cash that would still not provide a reasonable tip. So leaving the decision totally in the hands of the waiter might still not solve the customer's problem if he in fact wants to leave a reasonable tip. So for illustration purposes, and to further describe uncompressed conceptual communication, specifying the use of the $10.00 and $5.00 bill for payment (that being the optimal choice for the customer and the waiter) serves as the best way to transfer the expanded concept to participants. All the obvious payment options will be examined during level two processing. If the waiter did return a $10,00 bill, the customer would have to ask the waiter to break one of the $10.00 bills or the $5.00 bill in order to provide the waiter with a reasonable tip. We can never be sure of all the things another person is thinking (particularly one person acting in the role of another), at least until we learn everything there is to know about the human brain. We do know exactly what the transfer concept of learning entails—taking learning from one situation and transferring it to a new situation. Paragraph [0101] illustrates a participant making the decision for the waiter to return five $1.00 bills and $0.20 in coins, because that assures there will be money available for a reasonable tip. He knows that in this situation, because the contextual/conceptual narrative told him what bills were available for payment. The participant is demonstrating that he understands the concept through uncompressed conceptual communication and/or unconscious conceptual communication, because he is acting in the role of a waiter at the direction of the cognitive narrative. But there is also good reason to believe that the customer is telling the waiter that he needs change for the $5.00 bill through uncompressed conceptual communication. Otherwise, he would have just presented the $20.00 or the $10.00 bill for payment. But that would not have presented the same transfer concept of learning as the variable that is provided for training purposes. Cognitive thinking would suggest that a customer would not send the waiter away with an extra $5.00 bill, just to have it returned in that same form. Additionally, if he really wanted to leave it all as a tip, he could still leave all five of the $1.00 bills. All these considerations provide insight on the participant's cognitive reasoning skills, creative thinking, and decision making skills as either the teacher or the student involved in three level processing.

The conceptual narrative does not state whether or not the customer actually leaves a tip, which leaves a gap in the story worth considering. If the concept transferred involved uncompressed conceptual communication and/or unconscious conceptual communication (i.e. the customer leaves a tip larger than $0.20 and less than $5.20), the semitransparent thought-directed cognitive linkage enabled the transfer as intended, and validates the uncompressed conceptual communication (i.e. mind-to-mind thought-directed communication) intuited by the waiter (i.e. who is actually the participant); the waiter in fact perceived the communication being sent to him by the customer, and was carried through the cognitive linkage that extends outward from a participant's simulated reality. At the same time, in real life a participant may be perceiving mind-to-mind communication that the variable concept originally introduced has been expanded.) If the customer leaves $0.20 or less, that doesn't prove his uncompressed conceptual communication was not transferred, there are lots of reasons for not leaving a tip or a very small one—a poorly prepared meal or very poor service for example. But if that is the case, those reasons, if left unstated in the variable, could represent additional uncompressed conceptual communication relating to the reasoning for the small tip. The customer could be sending a totally different message by leaving only a $0.20 tip.

The cognitive element(s) of a variable requires an accurate response for several purposes including providing evidence that the semitransparent thought-directed cognitive linkage is operating. The variable at paragraph [0086] shows how this linkage is initiated and exists during level one processing. Many of the definitions related to communication suggest that a message is sent and received. But, there is not a requirement that a message be understood in order to be considered communication. That raises legitimate questions as to whether evidence of the new method of linkage disclosed herein needs to include proof of something more than the communication itself; rather it should require other elements such as understanding—an acknowledgment that exists in the form of empirical evidence that can prove “received and understood.” An accurate cognitive element response serves as evidence that a message was “received and understood”. The variable illustrates a cognitive element that involves math, and quantitative reasoning and cognition that involves math is special because it also requires executive function. Executive function is a cognitive skill, and research suggests that executive function skills which include monitoring and manipulating information in mind (working memory), suppressing distracting information and unwanted responses (inhibition), and flexible thinking (shifting—the ability to flexibly switch attention between different tasks) play a critical role in the development of mathematics proficiency. Executive function is the name given to the group of processes that allow us to respond flexibly to our environment and engage in deliberate goal-directed thought and action. It forms the basis of abilities such as problem solving and flexible thinking. Many people believe executive function skills are important for learning and performance across all academic subjects—but they also believe that the precise relationships with different domains may differ—and its impact may be different in its application to previously acquired mathematics knowledge and learning new mathematical material. The variable's cognitive element at [0086] calls for response of $10.20 to be considered accurate. But to arrive at that number several other functions had to be correctly performed. The math equation had to be extracted from the cognitive narrative in order to arrive at the accurate response (i.e. money tendered for payment—bill for lunch=change), and subtraction had to be performed accurately (or, as an alternative, the adding up method of making change could be used. Adding up involves addition instead of subtraction and would involve an explicit type of learning (at least until it becomes implicit learning through habit). There is no reference in the variable relating to how to develop an an equation or how to solve a subtraction problem—but both involve quantitative reasoning—that involves learning and knowledge that must be generated from the participant's brain. So, the participant had to “change” the variable and switch cognitive domains in order to arrive at the accurate response by using verbal reasoning and converting it into quantitative reasoning—in essence causing a participant to switch cognitive skills in the process. Executive function requires a participant to keep information that is being created in short term memory in place, while new information is being brought in as well. In this example, making an accurate response to the variable's cognitive element provides evidence that cognitive linkage was established and in place for some period of time in order for a participant to come up with the accurate response of $10.20 that most likely indicates that the concept transfer was received and understood.

If as the program progresses and concepts are transferred that can affect a participant's cognitive function, IQ, and/or behavior, it might eventually have an effect or alter some of the user's cognitive/behavioral biometrics or behavioral analytics that are used for authentication in a computer system's base cognitive authentication/access management system. For example, in the area of demonstrated preferences. But even when the semitransparent linkage accomplishes the transfer of an entire concept the individual procedural steps which will impact each participant differently because their personal cognitive skills will still have to meet the accurate response criterion that involves associated information and the neural coding and decoding measurements) they demonstrate compared to another participant. Each participant's response would result in a difference in typing speed even if they all demonstrated the same preferences after the concept was transferred from one to the other. So, while the program might result in an equalization of overall conceptual ability, each participant will still demonstrate his individual capabilities in his other cognitive skill levels and associated information measurements. For example, one participant could easily do the math required for the example variable at paragraph [0086] in his mind for example, while another might perform the math on his fingers—demonstrating that the concept would still involve individual ways of processing associated information and thusly represent different processing speeds. That same dynamic allows “all the participants” to be involved in the semitransparent linkage at differing levels—and that creates the need to address different speeds on the learning curve. The response to a cognitive element that is used to evidence this linkage has to be accurate, and as pointed out at paragraph [0178], the criterion for a cognitive element response to be deemed accurate could require not only an accurate math calculation for example, but also that the neural coding and decoding measurements match, thusly requiring that several factors would have to match those of the participant (which then could be used as continuous authentication metrics during the three level process as well).

Using the metaphorical type example variable presented at [0123] as a conduit to transfer mental content—such as the concept of considering the word “change” as something more than what it first appears to be can create opportunity within a business organization. For example looking at “change” in a new and different way. Thinking of it as not only the return of money owed for a purchase, but as something with the potential to deliver more value and to achieve more than one objective—for instance a potentially meaningful source of revenue to help a business achieve its objectives. Take for example a thrift shop that normally sells used clothing that has been donated to the shop to benefit individuals in need. At a given point in time, such as when a large natural disaster effecting many people has occurred, the concept of “rounding up” the purchase price of an item to the next highest dollar could create a substantial amount of cash donations as well, that the shop could earmark to help those in need of emergency funds as well as clothing. A new program of that type simply represents a different method than asking a customer to deposit change into a container on the counter for one worthy cause or another. In this situation, however, the worthy cause represents an additional way to help those that need to buy groceries and other items to get them through the emergency—that represents a new and different temporary objective for the shop. But, this situation involves new and different considerations because it involves a new way of asking for donations—that includes asking for money from potential beneficiaries and existing benefactors of the shop who might be purchasing goods to distribute through their churches, for example. When considering this concept for adoption, new technology and brain training/augmentation could be used in conjunction with AI, machine learning, and big data/cognitive analytics to test various strategies regarding the potential benefits (as well as any negative implications) that exist before such a program is actually implemented. This would involve considerations such as how well the concept fits in with the organization's basic mission, or how additional inventory can best be secured, and the overall long term effects of taking money away from current customers that might be on a fixed budget that might have been used to buy more clothing, which involves predictive analytics and the ability to perform big data/cognitive analytics that involves a broad and diverse set of data to consider. The analytics will probably involve both deterministic and probabilistic computing. But the major underlying considerations will also involve human intervention because they will involve knowledge that may well be invisible to a computer system—that lives within the culture of the community and the organization itself and that could reveal uncompressed conceptual communication that if it could be captured, could be used to predict how the current customer base might react to the concept and/or considerations regarding the economic impact of involving current patrons in an overlapping program. Geographic and economic demographics will be critical to such a program. This is where an internal dedicated analytics program can be invaluable and may make all the difference; by uncovering unknown shared secrets that can be used to create the most relevant analytics to assure that any new program is designed in a way that can attain success, and that does not result in alienating existing benefactors and customers.

One of the more unique features of the semitransparent thought-directed cognitive linkage is that it enables and accommodates transfer of learning (i.e. the application of skills, knowledge, and/or attitudes that were learned in one situation to another learning situation, even if the learning did not represent conscious learning). It also addresses a basic goal of the dedicated program—increasing the speed of learning. Positive transfer occurs when something learned previously aids in learning at a later time. Transfer of training refers to the effect that knowledge or abilities acquired in one area has on problem or knowledge acquisition in other areas; effectively and continually applying the knowledge, skills or attitudes that were learned in a learning environment to the job. The semitransparent linkage created by the method disclosed herein, supports at least two levels of the transfer concept of learning—“tip” considerations, and the ability to apply the learning created in a training program context to a real-world situation during level three processing. The program puts an emphasis on both of these through the language and context posed by the cognitive variables that have been presented to the participant. The linkage accommodates the transfer of conscious and unconscious thought; and compressed and uncompressed conceptual communication, therefore accommodating the broadest range of transfer capabilities that can be measured by today's standards to ascertain the program's accumulated progress at any particular point in time. The cognitive linkage established in level one processing can be evidenced by an accurate response to a cognitive element of the variable presented and other channel 2 communication generated. The cognitive linkage established in level two processing can be evidenced by an accurate response to a cognitive element each time a new response stimulus is presented, and/or in a cognitive element or a preference element response during the prototype variable modification process. Level three processing communication linkage can be evidenced in the same manner as in level one and level two.

The unconscious learning acquired through “implicit learning” that is recalled through “implicit memory” can be transferred through the semitransparent thought-directed cognitive linkage method disclosed herein, as associated conceptual communication—category level knowledge transferrable in the form of a thought, idea or concept based on the common properties of abstraction and generalization (such as those created by the preference element response to an example variable in the level two processing section). This leads to a series of related questions as to whether, and how, the new kind of linkage disclosed herein might be especially valuable. For example whether or not a mentally impaired person can re-learn lost category knowledge more quickly through concept transfer from other participants using the technology disclosed herein, whether a person can re-learn an unconscious concept from himself by making responses that reveal implicit learning and then reading the explicit responses he has made to the preference element(s) while he is consciously engaged in the three level training and augmentation process—re-learning it consciously, whether or not it is possible to transfer innate and acquired cognitive procedural knowledge and learning categorized as unconscious in a strict sense, to the same extent as unconscious implicit learning whether as research has indicated, there may be situations where implicit learning and explicit learning occurring together can have a positive effect on transfer of learning, and on a macro level could using both types of learning potentially represent the fastest way to close the digital divide. Further, in brain injury situations might it make sense to attempt to transfer entire concepts rather than selected information and knowledge, and then if learning gaps need to be filled in, that could be attempted. The cognitive linkage is capable of transmitting metaphorical thought that might be generated during a concept transfer. If a participant can be the recipient of uncompressed conceptual communication and can learn the unconscious implicit learning of another—turning it into conscious learning—it would seem that the traditional transfer of learning knowledge would be affected in some significant manner. This concept could be used to totally change the way unstructured data could be analyzed if a new type of algorithm could also be created. The key to finding some of the answers to these considerations involve utilizing cognitive behavioral biometrics, and all the other transfer components mentioned in the semitransparent thought-directed cognitive linkage definition [0076]. The technology discussed in this application discloses an enhanced version of the transfer concept of learning through the semitransparent thought-directed cognitive linkage that can speed up innovation by distributing the tools of thought that will allow program participants to display their unique and creative problem solving capabilities, and eliminates the need to make economic based decisions as to who should be the beneficiaries of a brain augmentation program, one involving the implementation of brain chips or that uses expensive helmets, for example. The technology allows all the company's employees to transfer learning and knowledge to other program participant's through the interactive training and education process that takes place in level two and three processing. Once conscious and unconscious learning has been transferred using these methods, participants can then leverage this knowledge and learning with other participants, as the cognitive augmentation program advances forward. Because the linkage allows the transfer of conscious and unconscious learning (from implicit memory), participants can share knowledge and experience in new ways, maybe even turning their own personal unconscious knowledge into conscious learning and knowledge—learning and knowledge they may not even know they had—through uncompressed conceptual communication. It doesn't matter whether the learning is conscious or unconscious at any specific point during the transfer process because the technology disclosed herein accommodates transfer in both forms; as long as at the end of the three level process unconscious and conscious concepts exist in enough detail to allow the transfer of that concept to be accomplished between and among the remaining program participants. While definitive answers do not exist yet for all the questions brought up in this paragraph, the technology disclosed herein provides new tools for use in the research that can help provide the answers. Each cognitive variable includes gaps in the conceptual narrative that represents the difference between what is stated in the cognitive narrative and what could be called “the full story”—the same situation a business faces every day. It means that to make the optimal decision in a situation, one needs to fill in gaps with the greatest amount of pertinent information, and then act. If he can't get at least a threshold amount of information, sometimes he still has to act. The example variables used herein include gaps; for instance they do not state whether the waiter is experienced or brand new on the job, and so participants do not know whether the participant was ever trained as a waiter in a “tip” environment that might have resulted in existing implicit learning and knowledge regarding the “tip” concept.

Analysis is separating out a whole into parts, studying the parts individually and then learning their relationship to one another. Analytics is the principle or logic that drives the analysis. Analytics is the method of logical analysis. Therefore, we do analysis using analytics. Analysis looks backward over time, analytics look forward to model the future or predict a result. Both help marketers transform customer's data by exploring and analyzing that data to help uncover unknown patterns, opportunities, and insights that can drive proactive evidenced-based decision marketing. Two cognitive skills listed at the top of required skills for working with analytics are innovative problem solving and systems thinking. These two skills can be broken down further: being able to diagnose the problem being addressed, and in order to find a solution—how the information is linked conceptually. By necessity then, the skills required include the ability to understand how an entire system works, how an action in one part of a system affects the rest of the system—adopting a big picture perspective on work, integrating information, judgment, decision making, abstract reasoning, and process interaction. The technology disclosed herein allows a company to create a workforce program of training and augmentation that includes all of the critical skills necessary to understand the analytics creation process.

The technology disclosed herein can contribute to a workforce's innovative capabilities by assisting program participants turn data into information, information into knowledge, and knowledge into wisdom and intelligence, and then to transfer and distribute that among the entire workforce. The program initiates and promotes this concept on a continual basis creating a new form of internal communications that can stimulate the entire workforce—and potentially the entire customer base. This program creates a new way for a participant to communicate implicit learning and knowledge that he may not even know he has, and that he is otherwise unable to pass to other employees. Participants who have better information processing skills, and have acquired greater learning and experience in a given area than other participants can now transfer that knowledge and experience which they may not even know they have to other participants in a way that speeds up the learning curve. This new method of cognitive linkage brought about through the components described herein, facilitates the transfer of a new types and kinds of communication that includes unconscious conceptual communication—implicit learning and memory that a participant may be unaware of and that he cannot verbalize (i.e. that cannot be compressed unilaterally through the participant's normal thought compression mechanisms because it is not consciously available to the participant for processing). The semitransparent thought-directed cognitive linkage method makes thought processing faster, more transferable, and could dramatically alter the way in which we collectively communicate with each other. Today we are limited when we speak with others by the speed with which we can compress thought into words, and when we interface with a computing device to send a text we are limited by our skills and abilities to type or text. But through the cognitive linkage method disclosed herein, which enables communication in an uncompressed state to take place in the form of uncompressed conceptual communication, the linkage enables the transfer of an entire concept or part of a concept in fewer steps at close to the speed of thought. Once the original response(s) to a preference element involving uncompressed conceptual communication or compressed conceptual communication of unconscious implicit learning using implicit memory is made and recorded by one participant, it can be transferred to many other participants in varying real time limited only by a participant's reading speed and pertinent cognitive skills (i.e. how fast they can read and think). Hypothetically speaking, that puts the speed somewhere between where we are today, and pure telepathic communication. As more and more employees of an organization are exposed to a new concept for example, the concept speeds up at an accelerating pace through the workplace because it moves through cognitive linkage that keeps getting extended. A company's most innovative minds are those most in the know regarding a given concept—and they are then always in a position to move concepts that have potential to move forward with modifications quicker. The most innovative and best concepts will move forward faster—and can even be prompted with an innovation reward program of some type. The method disclosed herein involves uncompressed conceptual communication that comes to a participant during level two and level three processing that is likely to come on an anonymous basis—after several participants have worked on its modification. That means other participants do not know exactly which participant initiated the initial response to a variable. The uncompressed conceptual communication could be sent out to many participants at one time, and responded to by many of them. The first participant to read and respond to a new stimulus introduced could be considered the participant who acknowledges the communication. The program administrator sets the parameters of the program and monitors and controls the three level process as it progresses. All variables could require approval by the administrator before they are forwarded on to maintain quality and to maintain centralized control of the variables (that could involve confidentiality concerns), and the program as a whole. The brain/cognitive training and augmentation program administered through the three level process that establishes semitransparent thought-directed cognitive linkage creates a new type of BMI (brain machine interface) whereby thoughts are transferred from one participant to another, and among all participants at the speed of thought—each participant's own speed of thought. Since participants bring different cognitive skill levels and abilities to the program, as well as their personal training education, job skills, and belief systems, the transfer of thought that may take place as uncompressed conceptual communication at each participant's own speed of thought as they read and interact with the cognitive variables while they interact with other participants. This is particularly true while they are involved in level two processing. A BMI is defined as a direct communication pathway between an enhanced brain and an external device—in this case the pathway is the semitransparent thought-directed cognitive linkage that carries the cognitive variable shipping container that enables conveying mental content between a machine and a human, and between and among humans that accommodates the transfer of unconscious implicit learning and implicit memory as unconscious conceptual communication. The process evolves as follows: Participant one is presented with a cognitive training variable in level one processing, the message is received by the participant and using his cognitive skills, and he makes his responses to the variable involving the cognitive and preference elements. If the concept involves the possibility of implicit learning, participant one uses his implicit memory to respond to the elements and responses that may be considered to comprise unconscious conceptual communication. After this communication that may involve conscious and unconscious learning takes place, participant two is presented with the variable, and eventually participant one's responses (and the associated conceptual thought that goes with it that may include implicit learning and knowledge). He reads it using his cognitive skills and abilities—at his own speed—and the conceptual transfer which may consist of the entire concept or part of the concept takes place at the speed of thought (i.e. the speed at which participant two acquires the conceptual transfer). The same variable (with accompanying associated conceptual thought that goes with it) can then be presented to each of the other participants in the program allowing the optimal transfer of learning to take place on a massive basis at the speed of thought. Paragraph [0123] explains how the variable presentation and re-presentation process unfolds that allows evidence that this transfer of learning is in fact taking place.

The method of brain/cognitive training and augmentation disclosed herein democratizes the digital divide somewhat instead of widening the gap. It addresses concerns relating to a stratified human race based on those who can afford brain chip augmentation and those who cannot. The creation of the new type of thought-directed simulated reality brought about by this new method of conduit conveying mental content between people—readers of the variables “extract” their own level of meaning and understanding of the conceptual message that is being delivered from the conceptual narrative—and then they are exposed to the reality of their interpretation, perception, and creative thinking by sharing their responses with the other participants in level two processing. As shown by the conceptual narrative of the example variables, the creation of the thought-directed simulated reality can play an influential role in our ability to understand perspectives other than our own at the current moment without the threat of confrontation that could for instance cause us to take an action, like donating money to a worthy cause as explained later in the section relating to level three processing. That's the reason for learning the basics about analytics; how to analyze past data to predict and impact future results. Scientists have been working on understanding the human mind for centuries, but recent improvements in brain related technology have given us a picture of the brain that improves our understanding tremendously.

Scientists have now unraveled how our brains create “time windows” of the world, and provide a new understanding of how memory works. Research indicates that the brain stores memories according to blocks of time when the memories are created which means these blocks of time may be accessed by using the conceptual narrative of the cognitive variables and the semitransparent thought-directed cognitive linkage established in combination to create a disturbance or disruption that opens a specific window of time in a participant's implicit memory—so that unconscious conceptual communication can be achieved relative to a specific time period using a new form of simulated reality that can open a specific door to the implicit learning that occurred during a specific time potentially. For example, by adding cognitive narrative that states the name of a popular song on the radio that can be dated. The cognitive and preference elements can also be used to facilitate disruption. Presenting a variable to a participant that is similar to one previously presented to him, but with targeted conceptual narrative, or a change in one of the other two elements, could provide evidence that modified conceptual narrative representing a different context and time period could be used to access a different “time window”— potentially allowing access to different implicit learning that could potentially indicate when the implicit learning was actually created—while turning unconscious learning into conscious learning. The cognitive and preference elements can also be used to introduce a new stimulus that disrupts the concept originally introduced, while not explicitly stating why that preference was demonstrated.

The semitransparent thought-directed method of cognitive linkage can exist at different levels between and among program participants. For example, differing levels could mean a participant transferring implicit learning he does not know he has through unconscious conceptual communication using his implicit memory to another participant that may be learning it on a conscious level through a prototype variable presented in level two processing. For example, imagine two different participants interacting in the program, and further that participant one is responding to a cognitive variable that involves implicit learning that is unknown to participant two. That means participant one is acting in the role of “teacher”. When participant two reads and responds to that same variable after participant one has made his responses, we can assume some level of uncompressed conceptual communication has taken place regarding the implicit learning and knowledge of participant one, that involved the variable concept, or part of a concept. Participant two is acting in the role of “student” prior to the process of reading and responding to the variable; assuming he had never been exposed to or thought about that exact concept before. Participant one's linkage involved the transfer of implicit learning through his implicit memory—the unconscious cognitive processing of past experiences that influence our thoughts, perceptions, and actions, that provides unconscious ways to respond to the world through unconscious stored prior learning, shaped by former events—to participant two who is learning the whole concept, or part of the concept but not in the same depth or context that participant one acquired the conceptual learning and knowledge that he acquired as a waiter. Participant one may not even know he has this implicit learning; or that he is acting in the role of “teacher”. If the transfer of implicit memory is being carried out in the semitransparent thought directed linkage at a given moment of time, any participant who sees that response a that moment can be thought of as connecting with another participant's memories in varying real time. Further proof of the existence of the cognitive linkage at some level can be evidenced if more than one participant is presented a variable requiring the same exact cognitive element response, and all the participants provide an identical response. It could be likened to multiple participants tuning into the same television game show at the same time—and all participants coming up with the same identical accurate response to a question (i.e. cognitive element response) at the same moment—showing all of them are cognitively engaged in creating a response to the same thought-directed variable emitted by the same outbound digital signal—that indicates everybody has in fact received that same exact signal and at least for a moment in time all of them were cognitively involved in the same task. Isaac Newton suggested that “seeing a falling apple” and his “contemplative mood” were at least partially responsible for his inspiration for the theory of gravity. The variable presentation process disclosed herein, which begins during level one processing, is designed with three main factors in mind: (1) maximizing the benefits provided to the program's participants (2) presenting the variables in a manner that provides empirical evidence of the benefits claimed, and (3) that AI, machine learning, and cognitive analytics are all enhanced by the way the variable presentation process is carried out, and the infrastructure involved. In other words, it is critical to be able to validate the uncompressed conceptual communication that has taken place between the computer system and a participant, and between two or more participants. This will involve providing evidence the cognitive linkage has been established, and then to identify a thought-directed concept to be transferred, creating a cognitive variable to serve as a container for the mental content involved in the concept, and then designing and creating the conceptual narrative, the cognitive elements, and the preference elements relating to the concept to be transferred—all the items necessary to convey the mental content that will need to be extracted by program participants during the transfer process in order to fully grasp the concept or part of the concept. The thought-directed interfaces then need to be coordinated to carry out the three level process that will provide maximum benefits to the participants and the business sponsoring the program. Lastly, the actual transfer of a concept needs to be documented before using it to form new analytics. Evidence of the cognitive linkage between the computer system and a participant is detailed in previous paragraphs. The existence of this linkage between two or more participants is also detailed. However, the most powerful evidence is presented at [0123], and FIG. 2A that relates to presenting and re-presenting variables through the three levels of the three level process; that illustrate why the order of presentation of the variables is so critical. Much of the proof that the linkage and that the actual conceptual transfer has taken place will be created as participants make successive responses to variables presented earlier.

The example variables at [0086] and [0101], and within this paragraph, illustrate how the cognitive narrative and the order of presentation of the variables can be carefully orchestrated to cause interactions among different brain areas to accomplish the goals and objectives of the program. Level One Processing: As explained at paragraph [0081], training variables are systematically presented to all program participants in level one and level two processing. An accurate response to the cognitive element of the variable at paragraph [0086], $10.20, is required to make sure certain program infrastructure is in place. If an accurate response is made by a participant, an accurate response credential is created and the participant advances to level two processing as far as that particular variable is concerned. Level Two Processing. Participants who have been presented with the example variable at [0086 and 0101], and have advanced to level two processing by making accurate responses, are presented with a second modified version of that variable: “Imagine you are a customer in a restaurant. You have cash in the form of three bills in your wallet to pay for lunch—a $20.00 bill, a $10.00 bill, and a $5.00 bill. Assuming the bill for lunch is $9.80 including tax, which bill(s) would you use for payment and what change (or as an alternative—what specific change) would you expect to get back? The modifications to the example variables presented earlier, are designed to further engage participants in the thought-directed simulated reality created by the conceptual narrative of the variable by providing the opportunity for participants to assume the role of being the customer, and to introduce more of their own thinking into the response to the preference element to give them a sense of having some control of the simulated reality they are continuously attempting to create. A participant's response to the preference elements can also change the cognitive element response, by changing or adding a new stimulus. It gives certain participants who have implicit learning regarding a variable's concept the ability to provide a response that may result in an expansion of the original concept, and starts the variable modification process of level-two processing that may ultimately turn the prototype variable into a inside training variable. A participant will fall into one of four categories as the modification phase continues, based on responses he makes. A participant's initial response will determine the order the next few variables will be presented to him as a method of identifying best ways to apply the transfer concept of learning to that participant; for instance, whether implicit learning and knowledge exists that could affect a concept transfer in some way. For illustration purposes, looking at the first preference element relating to the choice of which bill(s) to use for payment, category 1 could include those participants who picked the $10.00 bill and the $5.00 bill and calculate the correct change to be returned (and they receive an accurate response credential and move up in level two processing), category 2 could be participants who picked the $20.00 bill, category 3 could be those presenting the $10.00 bill, and category 4 could be those presenting some other method of payment that is sufficient to pay the bill. Those category 2,3, and 4 participants who accurately calculate the amount of change owed from the bill(s) presented also receive an accurate response credential moving them up to the next higher level of level two processing. All participants in level two processing will be presented with accurate responses made by other participants to open a dialogue regarding further modifications that can turn this into an inside variable, which also provides the opportunity for participants to gain additional insight into the brain processes of other participants. By asking a participant to switch roles from the waiter to the customer and then back to the waiter and the customer while continuing to provide accurate responses to the cognitive element(s) that are required to create accurate responses credentials, can provide empirical proof that the cognitive linkage and simulated reality are still in existence. Having the participant switch roles between waiter and customer in this manner, can play an influential role in a participant's ability to understand perspectives other than his own at the current moment (see “empathy”, [0055]). All the participants, regardless of category, will participate in the process of modifying the variable starting with their own level-one response and through the process of modifying the variable by responding to the changes in stimuli as the process continues, some in the role of teacher and some in the role of student. Following the participant's new responses to the variables, there are several ways to generate further concept expansion. The first way has been illustrated—by re-presenting the variable (or another participant's response) stating that the customer decides to pay using the $10.00 bill and the $5.00 bill to those participants who didn't already pick that response (i.e. those who elected to pay using the $20.00 bill, or the $10.00 bill, or even the $10.00 bill and the $5.00 bill, but did not return $1.00 bills as part of the change), through the use of disruption [0121]. This group of participants may be demonstrating uncompressed conceptual communication, because after two or three chances to consider a tip, they are still ignoring the “tip” concept—meaning it is not a consideration, or because leaving a tip was never brought up in the conceptual narrative. Certain category. 1 participants have probably already expanded the concept in their minds to address using part of the change returned for “tip” purposes. This introduction of the tip concept in this way represents the beginning of a string of independent, uncompressed conceptual communication taking place between different parties involved in the simulated reality. One of these is the uncompressed conceptual communication transmitted between the computer system (i.e. the training program software) and the participant, that involves conscious thinking in real life and in real time by introducing a scenario that requires the participant to interpret why the program would have had the customer pay that way, without telling him the reason why, since he didn't previously make that response. Asking the participant to use symbolic thinking in order to pay back the change suggests a change in stimulus, otherwise the variable could just have let the participant use their original pick—which was something other than the $10.00 and the $5.00, or no $1.00 bill(s) were returned. This new variable introduces a new or additional stimulus—without an explanation as to why. There may also be associated uncompressed conceptual communication between he customer and the waiter taking place in the simulated reality, because there is no explanation as to why the customer made the choice to pay with the $10.00 and the $5.00 in the conceptual narrative of the variable, possibly leaving the waiter wondering why this choice was made. So there is consciousness involved with the simulated reality to the extent the cognitive element requires an accurate response as to the total change owed the customer, and symbolic thinking is required to return bill(s) and coin(s) that add up to that amount. These are conscious real life and real time decisions that are made in response to the simulated reality established. But there is also unconscious implicit memory involved in doing the arithmetic (addition/subtraction) to arrive at the accurate total change amount. A second way to introduce the expanded concept is to modify the conceptual narrative as follows for example: “Assume the bill for his lunch is $9.80, including tax, but not including a tip”; which explicitly introduces the “tip” concept. After a transfer of concept has been accomplished, all the participants should have an opinion on the final version of the variable(s) that will be presented to the program administrator for approval of the conceptual narrative of a new training variable, that can include cognitive and preference element modifications. After multiple participants have been presented with the same variable in Level Two processing, modifications can be discussed in more detail, about why narrative was added, changed, or deleted. For instance, the pros and cons of disclosing what exact bills the customer has to use for payment. The category 1 participants could participate in the dialogue or not, as their responses will already have been noted. The other participants, having been exposed to all the category 1 responses, will either understand the concept or they will not. The answer to whether or not the concept has been transferred will be evidenced by the participants responses to similar variables that involve the same transfer of learning as the original variable (such as the one in paragraph [0176]). If their response has changed, and they use the $10.00 and the $5.00 and return the change using five ones, the total concept transfer will be evidenced. If a participant uses the $20.00 bill but in the change returns five $1.00 bills, at least part of the concept has been transferred. If other answers are provided, it doesn't prove the transfer wasn't completed, but illustrates there may be other considerations involved—such as negative learning that challenges the participant's belief system that he entered the program with. Instincts are the tendency to act in certain definite ways, without previous education and without a conscious end in view. Level two processing generates all types of associated conceptual communication through interaction of a participant with the multiple interfacing elements of the variables presented and re-presented.

A participant's preference element response generates a significant amount of thought, data, information, learning, and knowledge that can be transmitted and communicated to other program participants through the cognitive linkage that has been created for education and training purposes. Certain types of knowledge can change while it is being transmitted through the cognitive linkage, and it may also represent a different type of knowledge for one person than it does for another. For example, it may represent implicit (unconscious) learning and knowledge of the participant making the response, and represent explicit (conscious) knowledge for another participant who reads that response. This can be illustrated by the participant's preference element response presented earlier in this paragraph under the heading of the level two processing. “assume the bill for lunch is $9.80 including tax, which bill(s) would you use for payment and how much change would you expect back?” A participant's response using the $10.00 bill and the $5.00 bill for payment may generate many kinds of communication that can be transmitted through the linkage all at once: explicit (conscious) learning and knowledge represented by the participant' correct change calculation of $5.20; implicit (unconscious) learning, if, for example, the participant worked as a waiter at some point and recognizes that he is going to have to create the bill(s) that can be used to leave a reasonable tip; compressed thought to arrive at the correct total of bills and coins to return as change, $5.20; uncompressed conceptual communication that introduces concept expansion to address the idea of creating change that can be used for more than one purpose; imbedded demonstrated preference communication that may indicate intent, reasoning, other preferences and or other objectives; cognitive skills communication that is generated as the participant is exercising certain cognitive skills that includes associated conceptual communication and associated information that may be measured such as neural encoding and decoding—and possibly innate or intuitive knowledge, and other types of unconscious conceptual communication. The ability to generate and transmit so many kinds of communication in making a response through the cognitive linkage means a concept transfer can be accomplished faster. Variables can be designed to achieve certain goals and requirements because their design can anticipate that certain kinds of communication will be generated. While all these types of communication can be generated and transmitted through the linkage, some of it must be transformed in order to be picked up as big data. In essence communication may have to be changed during its time in the linkage in order to reach its maximum utilization capability—that of being easily transferable to other participants. For example, transforming a participant's implicit learning and knowledge into another participant's explicit learning, uncompressed conceptual communication into explicit conscious knowledge, and imbedded demonstrated conceptual preference communication into explicit conscious knowledge. Some types of communication must undergo some level of thought compression. If a participant, as student, cannot initiate part of the simulated reality required for a concept transfer using his perception and verbal reasoning skills, the concept might not be transferrable until level two processing when he sees a response made by another participant. The participant could also potentially change implicit knowledge to explicit knowledge making it known to himself, by making a thought compressed response to a preference element, that can then be identified, quantified, and documented. The cognitive linkage and the multiple interfacing opportunities within a single variable make this possible within a single response, and within a single communication channel. Just as important, it benefits the development of big data and cognitive analytics, because it is all happening within one preference response, Divergent kinds of communication can be brought together in a company's big data that may never have been brought together otherwise—and that may never even have become big data—because there would not have been any reason to connect them; that can now create new pattern matching opportunities. For example, the kinds of communication mentioned previously can be brought together by the fact that they were all part of a single demonstrated preference response. Certain category-level implicit knowledge can be transferred between participants if it involves a goal-based category with commonality between category members; the commonality here being that they are all part of the same demonstrated preference response (see FIG. 2(a)). The various kinds of communication could be considered a novel category because all are part of one response, yet all can be identified separately that makes a disruption possible, that can lead to concept expansion, and even to the generation of brain-to-brain communication. For analytic purposes, those specific kinds of communication have now been brought together in a novel goal-based category, which presents the opportunity to demonstrate how each one, and collectively, they relate to how to make correct change to achieve more than one objective. Comparing the big data relating to the original example variable at [0086] to the example variable at [0101] that includes all the various kinds of communication that can now be collectively analyzed because they have been collected under the umbrella of one conceptual category as part of one preference element response, the cognitive linkage demonstrates how the expanded concept has been made more readily ascertainable and more transferable. Successful learning involves linking new knowledge to what is already known. All knowledge consists of concepts. The cognitive narrative sets out the types of bills available to use for payment, the chosen preference of payment using the $10.00 bill and the $5.00 bill can be analyzed in comparison to other available options to determine a rationale as to why that method might have been chosen, and the proposed rationale can be validated reviewing three or four types of communication collected. The correct amount of change—$5.20—that represents explicit conscious knowledge of the correct change to be returned to the customer—can quickly be recognized as the equivalent of a cognitive element response if the participant's choice of the bill(s) and coin(s) to be returned equals $5.20 ($10.00+$5.00−$9.80=$5.20). The participant is now faced with uncompressed conceptual communication as to why the example variable illustrates the use of those two bills which significantly exceeds the actual cost of lunch, realizing the $10.00 bill alone would have been sufficient. The participant can immediately determine that using the $10.00 and the $5.00—which serves as the preference element response—the demonstrated preference and imbedded demonstrated conceptual preference communication that relates to the choice of using those two bills for payment can only have been presented because there is another objective involved that must be considered—the tip concept—and that the extra $5.00 has been included because after all alternatives were considered, turning that $5.00 bill into five $1.00 bills is the only way to have the cash to leave a reasonable tip. A preference element response allows a participant's implicit memory and implicit learning and knowledge to be made explicit—to that participant and to other participants. The three conceptually related example variables presented at [0086, 0101, and 0123], presented in a systematic order with modifications to cognitive narrative, eventually allow the participant's reasoning and the real stimulus to be identified—i.e. having the cash to leave a reasonable tip after paying the bill for lunch. This represents an unknown shared participant shared secret [0083]. The imbedded demonstrated conceptual preference communication can validate the customer's can validate the customer's reasoning for using the two bills. This illustration demonstrates three types of communication involved in the cognitive linkage have changed forms: the imbedded demonstrated conceptual preference communication that existed separately from the demonstrated preference itself was not previously available to be collected in big data, but because of the cognitive linkage it was transformed into conscious explicit knowledge that can be considered an accurate preference element response that supports a cognitive element (i.e. the $10.00 bill and the $5.00 bill represent a cognitive element response and a preference element response), serving two purposes at the same time. Having been made conscious explicit knowledge it would now be available for big data collection. If the participant had experience as a waiter, returning five $1.00 bills would reflect his implicit learning, turning his unconscious implicit learning into conscious explicit knowledge for another participant. The UCC introducing the concept of making change for more than one objective has been transformed into conscious explicit knowledge if the participant returns five ones instead of a $5.00 bill. Potentially being able to transform implicit learning and knowledge into explicit knowledge, unconscious knowledge into conscious knowledge and learning, unconscious UCC to explicit conscious knowledge, and imbedded demonstrated conceptual preference communication into explicit conscious knowledge, and then to be able to transfer it to other program participants would bring it out of dark data into big data to be available for analytics by all the participants. Continuing, using the example variable presented earlier in paragraph [0101], if the preference element response (i.e. the total bills and coins to be returned to the customer) totals $5.20, it could be considered to be a cognitive element response as well (i.e. $5.20=$5.20 in bill(s) and coins). But the UCC, as to why has this form of payment chosen for education and training purposes and why the customer choose this method of payment for demonstration purposes, all being part of the communication generated through this one preference element response has the effect of making the $10.00 and the $5.00 bill payment method conscious explicit knowledge as well. The participant chose this method of payment over other options available because it accomplishes his goals (which are unknown for sure at that point), but that leaves the impression that he wants change back for some reason. We can tell that the participant is engaged in the simulated reality to at least a threshold level because he has been able to recognize the stimuli presented thus far, and because he did not choose to pay with the $10.00 bill, which would have been sufficient. The participant is perceptually experiencing the simulated reality and has reached or surpassed the threshold level of cognitive function to activate several higher level cognitive skills thus far, and the accurate response to the preference element represents conscious explicit knowledge. The collection of multiple types of communication through one preference element response has significant implications as far as cognitive and big data analytics are concerned, as pointed out earlier in this paragraph. The collection of at least ten types of communication is significant because it ties the correct change total of $5.20 to the UCC described earlier through the collection of the various types of communication as part of one preference element response for cognitive and big data analytics purposes, that would not have otherwise have occurred. The various types of communication specified at paragraph [0105] can now be used to create a novel conceptual category involving the commonality being that they are all part of one preference element response; that can in and of itself be considered to formulate a goal-derived category. New examples belong to the category not based on their level of similarity to the other members or to a category average but according to their fit to the conceptual goals or basis for membership—not similar in terms of a broad overlap of features, but nonetheless a sensible category. One explanation of how knowledge can be transferred is by category membership. The goal derived category in this case would be “making the correct change to accomplish more than one goal (that may not be clear at the time)”. That makes it semitransparent. A preference element that is accurate can be considered to be a cognitive element response. A cognitive element response that is accurate can serve as a preference element response. For example, a return of change that meets the objectives of the customer, and that at the same time is accurate as to amount, means that the waiter accomplished the goals of the customer, and that he read his UCC correctly—the customer wanted change for the extra $5.00 bill that was above and beyond what he needed to pay—that could now be validated if the customer leaves one or more $1.00 bills as a tip. At the same time, the UCC would be made explicit because it meets the customers preference, it was UCC and now that it has been validated, it can be considered explicit conscious compressed knowledge by having been compressed into that demonstrated preference response. To the extent the UCC can be considered implicit learning, that implicit learning has been turned into explicit conscious learning and knowledge. The interfacing opportunities presented by the cognitive and preference elements of a variable that support each other allow multiple types of communication to be generated and transmitted through the cognitive linkage that creates a method of communication linkage that can accomplish uncompressed direct conceptual transfer. In implicit learning, learners remain unaware of the learning that has taken place, although it is evident in the behavioral responses they make. Implicit learning cannot be verbalized. In the case of explicit learning, learners are aware that they have learned something and can verbalize what they have learned. The cognitive linkage allows transfer of learning and knowledge that participants can articulate, and that at the same time may suggest uncompressed communication. Brain chips can be used to input knowledge and learning, and/or unethical knowledge and learning, and it is unclear how such learning can be undone once it has taken place.

To have a rational meaning, things must always be defined in terms of other things, or in terms of their uses. Everything depends for its meaning on its relation to other things, and the more of these relations we can discover, the more fully do we see the meaning. It is by thinking that these relations are discovered. That is the purpose of thinking. Thinking takes the various separate items of our experience and reveals to us the relations existing among them, and builds them together into a unified, related and usable body of knowledge, threading each little bit on the string of relationship which runs through the whole. The process of classification is made possible by what is called the concept. The concept lies at the bottom of all thinking which rises above the seeing of the simplest relations between immediately present objects. What the concept consists of finally is the common qualities or attributes of the class, which have been abstracted from the different individuals of the class and built together into a new image whose function is to enable us to classify our experience, and thus to deal with classes or universals in our thinking. Language comes in and crystallizes our concepts in words, so that we are able to understand each other's thoughts in oral or written speech. Words must change in meaning as concepts change, hence the language of a thinking people is constantly growing. Domain specificity relates to the concept that some aspects of conceptual knowledge are innate, or emerge very early in a child's development, such as some types of unconscious procedural knowledge needed to classify objects and events in the world; while others are acquired through learning and inference. This theory has been advanced to explain situations such as savant and genius that have been identified at an age that cannot have involved learning—these people are simply too young to know such things. But today, we believe that all children have some innate unconscious procedural knowledge. According to Plato's theories, nothing is exactly equal in experience—but only “almost equal”. If we do not learn our concepts from experience—we must already know them. This knowledge must come from birth. Moreover, studies suggest that children learn more about the world in much the same way that scientists do—by conducting experiments, analyzing statistics, and forming intuitive theories of the physical, biological, and psychological realms. Since about 2000, researchers have started to understand the underlying computational, evolutionary, and neurological mechanisms that underpin these remarkable early abilities. Obviously, children are not doing experiments or analyzing statistics in the self-conscious way that adult scientists do. The children's brains, however, must be unconsciously processing information in a way that parallels the methods of scientific discovery. The central idea of cognitive science is that the brain is a kind of computer designed by evolution and programmed by experience. A new picture of childhood and human nature emerges from the research of the past decade. Far from being mere unfinished adults, babies and young children are exquisitely designed by evolution to change and create, to learn and explore. Those capacities, so intrinsic to what it means to be human, appear in their purest forms in the earliest years of our lives. Our most valuable human accomplishments are possible because we were once helpless, dependent children and not in spite of it.

The ability to transfer this unconscious innate conceptual knowledge from one participant to another participant if it still exists from childhood, and the desire to learn, could change the world in ways we can't even imagine—such as being able to transfer certain types of unconscious knowledge to stroke and brain trauma patients by presenting specially designed cognitive variables through thought-directed interfaces and the cognitive linkage method. Reasoning is the highest level process of cognition. Reasoning is in some way present almost from the claim of consciousness. We can define reasoning as thinking with a purpose of arriving at some definite end. Similarly, during perception, the viewer may be aware of two objects in the external environment, but not of the mental calculations performed to determine that one is closer or larger than the other. Unconscious procedural knowledge of this sort appears to be innate. Many aspects of cognition are supported by specialized presumably evolutionary specified learning devices. There is also innate understanding and processing capability that exists—so if it is only the ability to do math so fast, for instance, does exist, it may not exist through implicit memory—but some kind of DNA capability to perform the math problem presented to them in a way that normal math could not be accomplished. In other words, it is not that a specific number is carried in their memory and recalled, it is a special processing capability. Between these two factors—the math and the language capabilities (i.e. rules of grammar exhibited by complete sentences that could not have been learned) that cannot be fully explained at such a young age—the special domain-specific cognitive modules could explain this. The cognitive variables that contain conceptual narrative, the general format, how they deal with elements, and presentation in the form of cognitive metaphor that requires domain switching during a single variable all combine to disclose innate learning capabilities. It is possible that the newest brain scanning equipment will show these modules. A variable could be designed for the use of proof of concept that would require domain switching in a cognitive/conceptual metaphor using advanced imaging devices to map the brain activity as domain switching takes place, the “educated” vs “uneducated” brain mapping and pathways could be compared and extraordinary deviations noted and could be researched further.

Unconscious conceptual communication and compressed unconscious conceptual communication is communication that is transmitted through the semitransparent thought-directed cognitive linkage that facilitates the brain/cognitive training and augmentation program disclosed herein. It is the learning revealed through a participant's implicit memory comprised of the procedural linkage acquired outside consciousness involved in skill and habit creation. This memory cannot be accessed through conscious memory, but may be revealed in task performance where these skills and habits may assist the participant in his task. In essence then, the linkage enables concept transfer of implicit learning that a participant may not be consciously aware of. Procedural knowledge appears to be unconscious in the strict sense of the term. We are aware of the goals and conditions of procedures, and the products of their execution, but not the operations themselves. The scope of the cognitive unconscious may actually be much wider than the conventional thinking has promoted—the view that unattended percepts and unretrieved memories cannot influence conscious experience, thought, and action. Thus, the classic information-processing model, by regarding attention and rehearsal as prerequisite for a full fledged analysis of the stimulus and by implicitly identifying consciousness with higher mental processes, leaves little or no room for the psychological unconscious. It is now believed that a good deal of mental activity is unconscious in the strict sense of being inaccessible to phenomenal awareness under any circumstances. Some unconscious procedural knowledge appears to be innate. However, other cognitive procedures appear to be acquired through experience. In the case of skill learning, the process is initially accessible to consciousness and later becomes unconscious by virtue of practice. In other words, skills that are not innate may become routinized through practice, and their operations thereby rendered unconscious. Both innate and acquired cognitive procedures may be unconscious in the strict sense of the term. A great deal of information processing takes place outside of working memory. This in contrast to the implications of the classic model of information processing, a great deal of complex cognitive activity can be devoted to stimuli that are themselves outside of phenomenal awareness. Explicit memory requires the conscious recollection of a previous episode, whereas implicit memory is revealed by a change in task-performance that is attributable to information acquired during such an episode. Research shows that people can display implicit memory without having any conscious recollection of the experimental basis of the effect. The events contributing to implicit memory effects were clearly detectable by the subject, and attention was devoted to them, and they were represented in phenomenal awareness at the time they occurred. However, it shows perception and memory outside of phenomenal awareness. It is now clear that procedural knowledge can interact with, and utilize, declarative knowledge that is not itself accessible to conscious awareness. In order for ongoing experience, thought and action to become conscious, a link must be made between its mental representation and some mental representation of the self as agent or experiencer—as well, perhaps, as some representation of the environment in which these events take place. These episodic representations of the self and context reside in working memory, but apparently the links in question are neither automatic or permanent, and must be actively forged. One area in particular that has received considerable attention is the study of implicit memory—unconscious cognitive processing of past experience that influence our current and future thoughts, perceptions and actions. Recent studies involving implicit memory reveal that a great deal of learning (information processing) takes place outside of working memory on an unconscious level, and it has tremendous influence on how we look at the world. Transformative learning is defined as the social process of construing and appropriating a new or revised interpretation of the meaning of one's experience as a guide to action. Recent research in long term memory has changed the classical view of implicit memory. It is now believed we have several different kinds of memory systems, each playing a significant role in defining who we are as a person. The implicit (nondeclarative) system involves the unconscious development of thoughts and actions. Implicit memory can be received, stored, and recovered outside the conscious awareness of the individual. These memories seem to be long term, consistent, and reliable, providing an array of unconscious ways to respond to the world. From implicit memory (i.e. implicit learning) emerge habits, attitudes, and preferences inaccessible to conscious recollection, but these are nonetheless shaped by former events, influence our present behavior, and are an essential part of who we are. Procedural knowledge are skills and habits, inclusive of perceptual and cognitive abilities, which research has shown can be learned and improved upon outside of one's focal awareness. Existing neural evidence suggest that skills and habit learning are different from declarative awareness. The various forms of implicit learning create a picture that implicit memory not only operates on a separate system of the brain, but also has a tremendous influence over our thoughts and actions. Furthermore, it operates outside our conscious awareness and ability to reflect, and has the potential to contribute to a transformation of meaning structures. Over time, certain daily routines become habit operating at an implicit level. This suggests that possibly by the very act of taking on and practicing new skills and habits without reflection, meaning structures are altered in an unconscious level, allowing perspective transformation to take place. In essence, people can demonstrate many skills, tasks, and cognitive abilities though are unable to explain how they occur and where or when they learned them. Some studies suggest that it may not always be a good idea to analyze the reasons for our preferences too carefully. Research does not rule out the need for introspection, but recommends that at times an unexamined choice is worth making. It means trusting what you learned on an implicit level and not always resorting to critical reflection when reasoning and making decisions. Research also shows that implicit memory aids the performance of particular types of tasks without the awareness of previous experiences. When needed, procedural memories are accessed and used without the need for conscious control or attention. It is learning and repeating a complex activity over and over again until all the relevant neural systems work together to automatically produce the activity. The program disclosed herein involves a two-fold approach. The training variables in level one processing are designed for the purpose of presenting a concept (i.e. the presentation phase of the program), designed to develop a participant's cognitive skill levels in areas important to the future of a business. The participant's responses to the training variables serves as a starting point to create a baseline for each participant that can be used to measure the program's impact on a participant as he progresses through the program. Level one processing involves presenting training variables through the thought-directed training interface, which establishes the initial semitransparent thought-directed cognitive linkage between the computer system and a program participant that facilitates the presentation of the variables that will provide new conceptual knowledge and learning. Each variable approved for use in the program is eventually presented to every participant and requires each participant to make a response to the cognitive and preference elements that will be captured and recorded. A cognitive training grid can be created for each participant as described at paragraph [0061]. How the program unfolds from there for a given participant is determined by the participant's responses to the variables. Level one is designed to provide brain/cognitive training and augmentation, by improving each participant's brain and cognitive function, and represents the main benefit of the program. The example variable at paragraphs [0086] is designed to present the general concept of calculating the correct change from a purchase. An accurate response to the cognitive elements is required to validate that the cognitive linkage has been established and that the participant meets at least a threshold level of cognitive function. The responses to the preference elements must be accurate, correct, or acceptable. Level two processing represents the concept expansion phase; which will be accomplished through the collaborative interaction between participants utilizing the cognitive linkage to communicate between themselves as prototype variables are modified into inside training variables to use in the program and eventually possibly even in the base authentication system. The thought that is transferred between participants during the modification process represents a second type of brain/cognitive training and augmentation by creating the capability for one participant to transfer implicit learning through implicit memory to another participant through the cognitive linkage as uncompressed conceptual communication, that could not otherwise have been transferred. It is also possible to transfer innate conceptual knowledge (i.e unconscious procedural knowledge) by capturing the preference element(s) responses that indicate children can learn by themselves through their innate ability to apply a valid form of the scientific method. Part of the infrastructure involved in the establishment of the linkage creates a new form of simulated reality that initiates unconscious implicit learning and memory that can be transferred to other participants through participants use of implicit memory. Imagine the following example, participant 1 is directed by the conceptual narrative of the example variable at paragraph [0123] to act in the role of a customer. Imagine participant 1 has actually been a waiter in real life, and that he acquired implicit learning in that job. Participant 1 elects to use the $10.00 bill and the $5.00 bill to pay for his lunch costing $9.80. Let's assume participant 2 is involved in the variable modification process of level two processing, and has never been a waiter. After participant 2 responds to the variables at [0086, 0101], he elects to use the $20.00 bill for payment in his first response in level two processing. After collaborating with other participants during level two processing, which includes seeing participant one's level one response, and the information associated with that response, participant two exhibits transformative learning and also validates the conceptual transfer of implicit learning from participant 1, by making his second level two response to the variable this time electing to pay with the $10.00 bill and the $5.00 bill, and returning five one dollar bills and $0.20 in change, because the concept was expanded to include “tip” considerations in his own mind—the concept that the change he returns not only means returning the money owed the customer, but creating cash in a form that allows for a reasonable tip. The semitransparent thought-directed cognitive linkage allows the transfer of unconscious conceptual communication from participant 1 to participant 2—and between and among other program participants at the speed of thought—each participant's own speed of thought. The conceptual transfer involved in the presentation of this example variable includes the big picture concept and could also include procedural learning transfer when considering the entire change making process as a whole. The entire conceptual transfer can be evidenced by participant 2 making the same response as participant 1 when he signs off on the final variable modification in level two processing. So a third form of brain augmentation is being able to accomplish conceptual transfer through the thought-directed cognitive linkage involving types of communication that could not have been transferred before, to a large group of program participants at the speed of thought, that could speed up internal innovation. A basic concept presented a participant in level one that can improve the cognitive skills of that one participant can be expanded in level two, to accommodate an even broader conceptual transfer to not only that participant, but to a large group of program participants at the speed of thought that can transform learning and training throughout the organization—providing training and augmentation from outside the organization, while at the same time transferring skills and experience within the company's existing culture by facilitating new kinds of communication to be accomplished internally. In levels one and two processing, a basic concept was presented and then expanded and transferred between and among program participants. By expanding the concept to include tip considerations in level two processing, the minds of all the participants have been expanded to see the potential uses of “change”, and possibly a desire to come up with other ways to use change that might directly benefit the business or a customer program participant. Returning to level two processing (FIG. 2A) for one additional thought, it is possible participant 1, by revisiting an original response from level one processing, could actually consciously experience transformative learning, through the cognitive linkage established. For the first time he may be consciously experiencing his own unconscious learning. So this could be considered another form of brain augmentation—putting a participant more in touch with learning and knowledge he already has—and only participant 1 could know whether that is the case. Another purpose for level two processing is that the learning can be used in level three to create value for the company by speeding up innovation. By examining the transfer of implicit learning using the optimal solution for illustration purposes—the one that illustration purposes—the one that offers the fastest learning to promote innovation and that speeds up the learning curve. The fastest way to put those two requirements together is to point out the optimal solution and then encourage employees to experiment with that concept to see if they all arrive at that same conclusion. The type of considerations that are brought up through interaction with other participants will stimulate their thinking. So the transfer of the concept illustrating the $10.00 and the $5.00 does not spell out the reasoning of participant 1, but the dialogue and other interactions between and among the participants in level 2 processing should cause all participants to understand why the $10.00 and the $5.00 represents the optimal form of payment, for the customer and the waiter, but only if the $5.00 bill is converted to five $1.00 bills. But the variable's uncompressed conceptual transfer also involves the mind-to-mind communication that relates to the concept expansion itself, brought about by the new stimulus introduced. In order to achieve maximum brain/cognitive augmentation benefits, a moving stimulus has been used. The ultimate concept transferred through the variable is that the real stimulus that is ultimately going to cause a person to take action must be properly identified in order to see that action take place—not just any stimulus that may be involved but the real stimulus. It illustrates that a stimulus can change, and that change must be recognized. (Change represents the money owed back, which depends upon the money tendered for payment—not the cost of the meal, and the change that is ultimately given back may have to serve an additional purpose for a tip and ultimately perhaps for other purposes that could benefit the company in some yet undetermined manner). There is more to the word “change” than meets the eye. Creativity is the ability to come up with new and original ideas, or new and unique solutions to problems. Innovation is the conversion of ideas from the creative process into a benefit. This can include new or improved products, services, or processes. To be innovative, it must be useful and add value. A business must be able to take advantage of innovation. Creativity involves an understanding of convergent and divergent thinking. Convergent thinking is when individuals attempt to solve problems with a single, correct answer. Using rational arguments, eliminating probable incorrect paths, systematic and logical of elimination to arrive at an answer of decision. Divergent thinking is solving problems with many possible solutions—incorporating spontaneous and free-flowing ideas, and in a non-linear fashion. Irrational thoughts and illogical responses to problems are sometimes encouraged, in order to obtain new and novel answers. An atmosphere that supports trying new things is critical to creativity, as it encourages experimentation. Recent research suggests that most creativity is not accomplished by dramatic and earth shattering moments of creation, but rather “doing new things with old things”. Most new ideas come from an ability of some people to look at the world differently and make novel connections between what already exists. Creativity has been identified by many CEO's as the number one most critical “leadership competency” of the future. However, unfortunately, studies show that the creativity level of U.S. children has been steadily declining since the 1990's. While some individuals are certainly more prone to being creative, an important recent finding is that creativity can be taught.

The language and design of a variable's cognitive narrative can ultimately change what participants learn in the program. Level two processing addresses this issue by assuring that participants receive relevant training by involving participants who are already associated with the business and therefore already part of the company's culture. It allows participants to use collaboration to build variables for use in the program, promotes the team building concept, and potentially increases the ultimate benefits offered by the program—to the participants as well as the company.

The example variables presented illustrate how level one brain/cognitive training and augmentation can improve cognitive skills and cognitive function, for example, math skills, decision making, creative problem solving, and symbolic thinking. But level one also prepares participants for their participation in designing and building cognitive training variables in level two processing that requires them to assume a new role that allows them to contribute something back to the program, and the company.

A preference element not only provides a method of capturing and measuring a participant's preference, but also provides insight into why a participant demonstrated that preference as opposed to another. As an an illustration, the cognitive credential technology disclosed herein creates an historical record of the modifications made to a variable during level two processing that allows all participants to track the final inside training variable (or an individual response) back to the original stimulus. As more and more big data gets created during the modification process, participants can keep track of the history of a prototype variable to be able to determine where, when, and how the big data changes so that a participant can determine the real reason (and the real stimulus) a customer uses to make a given decision. This helps assure that a preference element response can be matched back to the real stimulus that a company needs to know in order to generate a desired response. (In the previous illustrations, it is the return of the correct amount of “change”, or the correct change so that the customer can leave a reasonable tip). Level two and level three processing involve dynamic processes that can allow for the collective work of many employees to be directed at a specific issue at each participant's own time and pace, as they don't all have to be physically present with each other as the dynamic process unfolds. Each participant can work at his own pace, but all are working with the most up-to-date information regarding a concept or issue.

### Additional Level Two Processing Considerations

Level two processing has been discussed in previous paragraphs—it promotes training and cognitive augmentation through the transfer of conscious and unconscious thinking, learning and knowledge between participants brought about from the interaction between participants while they teach and learn while collaborating on the design of new inside cognitive variables. Level two processing often involves the further expansion of a concept first disclosed in level one processing. The interface can be considered to be a form of E2E (business employee to business employee), utilizing a computer system that has internet and/or intranet connectivity. The variables built through collaboration during level two processing are multi-purpose variables, which if further modified may even be used as random cognitive logon variables in a system's base authentication process, training variables for use in level one processing, and after any necessary modification to serve as prototypes for a new style of conversational interface for use in communications with a company's customers or providers as part of level three processing.

Using the cognitive variables in the role of a conversational interface, the semitransparent thought-directed cognitive linkage, and the level two thought-directed interface in combination allows the company's workforce to be connected through neuro-technology that creates a new type of brain machine interface (BMI), that creates the potential to create other new types of relationships—the total benefits of which can only be imagined.

As in level one processing, participants are cognitively linked during level two processing by means of the variables presented through the thought-directed user-to-user training interface as they collaborate with other participants in designing and building new cognitive variables. To initiate the process, a thought-directed interface can present a prototype cognitive training variable to randomly selected teams of level two participants, and all the team members remain unknown to the other team members and to the members of all the other teams during this processing. Through interaction with all the team members during level two processing the prototype training variable will eventually become suitable for use to other participants and in other levels of the program.

Information sharing with external partners and customers has become business critical. Certain kinds of information can enable companies to help address potential problems before they happen. The challenge then becomes how to enable all those parties that have access to the data they need without it falling into the wrong hands. The trouble is that attempting to harden a company's security posture can make file sharing and collaboration more difficult for the parties involved, which increases the risk that a data breech occurs due to the actions of an employee.

That means there is a need to find better ways to share information and files. Companies have deployed a variety of security solutions to thwart threats from external factors, malicious insiders, or employees who make innocent mistakes that expose data. But security can be the enemy of business agility. Many solutions that could possibly be used to promote a secure transfer of new concepts that need to remain confidential, are actually less secure than the systems where the content was originally generated, and are also not subject to an enterprise's overall security monitoring. Furthermore, they do not provide IT sufficient visibility over the movement of files across the network, limiting what IT knows about who has accessed a file, and how it was shared. In the event of a data breach, that information is critical to identifying that cause and which files may have been exposed. That is why companies are increasingly employing secure content collaboration solutions to strike a balance between improving user productivity and reassuring auditors that secretive data is shared securely. New methods of thought-compression (such as those illustrated in imbedded demonstrated conceptual preference communication and uncompressed conceptual communication [0055] could represent new potential options for sharing information in a more secure way.

By establishing a secure governance perimeter around sensitive content, information can be protected from prying eyes, enabling employees to securely access and share files, and provide the IT and risk management compliance teams with the controls and auditing and reporting capabilities they need to demonstrate compliance. Finding new ways to accomplish these objectives is going to be necessary, while businesses find new ways to transform raw data into reliable predictive analytics.

As participants interact with the prototype training variables, they transfer concepts between and among themselves through the semitransparent thought-directed cognitive linkage that exists. This activity is continually reinforced through re-presentation of the variables as they go through the level two modification process. Participants learn the importance of language in creating variables as they practice the thought compression necessary to design and create new usable variables—collaborating on how many and what kind of cognitive and preference elements to include, how to introduce them into the variables, how to set variables up to accomplish uncompressed conceptual communication that can be recorded and measured, and the best ways to administer the concept transfer of learning. Critical thinking involves the objective. analysis and evaluation of an issue in order to make a judgement. An important link between communication and critical thinking is the ability to learn how to follow another participant's thought process and line of reasoning. An individual who is able to think critically about how another person is making an argument, for instance, will be able to formulate a more effective response more quickly than someone who is not. Fortunately, it is something that can be learned and practiced, and is certainly a skill that can be improved over time. Many companies find they need to provide training in critical thinking.

Communication will become even more important in the future, and companies will need to keep working to find alternative ways to store, transfer, and share information in the “information age”- and new more stringent ways to meet future cyber security regulations while limiting a company's liability if personal information gets hacked. Information sharing has become critical and that is not going to change. The challenges involved in keeping that data safe will only increase. Someday soon, universal rules will probably apply that will limit access to the “need to know”. There will be a premium placed on collecting data and information in the information age that can be turned into usable analytics that can remain proprietary—for internal use only—that can remain confidential even if the system gets hacked. This means finding new ways to encrypt information in rest and in transit.

Finding a way to keep employees in the loop while maintaining privacy requirements is a difficult task. One way to accomplish that is by sharing enough information and knowledge, but not too much. Sharing what is necessary—but not everything. This idea is reinforced by the New York Cybersecurity Regulations that require companies to limit computer system access to the level necessary to perform their job functions. While access is controllable within a computer system, it is not possible in the real world because “the need to know” changes more quickly than the ability of a company to keep their employees fully informed. That is what makes sensors so valuable, and the ability to create human sensors. Today everybody needs to know everything they need to know right now, not when somebody gets around to telling them. As pointed out in paragraph [0133], small selected teams could be used to initiate a new concept transfer and then spreading it out to a larger audience when appropriate. That's the strength of a sensor. In a company, human beings should be considered sensors of a sort, as far as their customers are concerned. Think of employees as a 24/7/365 customer survey mechanism. The technology disclosed herein gives participants the training and tools they need to become effective sensors.

Human learning involves much more than simply the acceptance of new information or even knowledge. It requires entire concepts to be learned through the transfer concept of learning. Siri can transfer information, and maybe even knowledge. But it does not provide for the transfer of concepts. Human learning appears to require engagement with the new information in a way that stimulates contrast and comparison. The kind of interaction that takes place during level two processing. Many experts believe we must think of things in terms of other things—and learn the relationships that exist between those things. Many experts believe that to have a rational meaning for us, things must always be defined in terms of other things, or in terms of their uses—that everything depends for its meaning upon its relation to other things; and the more of these relations we can discover, the more fully do we see the meaning. Now it is by thinking that these relations are discovered. This is the function of thinking. Human beings can also reason by deliberating—thinking things through carefully. But, more than anything, we learn best when we're thinking with others. Human beings are able to work together, aware of others and what they are trying to accomplish. We pay attention together and we share goals. The technology disclosed herein can turn raw stimuli into information that fosters intentionality.

If humans are going to remain an important link in the IoT (Internet of Things), humans will have to continue to improve their cognitive abilities and skills. That is why some people propose implementing brain chips as augmentation tools. The IoT reaches well past human involvement, connecting to other machines it must communicate with. Business uses are plentiful and include inventory tracking and security, while medical applications include monitoring and actually correcting anomalies—as in the case of delivering a charge to a heart monitor to automatically correct heart rhythm—all without human intervention as the devices are communicating with each other from one end of the network to the other. The technologies of IoT will encompass sensors and associated connectivity devices that are well suited for machine-to-machine applications, such as utility companies that use it to harvest energy, and even to bill customers when harvesting oil and gas, sensors detect pressure, flow rates, fuel levels, temperature, and the computer providing analysis and control can adjust the equipment involved for efficiency, safety, and more. The technology disclosed herein creates a new type of system comprised of highly sensitive; human sensors (i.e. program participants) placed in the most strategic locations—between the company and its customers—that creates a new form of augmented AI algorithm. Serving as human sensors in the IoT will allow participants to contribute to organic computing, and to remain relevant, and AI to more effectively evolve.

But in order to extract more meaningful information out of human sensor, employees will need to move out of their comfort zones. They will need to move into new roles, and acquire new skills.

The cognitive narrative and the cognitive element(s) of a properly designed variable that facilitates a concept transfer involves thought compression—in creating the variable and in creating a response to a variable. Any thought-directed uncompressed conceptual communication usually occurs through the preference element(s) of a variable. These preference elements could potentially serve the same purpose as other sensors in the IoT—to monitor, record, analyze, and stimulate action, regarding data, information, and knowledge that would not normally be capturable by a company's big data.

The collaboration involved in level two processing could be considered to be a cognitive game for training purposes—directed at positively affecting the company's business culture—as level two processing is all about employees understanding how culture can positively impact a participant's cognition, and how a participant's cognition can impact a company's culture in today's world. As participants collaborate to design and construct inside variables, they never know whether they are acting as teacher or student as of a particular moment; whether they are teaching others or learning from them. Participants can add an element, change an element, or alter a response during the modification process for training purposes, for example. Within a workplace environment, the workforce represents an organized community and/or society that has its own beliefs, way of thinking, behaving, or way of working that exists. It is a pattern of responses to internal and external stimuli discovered, developed, or invented during the group's history of handling problems which arise from the interactions among its members, and between them and their environment. Culture determines what is acceptable or unacceptable, important or unimportant, right or wrong, workable or unworkable. It includes behavior that is learned. Research shows that cultural activities may actually influence cognition.

Augmented cognition research generally focuses on tasks and environments where human computer interaction and interfaces already exist. Developers, leveraging the tools and findings of neuroscience, aim to develop applications which capture the human user's cognitive state in order to drive real-time computer systems. In doing so, these systems are able to provide operational data specifically targeted for the user in a given context. A sub-field of the science, augmented social cognition, endeavors to enhance the “ability of a group of people to remember, think, and reason”. “Augmented Human Intellect” is a term that concerns increasing the ability of man to approach a complex problem situation, to gain comprehension to suit his particular needs, and to derive solutions to problems. The technology disclosed herein can be introduced into all levels of a company's relationship chain. This thinking is closely tied to cognitive informatics.

### Level Three Processing

Level three processing promotes brain training and augmentation through the conscious and unconscious learning and knowledge transferred through the cognitive/conceptual linkage during level one and two processing, and interaction with customers, other company participants, and suppliers, by teaching participants to successfully perform a new process for creating big data analytics and cognitive analytics—examining large and varied data sets to uncover hidden patterns, unknown correlations, market trends, customer preferences, and other types of information. This processing level can be considered a form of B2B commerce. The concept transfer of learning is vital to understanding why all three levels of the program disclosed herein dovetail as they do. That concept refers to learning in one context and applying it to another. It represents the capacity to apply acquired knowledge and skills in new situations. Each of the interfaces in the three-level process can be thought of as a “conversational interface”—a program that controls a display for the user and that allows the user to interact with the system's interfaces that can understand the natural language of human users. With conversation type interfaces, computers and humans can finally speak the same language. This development should positively affect big data analytics. The three-level process represents cognitive computing at the highest level.

Only recently has technology gotten good enough to make such interfaces practical. AI projects are getting better than ever at understanding more than just syntax, but what we actually mean. The dream of conversational interfaces is that they will finally allow humans to talk to computers in a way that puts the onus on the software, not the user, to figure out how to get things done—not the user. That's not only the way it should be, it creates the potential to totally change the way we use computers going forward. The technology disclosed in this patent continues this trend moving forward in the context of AI and machine learning by linking humans and computing devices closer to one another.

Level three processing allows participants to serve as a new type of machine interface and creates a place where their performance directly impacts the company as they perform their normal day's work and interact with their co-workers and customers. The program teaches participants what they need to know to understand their customers and supplier's needs, and provides them with the skills necessary to discover previously undiscovered and unrecognized connections and relationships (and their meanings), that exist between and among the company's workforce, and its suppliers and customers. The program teaches participants to anticipate problems and issues.

Level three training is designed to teach participants how to apply their learning from level one and level two processing to create and build cognitive variables that can be used in connection with big data and cognitive analytics to reveal unknown shared participant secrets. This process can prove beneficial at all levels of the relationship chain—B2E, E2E, B2B, B2C. Participants should be able to understand a customer's needs and objectives, how to develop cognitive variables based upon those needs and objectives, how to create invisible challenges that involve unconscious learning and knowledge, and how to create demonstrated preferences that can be inserted into a variable to take advantage of uncompressed conceptual connections that can maximize the benefits of the concept transfer of learning while all the time recognizing the cultural environment he is working in. All of these considerations—the discovery, interpretation, and communication of meaningful patterns in data can be used to describe, predict, and improve business performance. It teaches participants to design variables to present to their customers to uncover unknown shared secrets that will be meaningful to those customers.

Big data analytics is primarily concerned with the processing of vast data for cumbersome problems. It is possible that cognitive computing and interactive learning such as that used in level two and level three processing could be better suited to solve certain problems faster than big data analytics and cognitive analytics utilizing AI and NLP.

Cognitive analytics deals with problems that are inherently uncertain, problems whose solutions are unavoidably and necessarily probabilistic. Consider a classic probabilistic problem, natural language processing (NLP). If real-world data is involved, the probabilistic nature of language means that software claiming 98% accuracy might fall to 70% accuracy. In one experiment, the software was only 70% confident that any non-phrases extracted by industry standard NLP tools are accurate. It could be that level three processing, big data analytics, and cognitive/behavioral biometrics merged together could help solve NLP problems. As disclosed herein, variables contain at least one cognitive element and one preference element as stated previously. The cognitive element could require a math sum, 500 for example, and if the response is 100% accurate and correct, that becomes a very easy pattern to match. The answers to analyses conducted using big data are usually deterministic. Given a set of assumptions and rules, a machine will give a reliable output. So much of a company's big data can be mined in this matter, and this data could be useful for level three processing.

However, the preference element responses that could be used to create more effective analytics proves much more problematic. The preference element of a variable may be hidden in a way that makes a standard analytics program less effective, if not impossible. The response to a preference element may be in the form of information, instead of data, and it may involve uncompressed conceptual communication that has not undergone thought compression. In other words, there is usually no pattern matching algorithm to match to. A demonstrated preference element presented for the first time involving uncompressed conceptual communication, as illustrated at paragraph [0123] for example, would not have a specific algorithm to match to. A pattern could eventually be recognized if a special form of algorithm—an accurate response criterion algorithm is created so the big data analysis could detect a specific response. Variables can also be designed to anticipate. Anticipation is key to collecting these new kinds of communication in big data.

Big data analytics is not the same as big data analysis. Big data is the term for data sets that are rapidly evolving, span across both structured and unstructured data, can be very large and from which considerable value can be derived. Big data sees the world as an interlinked set of “things” which have certain qualities and data associated with them, and both the things and their qualities can be analyzed. Big data sets need to be analyzed with real time and even predictive analytics. This means that big data can tell you what is happening now or is likely to happen in the future, as opposed to the old world where information analysis was only used to what happened in the past. In other words, today an insight might affect a single customer and only for the next few minutes. As a result of this, there is a misconception that analytics means that big data systems can provide all the information, but in reality a human element is required as well—humans can serve in the capacity that other types of sensors do; in essence, they become human sensors, that can serve as augmented AI algorithms by enhancing their ability to recognize and receive mind-to-mind communication.

All of this means that the power of predictive analytics should not be overstated. The problem is that the computer still can't answer the “why” questions, or draw conclusions from data that are applicable elsewhere; and therein lies the value of the technology disclosed herein. Humans are great at this because what we really do is tell stories all the time. It's natural for people to read about big data and imagine that it is an entirely automated process, but the reality is that a human is needed to make sense of big data, and that the humans involved need a combination of data skills and business knowledge that is quite unique. The cognitive variables that comprise most of the technology disclosed herein, each tell a short story, and the interaction between the workforce program participants can weave them into a bigger, more meaningful story that unfolds within a company's culture—which makes it a specific company's unique story—as told by that company's workforce.

Level three processing creates an opportunity for the company and customer program participants to connect in new ways to create more meaningful big data and big data analytics—while they are jointly engaged in semitransparent thought-directed cognitive linkage. The cognitive linkage can place a human sensor—a program participant—into the head of a company's customers as they jointly design new ways to collect and merge data, information, and knowledge from many different sources including other non-human sensors that may already be situated or that could ultimately be put into place to be used to influence and maybe even adapt behavior. Soon it may be possible to reliably measure things such as mood and engagement in conjunction with machine learning. If a better predictive analytic can be created jointly with a customer through the thought-directed cognitive linkage concept, the same process could be used to create more meaningful analytics for other companies.

Taking the example variable disclosed at paragraph [0101], the variable does not require the total change amount of $5.20 in numeric form. It is represented by proxy—the total of bills and coins to be returned as change. It would be easier to create a pattern matching algorithm if the $5.20 accurate total is specifically required in numeric form, as it is much harder to identify in big data if it is disguised as a proxy (e.g. the total of the bill(s) and coin(s) returned as change). That is, unless its proxy form is anticipated by the analytics search software. It is difficult to go about constructing a hidden challenge algorithm for example—especially one that might involve uncompressed conceptual communication. Since the figure of $5.20 is not required as part of the response, it might never become big data. Big data mining and analytics would need to be able to recognize and combine all types and kinds of communication and be able to assure that the responses relate to the variable concept involved. In other words, be able to reason as a human can. A new special type of pattern matching algorithm is required—an “accurate response criterion algorithm” that can be used for machine learning, AI, big data mining, and analytics, that can recognize compressed thought and uncompressed conceptual communication all at the same time. Being able to generate, separate out, capture, measure and record more types of communication would be very valuable as far as big data analytics and data mining purposes are concerned, especially if it is a determining factor for use in predictive analytics and/or probabilistic computing. Such an algorithm creates the ability for a machine to reason and make decisions as good as a human. That is one of the objectives of the technology disclosed herein. Another objective is to create a way to collect data, information, and knowledge instead of trying to collect data only and have to process it further to turn it into information and knowledge. The cognitive variables used in the three-level process help to achieve these objectives—as well as delivering brain/cognitive training and augmentation to those program participants as they teach and learn through the program.

According to research, one's so-called cognitive fingerprint is at its most obvious when we're actually thinking and our brains are bouncing signals back and forth. We all have a cognitive fingerprint, and we are now in a new cognitive era whereby we can start using machines to advance mankind at a level unthought of even ten years ago. What excites the researchers is the potential for brain activity data to be used for therapeutic purposes, where treatments can be specifically tailored to an individual's unique brain connectivity profile—such as profiles that are now possible through the presentation of the technology disclosed herein.

The technology disclosed in this application represents a new kind of brain training and augmentation method. Level one training utilizes the standard kind of training program that uses digital technology to present questions and mental exercises that engage participants in challenge-response scenarios to give their brains and cognitive skills a good workout. Progress can be measured with every response. Using a mixture of new and challenging cognitive exercises that are both adaptive and novel to provide the brain with the challenges it needs to take advantage of its innate neuroplasticity—it's ability to re-shape neural connections. It creates the opportunity for participants to actually strengthen their brains in numerous ways. The right kind of training introduces novel tasks that force the brain to process information in new ways, such as that required of a participant when a concept is expanded in level two processing during interaction with other program participants.

There is getting to be substantial evidence that computer-based cognitive training offers real benefits for certain populations. Physical exercise builds the brain and body in older adults. Training and other interactions, exercises, etc. have shown to improve cognitive function. The study showed that those who underwent training relating to speed of processing and reasoning showed particularly good results. A full ten years later, they still out performed the control group. Tentative results presented in the summer of 2016 at the Alzheimer's Association showed that those who underwent booster training were 48% less likely to be diagnosed with dementia ten years later.

Cognitive games—such as field of view driving training—showed positive results and the participants in the studies done so far show participants cut down on the number of accidents. Working memory is essential for learning, reasoning, and comprehension. We now know that working memory can be developed through cognitive exercises and training, even in children with learning disabilities. Cognitive games are engaging, and helpful in improving attention, working memory, and impulse control. Research has shown that strengthening of human adaptive reasoning and problem solving can occur even in people with average or above average intelligence.

Level two processing introduces a new type of platform for brain training and cognitive augmentation that allows participants to collaborate with each other to construct new variables while cognitively linked to one another, allowing participants to learn from each other and teach each other. The cognitive variables can each be thought of as a cognitive game categorizable by the contextual/conceptual narrative of the concept involved; each game having multiple levels of difficulty, and each designed to challenge the user to display a different set of cognitive skills. As discussed in the example variables presented previously, participants are cast into different roles to display their own individual thinking processes, but also to think like another co-worker, customer, or provider might think. In essence, it creates a new form of augmented reality, thought-directed simulated reality, that can even teach skills such as empathy. In an environment of machine learning and AI, these new technologies will allow both humans and machine to learn and adapt together, creating new ways to effectively use information technology to augment human intelligence. The technology disclosed herein drives this innovation further.

The language, elements, and ultimate design of new variables developed in the program is controlled by the participants themselves, working in collaboration, while acting in the dual roles of teacher and student. The preference element(s) provides participants with the opportunity to display uncompressed conceptual communication, whereby they share their implicit learning and knowledge, unconscious learning, and demonstrated preferences. It allows them to transfer concepts and knowledge that they might not even know they have. Knowledge, that displayed in this manner, allows them to learn from themselves—turning unconscious learning and knowledge into conscious learning.

The technology disclosed herein can be useful in the diagnosis and treatment of traumatic brain injury (TBI), which makes it a neurocognitive assessment tool. With mild traumatic brain injury, the patient's level of awareness, or dazing, following a concussive event, such as those events involving many veterans in combat zones around the world, may involve impaired awareness or loss of consciousness that may be momentary or it may last up to 30 minutes. For a moderate injury it would be 30 minutes to 24 hours, and for a severe injury it would last more than 24 hours. Additional indication of TBI over time might include dizziness, anxiety, mood swings, depression, severe headaches, and behavioral changes. In the cognitive domain, it would cause concentration problems, temporary gaps in memory, attention problems, slowed thinking, judgement issues, difficulty finding words—and there could also be physical and emotional implications. Many current patients say they wished they'd asked for help sooner. TBI can result in a host of medical issues. There is an association between TBI and post-traumatic stress syndrome (PTS). These conditions both share similar symptoms so the earlier one gets checked out the better. Current and former military personnel are potential candidates for future research involving the technology disclosed herein. If these personnel become participants in a program of this type, it is possible that some of them could be diagnosed with the correct impairment quicker. Responding to the variables presented through a thought-directed interface and collaborating with other participants in the same cultural environment, affected participants might exhibit, or might disclose important actions, signs, or symptoms of an impairment they might not otherwise be able or willing to disclose voluntarily through uncompressed conceptual communication involving implicit learning, solving techniques, invisible challenges, demonstrated preferences, unconscious learning and knowledge in responding to the cognitive element(s) and preference element(s) included in the variables. The “displacement” feature of the variables provides the opportunity for participants to act in an environment that could make them feel free to communicate and disclose thoughts or behaviors they couldn't or wouldn't otherwise. In addition, the response to a preference element in a variable is tantamount to an open-ended question and if the response is truly “uncompressed”, could reveal other learning and knowledge the participant may not be consciously aware of, and could be an early indicator of suicidal thoughts.

The multiple and flexible features of the variables can liberate a participant's thought processes rather than constricting them like most questions that require thought compression. Compare the difference between the big data that could be collected in connection with the example variables at [0086] and [0123] for instance.

Implicit learning refers to learning patterns without any conscious knowledge of the learned pattern. An example of this is riding a bicycle. One knows how to ride a bicycle, but cannot really explain how. Implicit learning is the absorption of information without conscious intent or awareness, and all of us are doing it all of the time. It's how a young child can put together a coherent sentence without knowing the rules of grammar, it's how a fisherman knows the weather will be good and the fish will be biting, based on shades of the sea and sky that others wouldn't notice and that he could not explain. There are ways to improve our implicit learning. First, give your mind plenty of material to work with. Research suggests that we acquire a complex skill, such as speaking a foreign language, more rapidly when we're exposed to many different examples of that skill in action. Well past the point when we think we've got it, continued practice allows our brain and our muscles to become more accurate and efficient in carrying out the task, even using less energy to do so. Published research has shown that during sleep, the brain identifies meaningful patterns in our memories from the preceding day and “consolidates” them, or makes them stronger and more permanent.

The technology disclosed herein allows a program participant to teach something he cannot really explain. Through the responses to the programs specially designed cognitive variables, a participant may divulge a thinking strategy, move sequences, and/or demonstrated preferences he may not consciously know he is using, that are then captured and recorded. The preference element(s) of the variables are designed to liberate rather than constrict participants by allowing unconscious compressed thought, uncompressed conceptual communication, and associated conceptual communication as opposed to only conscious compressed thought that is demonstrated in a cognitive element response.

Focusing again on the word “change” as discussed previously, the example variable at paragraphs [0123] presents the opportunity to see how analytics and the cognitive variables share an important relationship. A common occurrence these days involves “rounding up” your bill at a retail store as a donation to one good cause or another. At the checkout counter, a clerk might say “Would you like to round up your purchase today to the next highest dollar to further support our mission? The question expands the relevance of change to include it as a potential source of donations to the business based upon the idea that people don't want to have to deal with small change amounts (in this example “donating” the coins that would have been paid back to a customer along with any bills due. But the concept also applies to debt and credit card transactions, where there would not actually be change. Reviewing the big data from sales that day would reveal the specific number and percentage of customers that agreed to the “round up” process. The big data allows the store to immediately know the amount of “extra” donations acquired through this process. But it also opens up the opportunity to test a large number of predictive analytics. High on the list would be: “How can we increase traffic and clothing donations to improve our results without disrupting our normal operation? The technology disclosed herein is designed to turn raw stimuli (the “change” owed to a customer from a sale) into information to create analytics that can lead to innovation.

But being able to identify the real stimulus behind any action taken becomes the key issue in being able to create usable effective analytics. In the example used in [0166], the “round up” is focused on “change” as a donation source, so “change” is a primary stimulus for sure. But the store's mission is also a stimulus, because the “cause” is an emotional reason to make a donation. But there are a number of other considerations that must be taken into account as well. Analytics is the scientific process of transforming data into insight for making better decisions. Cognitive computing combines artificial intelligence and machine learning algorithms in an approach which attempts to reproduce big data analytics; and is primarily concerned with the symbolic processing of vast data for cumbersome problems: targeted advertisements, recommendation systems, and the learning of straightforward correlations. Data scientists are anxious to intelligently manage information that is captured in text, speech, and other constructed forms. Cognitive analytics holds much greater potential than big data analytics. It also holds more challenges.

Probabilistic computing and deterministic computing represent two distinct computing methods. Given a set of assumptions and rules, a machine will give a reliable output. The trick is to get the right set of assumptions and rules, and to program the machine in a resource efficient way. Builders of cognitive systems are not so lucky. Cognitive analytics deals with problems that are inherently uncertain, problems whose solutions are unavoidably and necessarily probabilistic. It involves completely unpredictable, unstructured, and string-based data that involves computational complexity. By nature, big data involves humans who have a unique combination of experiential learning, ability to abstract concepts, and deft extrapolation leading to seemingly incomprehensible phenomena like humor, creativity, and wisdom. That means thinking like a human brain on a minor level may be quite achievable; but thinking everything the human brain can is a whole different thing.

The cognitive training variables presented to a program participant provide insight into one or more brain processes of the participant by means of the neural coding and decoding information associated and other associated information with the cognitive credentials created during the supplemental process. There are a number of cognitive skills being tested. Invisible challenges provide insight through the associated information gathered as part of the response, and may reveal responses that are not explicitly called for. The first thing the program participant would have to do is determine the change due. The participant would have to use symbolic thinking to determine how many bills and coins to give back—and the denominations involved. But the variable also involves several other factors for consideration. The variable suggests an environment where an employee's compensation includes tips. Often, the method of returning change will anticipate this, and in this case, a five and five one dollar bills rather than at $10.00 bill makes sense—anticipating a larger tip. Additionally, $15.00 in change given back as a $10.00 and a $5.00 bill can force a somewhat larger tip, depending upon the circumstances. Demonstrated preferences, implicit learning and knowledge, and solving techniques also provide a window on a participant's brain processes.

Each level of the Three Level Process is distinctly different. Each level contributes to the workplace program in a different way. Level One of the Three Level Process represents the concept presentation phase and could be considered the core phase of the education, training, and augmentation program. It is where the semitransparent thought-directed cognitive linkage and simulated reality are first established, and where the first steps of a conceptual transfer are initiated. As illustrated in FIGS. 1A and 1B, an authorized user requests a logon session at STEP 1, usually by first entering a username and password, which comprise the known shared secret between the user and the computer system. The system then initiates STEP 2 of the process that enables it to rapidly search, identify and verify the user's identity and which parts of the computer system the user is authorized to access contained in the baseline authentication/authorization store at STEP 3. At STEP 4 a user is presented with a computer screen that provides required and/or optional legal and privacy language regarding the pertinent parts of the authentication/authorization process yet to come. At STEP 5, a system's additional authentication/authorization access control process is initiated, that introduces a cognitive authentication protocol, and may involve other multi-factor and/or risk-based authentication requiring other types of authenticators to be introduced, for example, presenting the user with a random cognitive logon variable from the variable store at STEP 6; receiving a response to the variable from the user, measuring the response against an accurate response criterion; transforming the response into a logon credential; generating prescribed actions based on the credentials; and storing the credential and data. At STEP 7, a user is granted further access to the system, if he has successfully met the base authentication/authorization mechanism requirements.

Following the successful completion of a computer system's regular cognitive/behavioral authentication process that may require validating the user's cognitive/behavioral biometric fingerprint at STEP 7, at STEP 8 the dedicated program disclosed herein as the invention begins by validating that the authorized user is a designated participant in the program at STEP 9, and begins the three-level supplemental process at STEP 10. Users who have been authenticated/authorized who are not designated as program participants are given immediate access to the system at STEP 15, and do not participate in the supplemental program disclosed herein.

Level One processing actually begins at STEP 11 (see paragraphs beginning at and FIG. 1B)) where the training interface executes the program by accessing the big data store database at Step 12 where the training variables are stored and arranged in subsets and by concept. This database may also import certain random cognitive logon variables and outside cognitive test variables from the baseline authentication/authorization store, the random logon variable store, or from another database located outside the system. Other associated information could be imported into the variables database from an outside database, such as an employer's database.

The interface then initiates the process of selecting cognitive training variables for presentation to a participant. Each variable is tagged with an accurate response criterion and the variable concept to be transferred, thereby determining the cognitive credentials that will be formed if accurate responses are made, and that will determine a participant's ability to progress through the program. These variables, the accurate responses to these variables, and the resulting required credentials (that may or may not ultimately be created), are held for further processing.

The user is presented with the first cognitive training variable designed to transfer a concept important to the business, and to improve a participant's imagination, perception, attention, memory, verbal language, reasoning, visual and spatial processing, executive functions, and other cognitive abilities. This is the point where the semitransparent thought-directed cognitive linkage is initiated and established. This is also where the neural encoding measurements that comprise “associated information” are collected. Because both the variables and the accurate responses to the cognitive element(s) required are unknown to the participant, he must utilize his cognitive abilities. In order to provide responses, the user must demonstrate some or all of the following cognitive skills including: attention, awareness, comprehension, concentration, decision making, executive function, judgment, logical thinking, long-term memory, perception, problem-solving, planning, math skills, reasoning, short-term memory, symbolic thinking, verbal recognition and verbal memory, and visual skills.

For illustration purposes, assume that a participant who has already responded to the variables presented at [0086, 0101, and 0123] is presented a similar training variable in level one processing at a later date that includes similar cognitive and preference elements. “Imagine you are a waiter, and that a customer has just given you a $50.00 bill to pay for a dinner costing $29.50 including tax. What bill(s) and coin(s) would you give him back as change?” If a bank teller faced a similar situation, such as paying for new checks for example, most, if not all, bank tellers would normally be trained to return the change due in the most customer friendly way, and would give back a $20.00 bill as part of the total change returned absent any specific customer request. While the variable presented here is similar to the other three training variables noted previously and within the same general conceptual boundaries, there are several factors that are different. For one, the customers real cash position has not been disclosed. The participant faces a similar position in that he must calculate the total change figure of $20.50, even though that figure is not requested specifically in order to return the proper bills and coins. In that regard it is an “invisible” challenge. Each person has stronger and weaker cognitive skills, and each user thinks in his own way, interacts with the computer in his own way, and responds to the variables in a different way, even though his responses may all technically be accurate. As long as the correct amount of change is returned, and the bill(s) and coin(s) returned add up to the correct amount, the response is technically accurate. The cognitive element assures the participant's cognitive function meets minimum standards, and the neural coding and decoding measurements can be used to authenticate the user during continuous authentication processing, (and to validate the participant's cognitive function at the same time). A correct response to the cognitive element also assures that the participant is thinking about the thought-directed challenge presented to him and that thought-directed cognitive linkage has been established. If the participant learned anything from earlier example variables presented and demonstrates that he has adopted the concepts presented earlier, he would quickly recognize that giving back a $20.00 bill and two quarters could be problematic from a “tip” perspective. So the previous concept transfer at [0086, 0101, and 0123] could be reinforced if the participant's response illustrates a mix of bills and coins that includes at least five $1.00 bills.

Within the variable itself, the cognitive skills of symbolic thinking (one dime=ten cents=two nickels), attention (math calculations) quantitative reasoning, decision making, problem solving, how much in coins and bills to give back, and verbal reasoning (paying attention to the word “waiter” for example) are involved. The way each user decides to return the amount owed (the actual number of bills and coins and their denominations) indicates more about the thinking pattern of that user. The preferences demonstrated in this regard serve as the response to the preference element, involve thought-compression and/or uncompressed cognitive communications, and may involve implicit and unconscious learning and knowledge. In other words, all of the responses are correct as long as the bills and coins add up to the correct amount, but the way the user would pay it out demonstrates the way he thinks when responding to such a variable and how he would be expected to respond to a similar variable at some future point in time. The three variables presented at paragraphs [0086, 0101, and 0123] are used to illustrate the potential range that a cognitive variable can exhibit as far as its potential use in risk-based authentication is concerned. As transactions increase in risk, more elements of a variable can be used as authenticators; and there is better chance that anomalies by imposters will be detected. Software that uses brain scans to determine what items people are thinking about has already been developed, and the results indicate that “the more detailed the thought is, the more different the brain scan patterns get from one person to another, indicting different people have different associations for an object or idea”.

The neural encoding and decoding measurements of how long it takes the user to read the variable, think up his response, and enter his response (i. e. response time) create the ability to measure and record coding and decoding relating to the responses in aggregate, by separate steps, and even by the specific type of skills and sub-skills required to accurately respond, as well as how the user organizes his responses. In addition, these neural coding and decoding measurements can be recorded and classified by the level of difficulty of the variable presented for response. This process provides the opportunity to observe the user in real-time and over a longer period of time based on previously stored data. The link between stimulus and response can be studied from two opposite points of view: the neural coding map from stimulus to response (i.e. presentation of the variable to initiation of the variable response by the user), and the neural decoding map from response to stimulus (user created and enters a response, which is read by the component). Both perspectives can be measured by linear stimulus-response or other means and allow for measurement by the type of cognitive skills involved, and can then be used for validation, evaluation, and monitoring purposes when integrated into a four level multi-factor authentication process as an additional means of cognitive/behavioral biometric verification. A response can be entered into the computing device through a variety of interfaces, and with regard to component 2, can even include direct brain-to-brain communication between participants. The neural measurements outlined in this paragraph establish further evidence of cognitive linkage.

The response and neural encoding and decoding measurements are captured and recorded. If the response is deemed accurate, the response is transformed into an accurate response credential. A transfer credential could also be created if this is the first evidence of a successfully completed conceptual transfer. The transformation of the response into a credential serves multiple purposes. First, it allows different employers to create differing program requirements. Secondly, it provides an easy way to capture associated information and big data relating to the response. Third, it facilitates long-term storage and recordkeeping for such information. All of the above facilitate the three level process and create the ability to evaluate neural coding and decoding and other associated information relating to the response (i.e. elapsed time).

A set of outside cognitive training variables or random cognitive logon variables could be created for use in a component that will be presented to a user who has been determined to have some form of cognitive or physical impairment. These variables would allow the user to successfully complete the logon requirements by accurately responding to a set of specially designed and targeted variables that have been developed for use with that specific impairment.

Once the above process has been completed for the first variable and a credential has been created and stored in temporary storage, to be sent to permanent storage after all levels of the three level process have been execute, a decision is made as to whether another prototype training, or other type of variable, if appropriate, is to be presented. If so, the next variable is sent for presentation to the participant involved.

The component presents the user with cognitive variables that require cognition and are designed to elicit a range of possible specific responses to meet the ongoing purposes of the program. The accurate responses are transformed into (and become and formulate) the accurate response and transfer credentials required to advance through to level two and level three processing. Because the computer is awaiting the exact matching response (or, if applicable, one of the matching responses), that exact response must exist in the user's brain/mind and cognitive thoughts if only for a moment.

Level One processing then ends and if only Level One processing is conducted, the current data that was put into temporary storage can now be transferred to permanent storage with the permanent baseline data already stored there, and the user is logged off, or returned to the main computer system. Otherwise, he is sent to Level Two processing.

Level Two of the Three Level Process at FIG. 1B (Step 13) represents the concept/category expansion phase, that allows participants to consider a concept from different perspectives while interacting with other participants that may lead to concept expansion or even category extension and/or new categories being created, that can facilitate innovation through collaboration that comprises an important end product of the program. Through a variable re-presentation process, Level Two processing can generate and document communication that takes place directly between program participants that formulates a basis for a new type of artificial conduit that carries communication that can improve the program's education, training, and brain augmentation capabilities and create a more innovative workplace. Level Two processing includes data and information created during Level One processing (located in the big data store at Step 12).

Participant One has previously responded to the example variables at paragraphs [0086] and [0101] as part of Level One/Level Two processing.

As illustrated at Step 1 of FIG. 2A Participant One is presented with the example variable at paragraph [0123] through component 1, in his real time, as part of Level Two processing.

At Step 2 Participant One using his reasoning, decision making, and other cognitive skills to create thought-directed simulated reality in his mind at Step 3, that has no physical existence outside his brain/mind other than through a response he may later make that can be measured and serves as the context for formulating his response(s) to the cognitive/preference elements of the narrative, and returns his response at Step 4 that is sent through component 1 of the thought-directed cognitive linkage as follows: “the $10.00 bill and the $5.00 bill; would expect $5.20 back in the form of five $1.00 bills and $0.20 in coins”. That decision and his response may take place immediately in his real time, or later (together or separately). As an alternative to that option, he could have stated that he would expect to get back $5.20 without specifying that he expected five $1.00 bills, or only the first part of his response “the $10.00 bill and the $5.00 bill” could be presented initially that creates even stronger evidence that mind-to-mind communication is involved, and illustrating the flexibility of the cognitive variables that allows important experimentation to take place during level two processing [0079] regarding transfer of learning [0042, 0043, and 0047]. It requires Participant One's threshold level of participation in creating the response, his thought-directed and eventually his shared thought-directed simulated reality, the thought-directed cognitive linkage, and the ability to initiate the associated conceptual communication that can result in mind-to-mind communication related to a response at forms a basis for the artificial conduit that allows thoughts at a conceptual level to be transferred directly from one participant to another participant later at Step 11 of FIG. 2B.

The explicit response to [0123] is sent back at Step 4 through component 1 of the cognitive linkage, and is stored in the big data store at Step 5. The reasoning and decision making imbedded in the response that represents associated conceptual communication and potentially mind-to-mind communication that may be generated and potentially received by another participant, that may comprise channel 2, 3, and 4 communication that has not been entered through any type of authorized input device and has no physical existence, but is measurable and therefore quantifiable as it exists separately from a participant's brain/mind. In that regard measurement of the responses made to the variables becomes everything. Empathy for example, can be measured as a character trait/feeling/emotion and empathetic understanding can be measurably improved. Participant One is put into category 1 of Level Two processing

Participant Two has previously responded to the example variables at [0086 and 0101], and is presented with the variable at paragraph [0123] at Step 6 in his real time, as part of Level Two processing. See [0123].

Participant Two thinks up his response at Step 7 using his thinking, reasoning, and other cognitive skills and the thought-directed simulated reality he has created in his brain/mind at Step 8 that generates component 1 and 2 communication as follows: “the $20.00 bill; would expect to get $10.20 back as change”. (Note: notice that the two participants attributed different meanings to the phrase “what change would you expect back”, with participant one actually specifying the denominations of the bills to be returned.) This illustrates a difference in verbal reasoning of the participants and points out one obstacle to communicating with thought alone. The way in which two people who have learned language individually represent language in their brains, is going to be different. A conversation may involve hundreds of words, sometimes in completely novel combinations. Communication that involves access to an individual's thoughts at a conceptual level that does not have any physical existence and that does not produce any audible noise partially addresses this problem and can allow inaudible conceptual language to be transferred that may not be transferred by words and language alone. Participant Two makes his response at Step 9 and is put into category 2 of Level Two processing (see [0123]). The response is sent to the big data store at Step 5.

Participant Two is presented with Participant One's original response to [0123] at Step 10 later in varying real time during the variable re-presentation process. He is viewing a response that was made sometime earlier. At Step 11, Participant Two uses his decision making, reasoning, and other cognitive skills to think up his responses to the re-presented variable, the cognitive narrative of which now includes Participant One's thoughts and associated conceptual communication on a conceptual level regarding the same variable, in his real time allowing him to enter into shared simulated reality with Participant One that creates the ability for him to receive mind-to-mind communication directly from Participant One, in real time and in varying real time, as Participant One actually made his response sometime earlier.

Participant Two previously responded to the example variables at paragraphs [0086 and 0101]. The narrative of [0101] stipulated the use of the $10.00 bill and the $5.00 bill for payment, without providing any insight as to why that option was chosen. For some reason, Participant Two rejected using that method of payment when he made his response to [0123], because he chose to pay with the $20.00 bill. If he elected to give back a $5.00 bill and $0.20 in coins in his response to [0101], it would indicate that he did not pick up on the expanded concept, and also that he probably never had training as a waiter—otherwise he would have realized that the customer may not have money in his wallet to leave a reasonable tip—information he now knows because variable [0123] states his cash position.

If Participant Two changes his response to that of Participant One following the observation of Participant One's response and after receiving Participant One's mind-to-mind thought-directed communication that together causes a disruption in his thinking process (see claims 1-20 for further context), and that provides him with the ability to perceive the explicit method of payment portion of the response as “a $10.00 bill and a $5.00 bill,” through his physical senses, and that enables his brain/mind to actually perceive its deeper cognitive/conceptual meaning in the alternative form of “a $10.00 bill and five $1.00 bills” when he is under no obligation to do so, provides evidence that he recognized the concept was expanded, that the conceptual transfer has taken place, that discerning the responses deeper cognitive/conceptual meaning could not have been achieved only by seeing/reading the words of the original explicit response (i.e. physically seeing the language), but that it took place outside his known physical senses in varying real time and involved the artificial conduit in existence at that time. There is no explicitly stated reason for expecting $1.00 bills to be returned as change, or for connecting the payment method with a specific type of change to be returned. This collaborative form of intelligence is made possible through access to Participant One's thoughts at a conceptual level via the thought-directed cognitive linkage established, and provides empirical evidence that one's mind can expand outward and merge with other minds it thinks with, without being explicitly stated (i.e. in an uncompressed state). The act of “seeing” requires the brain to perform an enormous amount of work to interpret all the information streaming into the eyes. Strictly speaking, all visual scenes are ambiguous. A participant's brain goes through a good deal of trouble to determine the information hitting his eyes by taking context into account and making assumptions. As a result of observing Participant One's response to [0123], at Step 12, Participant Two changes his response as follows to “the $10.00 bill and the $5.00 bill; would expect to get back five $1.00 bills and $0.20 in coins.” Using the $10.00 bill for payment, the $20.00 bill, and the $10.00 bill and the $5.00 bill together for payment all represent forms of overpayment for the cost of lunch (i.e. change is due back to the customer). But of these three alternatives, only the use of the $10.00 bill and the $5.00 bill for payment sends out interruptive/disruptive associated conceptual communication that directly relates to the transfer of the expanded concept. The overpayment could be for a reason that does not warrant further consideration, or could be meaningless, or a mistake, but it is important to pay attention to disruption for innovation purposes. If it has a purpose, shadow conceptual communication could be examined to determine the cause of that disruption. Being able to recognize the expanded concept not only augments a participant's intelligence (i.e. making change for more than one purpose), but facilitates the computer system's ability to recognize the transaction for other program purposes, improving AI, machine learning, and reasoning like a human (or two humans) would, is the difference. Seeing the response of the $10.00 bill and a $5.00 bill should cause an inquisitive and potentially innovative mind to question the reason for including the $5.00 bill. (See Wikipedia regarding Broca's Area and Broca's Region and article dated Sep. 4, 2019/Metro News—“Human telepathy” is the natural progression for communication”).

Changing his response provides empirical evidence that the expanded concept has been transferred from Participant One to Participant Two through components 1 and 2 of the cognitive linkage without ever explicitly stating that the original concept has been expanded from that of simply making correct change, and there has never been an explicit reference to the “tip” concept. It also illustrates that component 2 is powered by thought. If Participant Two does not become immersed in the simulated reality to a threshold extent, and the artificial conduit is not created, this type of communication will not take place. Component 1 can only recognize and transmit explicit responses entered into the computer system. Participant Two had to have a reason for changing his response—and that was initiated by the presentation of Participant One's response to him through component 1. Component 2 carries associated conceptual communication that has no physical existence, through an artificial conduit. This example variable involves what may be the implicit unconscious learning and knowledge of participant one. This result is achieved by Participant One's ability to be the initiator of mind-to-mind communication, and Participant Two's ability to be the recipient of that mind-to-mind communication, that would now be considered transformative. This result is also brought about by the other technology discussed at [0032]. The technology disclosed herein is restricted only by computer system limitations—as any number of participants could theoretically participate in level two processing simultaneously.

During Level Two processing, all participants are provided with all of the other participant's responses on an anonymous basis. The program therefore unfolds differently for each participant based on the learning and skills he brings to the program making the program much different than other programs that can be considered “one size fits all”. Less time is wasted and the program can move faster, meeting the objectives of the program and the individual participants.

Level three processing is explained in depth starting at [0146], and takes place at Step 14 of FIG. 1B, and requires access to the big data stored at Step 12 of FIG. 1B.

Because the results of the three-level process for a user may be stored and maintained for a significant period of time, such data could be used as a further indicator of brain trauma, or mild cognitive decline, and could indicate the early symptoms of Alzheimer's disease or other diseases or conditions affecting the brain and/or mind of the user. In some cases, it may even indicate a much more serious acute condition, allowing an early intervention opportunity, and might even prove useful in the diagnosis, ongoing evaluation, and treatment of some cognitive diseases. A user may have had a stroke or heart attack and a modification of Level 1, Level 2, or Level 3, and a grouping of standardized cognitive tests could be combined into a rehabilitation program for use while the user is recovering. In such cases, the user's established baseline could not be used and a new baseline would be started which could then be compared to previous baseline data to measure rehabilitation progress.

When the three-level process has been applied to a single user a significant number of times over a significant period of time, and the neural coding and decoding of the user has been successfully mapped, allows insight into a participant's brain processing, the three-level process is demonstrating machine learning by automatically learning to recognize complex patterns and make intelligent decisions based on data contained in the database.

Both the participant and the level three process can be considered to be exercising thought-directed control, as the supplemental process determines the variables to be presented and a participant must create the thoughts in his mind that initiate the response which, if accurate, is transformed into a cognitive credential.

While the invention has been described with reference to illustrative embodiments, this description is not intended to be construed in a limiting sense. Various modifications to the illustrative embodiment will be apparent to those skilled in the art upon reference to this description. It is therefore contemplated that appended claims will cover such modifications or embodiments as fall within the scope of the invention.

We claim:

1. A computer program product comprising at least one non-transitory computer-readable medium tangibly embodying a computer-readable program within a computer system having internet and/or intranet connectivity, wherein the computer-readable program when executed following a program participant's successful completion of a computer system's authentication/access management process implements a supplemental distinct workplace brain/cognitive education, training, and augmentation program that; (i) prompts a participant with a cognitive variable that includes thought-directed conceptual narrative concerning a variable concept that is to be transferred; (ii) that is selected by, and presented through, one of the program's thought-directed user interfaces; (iii) that has been designed to assist a participant in creating thought-directed simulated reality in his brain/mind relating to a variable concept presented; (iv) that requires him to make accurate responses that create cognitive credentials that will allow him to advance further through the program; (v) that formulates a basis for a telecommunications-enabled semitransparent thought-directed cognitive/conceptual communication linkage between a participant and a computer system; (vi) and directly between a participant and another participant; (vii) that facilitates and in other ways orchestrates the generation, transmission, documentation, and analysis of participant responses made to a cognitive variable presented that may include thought-directed associated conceptual communication; (viii) that has not been explicitly stated or entered into the computer system as part of a response through an authorized program supported input device, brain or other type of implant device, or other type of wearable device, that has an existence separate from the explicit response it is associated with that is fundamental to the program's objectives.

2. A computer program product comprising at least one non-transitory computer-readable medium tangibly embodying a computer-readable program within a computer system having internet and/or intranet connectivity, wherein the computer-readable program when executed allows multiple participants to respond to a variable that has been presented without the need for them to be physically together that allows them to smoothly interact and share experiences as if they were physically together, resulting in more training, education, and brain augmentation to take place between participants who exhibit a broad range of training, knowledge, and experience that can be shared at each participant's own speed of thought through communication that can be perceived by means other than through the known physical senses that involves learning and knowledge transferred directly between a participant and another participant that further advances language from a medium for describing and reflecting the world we live in to an innovative physical substance as it is brought into the real world through an artificial conduit.

3. A computer product comprising at least one non-transitory computer-readable medium tangibly embodying a computer-readable program within a computer system having internet and/or intranet connectivity, wherein the computer-readable program when executed, allows a participant to use his imagination, perception, and other cognitive skills to create a mental image in his brain and mind that supports a thought-directed simulated reality that he can temporarily accept as his real environment and gives him the power to substantially determine what takes place in the environment and in the thought-directed simulated reality of other participants, that establishes a real world conscious link between a participant and that participant as agent and experiencer in the simulated environment that he has created that allows him to transport his sense, actions, and mental presence to a remote location in real time and to import these things from a remote location into his brain/mind in real time that serves as the context for his cognitive and preference element responses that provide a level of assurance that a participant's thought-directed simulated reality maintains at least a threshold level of objectivity, enhances a participant's connection to the concept involved, and endows him with the ability to continually recognize and distinguish reality from unreality in the multiple contextual environments, that are created, and allowing him to establish a detectible line between brain augmentation and unethical manipulation.

4. The computer program product of claim 1, wherein the unfiltered associated conceptual communication received by a participant through the thought-directed cognitive/conceptual linkage during a conceptual transfer may include the transfer of implicit learning and knowledge from another participant at his own speed of thought that represents explicit learning to him that he may only have been able to acquire over an undeterminable but most likely longer period of time through the repetitive tasks he performs relating to the concept involved.

5. The computer program product of claim 1, wherein the cognitive narrative of a variable and the cognitive/conceptual linkage that in combination facilitate the generation and transmission of new and different types of associated conceptual communication that can be distinguished from the behavior that may precede, accompany, or follow it and may reveal deeper thinking including mood, feelings and emotions, intent, attitudes, goals, and/or preferences of a participant that can be used to improve artificial intelligence, machine learning, analytics, cognitive informatics, and/or to identify changes in emotions, personality, and behavior that can be used to create additional ways to engage his interest that can lead to modifications in his behavior.

6. The computer program product of claim 1, wherein the basis for a new type of cognitive/conceptual thought-directed conversational brain-machine interface is formulated that comprises a digital layer that merges a computer with a participant's brain/mind, allowing him to communicate with a computer system through the cognitive responses he makes while also enabling new channels of communication that can generate documentable communication that is taking place directly between program participants at each participant's own individual speed of thought.

7. A computer program product comprising at least one non-transitory computer-readable medium tangibly embodying a computer-readable program within a computer system having Internet and/or intranet connectivity, wherein the computer-readable program when executed following a program participant's successful completion of a computer system's authentication/access management process implements a supplemental distinct workplace brain/cognitive education, training, and augmentation program that; (i) prompts a participant with a cognitive variable that includes thought-directed conceptual narrative concerning a variable concept that is to be transferred; (ii) that is selected by, and presented through, one of the program's thought-directed user interfaces; (iii) that has been designed to assist a participant in creating thought-directed simulated reality in his brain/mind relating to a variable concept presented; (iv) that requires him make accurate responses that create cognitive credentials that will allow him to advance further through the program; (v) that formulates a basis for a telecommunications-enabled semitransparent thought-directed cognitive/conceptual communication linkage between a participant and a computer system; (vi) and between and among a participant and other participants; (vii) that facilitates and in other ways orchestrates the generation, transmission, documentation, and analysis of participant responses made to a variable presented that may include thought-directed associated conceptual communication; (viii) that has not been explicitly stated in a variable's narrative or entered into the computer system as part of a response through an authorized program supported input device, brain or other type of implant device, or other type of wearable device, that has an existence separate from the explicit response it is associated with that is fundamental to the program's objectives; and (ix) that may comprise unfiltered thought-directed brain/mind-to-brain/mind cognitive/conceptual communication that temporarily formulates a basis for an artificial conduit directly between the brain/mind of one participant and the brain/mind of another participant, without either one of them knowing the identity or exact location of the other participant involved, that can involve a non-human employee, that facilitates the communication of thought or perceiving things by means other than the known physical senses that may come into existence as a result of the program's variable re-presentation process, at each participant's own speed of thought.

8. The computer program product of claim 7, wherein the computer-readable program when executed facilitates the creation of thought-directed cognitive/conceptual linkage during a conceptual transfer that extends outward from the simulated reality of a participant who originates associated conceptual communication, a time when a participant's responses represent his brain in action, facilitating a new method of mind transfer that can take place when his brain and mind each have a distinct existence from the responses and communication they create, a time when mind is temporarily extracted from brain matter because the communication generated can be transmitted through the cognitive linkage, a portion of which comprises an artificial conduit, that can be measured separately using a limited number of options that can document a participant's perception and cognitive processing time that makes the artificial conduit portion of the cognitive linkage thought powered as associated conceptual communication is sent out in the form of human thought that has no physical existence or audible sound, under the power and control of a participant who first originates a specific thought as part of a response, providing empirical evidence that one's mind can expand outward and merge with other minds through communication that exists only in an uncompressed state and without explicit representation.

9. The computer program product of claim 7, wherein the existing artificial conduit portion of the cognitive linkage can be further extended by a participant who willingly becomes aware of thought being transmitted through the artificial conduit and links to it as a receiver of that associated conceptual communication during level two processing following a comparison of responses to the same variable, that can help a participant better understand the relationship between objects not just the objects themselves, which can be evidenced through the cognitive and preference element responses he subsequently makes that reflect the new learning and knowledge that is continuously being introduced into the linkage, and that further cognitively and conceptually links participants together creating a new type of collective computing device that involves a human thought powered operating system.

10. The computer program product of claim 7, wherein the computer-readable program when executed following the presentation of a variable concept, enables the computer system to recognize and document the non-explicitly stated portion of a participant's variable response that may not be visible to a computer system even though it is technically already represented by data that resides within that system in the form of conceptual communication associated with a response, because it has not been explicitly stated and has not been entered into that system through an authorized program supported input device of any type, that previously would have remained invisible because the computer system did not have any way of knowing such data existed, but that is now given visibility through the artificial conduit portion of the cognitive/conceptual linkage created during a conceptual transfer by the shadow associated conceptual communication that represents a reverse projection of the reasoning and decision making the originating participant used in formulating the language and the true meaning of his response that can be separately transmitted as communication and means that a participant's ultimate response to a re-presented variable can actually involve the reasoning processes of at least two people, so that if an expanded or changed variable concept is involved the re-presentation process creates the ability to recognize that expansion and/or change has taken place, making the receiving participant a new type of human sensor within a system's artificial intelligence processes who can perform the function of an augmented AI algorithm by recognizing and receiving mind-to-mind communication that otherwise would not have been recognized by the computer system, and forms an ongoing real world connection for quality control and security purposes.

11. The computer program product of claim 7, wherein the computer-readable program when executed facilitates the creation of thought-directed cognitive linkage during a conceptual transfer that extends outward from the thought-directed simulated reality of a participant who originates associated conceptual communication relating to the thought processes he utilizes to create the responses he makes and can be extended as far as the thought-directed simulated reality of another participant who makes himself aware of that associated conceptual communication by becoming a receiver of mind-to-mind communication that allows him access to the originator's thoughts at a conceptual level through the shared simulated reality that exists related to an expansion of the original concept presented, that can be evidenced through subsequent responses he makes following receipt of that communication.

12. The computer program product of claim 7, wherein the technology disclosed herein that is capable of directly measuring a participant's level of attention, perception, engagement, and interest in a non-intrusive manner by documenting the level of interaction he achieves with a variable's conceptual narrative that has been presented to him, by identifying the types of communication he generates and receives, by analyzing the specific content of his responses transmitted through the cognitive linkage, and if the response calls for reasoning and/or decision making—by the associated conceptual communication that is generated as a bi-product of that process that collectively formulates the basis for a new type of neurocognitive assessment tool, rehabilitation device, augmentative and alternative communication device, and cognitive assistive device.

13. The computer program product of claim 7, wherein part of the original thought-directed simulated reality that exists in a participant's mind that impacts his original response in his real time can impact another participant's thought-directed simulated reality in varying real time during the re-presentation of that variable at a later time that includes his response as part of the narrative, that allows direct unfiltered brain-to-brain communication between two participants in the other participant's real time and in varying real time concurrently, allowing the two participants to become cognitively and conceptually linked together through the shared simulated reality that can take place during a conceptual transfer that may be occurring incrementally.

14. The computer program product of claim 7, wherein the computer readable program when executed, forms a basis for a new type of cognitive identification/authentication access management protocol based on a new type of conceptual authentication modality, mind-to-mind communication that takes place outside the normal senses, made possible by the combination of the cognitive linkage technology, cognitive variables, associated conceptual communication, and thought-directed simulated reality that can be used to identify and validate a specific participant at the time he logs onto the system and continuously during the three level process that makes it possible to link a cognitive element response, a preference element response, and/or imbedded demonstrated preference communication related to a response to a single stimulus for attribution and person identification/authentication purposes, that can then be used to reconcile a participant's associated conceptual communication relating to an action he takes while he is immersed in a form of alternate reality with actions he takes in the real world, that requires being able to separate communication from the behavior that precedes, follows, or accompanies it.

15. The computer program product of claim 7, wherein, if a participant is re-presented with a cognitive variable that is part of a systematic variable re-presentation process that includes a previous response made by another participant, that gives him the opportunity to make a different response, and as a result of that process he changes his previous response to match that of the participant who originated that response, that change is meant to convey different mental content and provides empirical evidence that the participant has received and processed new conceptual information/learning at his speed of thought in the form of direct mind-to-mind communication that has been transmitted through the thought-directed cognitive/conceptual linkage that has been transformative, if the participant does not have any other apparent reason to change his previous response but for the new conceptual information/learning that has changed and expanded the original variable concept presented that can be evidenced by his revised response, and neither the original variable nor the variable re-presented to him explicitly states or makes specific reference to the variable concept or expanded concept involved, demonstrating the cognitive and conceptual nature of the linkage that can drive innovation through the willful collaboration that can take place.

16. The computer program product of claim 7, wherein the computer-readable program when executed during a conceptual transfer involving a personal character trait such as empathy that can involve more than one person's reasoning and feelings that can be documented, analyzed, and re-directed to improve augmented artificial intelligence, machine learning, and cognitive analytics if a participant is given the opportunity to change a previous response during level two processing and elects to do so after identifying and receiving shadow associated conceptual communication associated with another participant's response, allowing a participant to demonstrate extra reasoning and decision making related to a personal character trait that is possessed by another participant engaged in the same joint simulated realty that can be used to teach the computer system to reason like two collaborating humans might, as their rational and emotional neural systems battle to control a single channel of behavior, because the cognitive skills demonstrated in changing a response he previously made illustrates not only that he received new learning provided by another participants re-presented response through the cognitive linkage, but that he is capable of developing and/or improving his ability to identify with what someone else is feeling—and his ability to understand the reasoning of another person by taking an action in simulated reality that he can then bring into the real world by changing his response.

17. The computer program product of claim 7, whereby a participant's unanticipated response that can disrupt the transfer of a variable concept by introducing a new stimulus that is not explicitly stated or referenced in a manner that draws attention to the fact that a variable concept as originally introduced is being changed and/or expanded, can serve as a stimulus that initiates mind-to-mind communication between the participant whose response introduces the disruption and a participant who recognizes and is affected by it by becoming a willing receiver of communication relating to the disruption that may take the conversation and the conceptual transfer in an entirely new direction as participants interact with each other and they derive new intents and the ongoing context of the thought-directed shared simulated reality that exists following the introduction of the new stimulus may be controlled by the program's infrastructure through the cognitive/conceptual narrative of newly presented variables making the mind-to-mind communication involved, and the interactions between participants regarding the expanded concept more innovative.

18. A computer program product comprising at least one non-transitory computer-readable medium tangibly embodying a computer-readable program within a computer system having internet and/or intranet connectivity, wherein the computer-readable program when executed initiates a conceptual transfer process that facilitates the creation of an artificial conduit that comprises a portion of the cognitive/conceptual thought-directed cognitive linkage, that is capable of conveying mental content in the form of cognitive and conceptual thought that is created as a result of an explicit cognitive and/or preference element response that has been made, that can be transmitted in the form of thought-directed mind-to-mind communication directly between the brain/mind of a participant who originated that response and the brain/mind of another participant who views that response during a variable re-presentation process, allowing him to perceive the originating participant's intended meaning outside of his known physical senses, that makes that portion of the linkage thought-powered and thought-driven by means of a participant's critical thinking that involves the analysis of a chain of associations whereby one thought retrieves another and others to which it is related consolidating information and trying out new combinations, that is made possible because the language and the meaning of an explicit response to a cognitive variable that involves the transfer of an abstract concept allows at least two levels and methods of cognitive communication to take place at the same time, that separately and together allow an abstract concept expansion/change to be detected by interruptive language and/or associated conceptual communication and by the intended meaning of that language and/or associated conceptual communication, that is being communicated without any audible noise at all, that can both be determined without the expansion or the meaning of the language used having been explicitly stated.

19. The computer program product of claim 7, wherein the computer program product when executed during a conceptual transfer, while a participant is engaged in shared simulated reality with other participants there can be a point in time during level two processing made possible by the re-presentation of another participant's response, when that participant is capable of receiving mind-to-mind communication through the artificial conduit relating to the actions the initiating participant has taken in the simulated reality they now temporarily share, and the associated communication created by that action made possible by both participant's level of immersion in the joint cognitive narrative that is not taking place in the real physical world, but that is capable of generating communication in the real world, making it a time where the mind ends and the real world begins—the communication is real, but the place where it comes from is not—also making it a point where a participant must be able to distinguish between reality and unreality, and because thought-directed simulated reality endows each participant with the ability to make that determination for himself while sharing his reasoning with other participants, allows him to continue exercising free will regarding his participation in the simulated reality and the actions he will take in the future that will generate direct and indirect feedback from other participants regarding those actions that can power innovation.

20. A computer program product comprising at least one non-transitory computer-readable medium tangibly embodying a computer-readable program within a computer system having internet and/or intranet connectivity, wherein the computer-readable program when executed permits successive modifications to the cognitive narrative of a variable that is presented to participants to initiate or continue a conceptual transfer, to be accomplished by the system or by a participant, allowing either to import new context into a variable, and potentially new simulated reality into other program participant's minds and eventually their responses, creating the ability to test the effect of modifying language in establishing the limits of what participants will experience and accept as being real in the simulated reality they create in their brains and minds that can be used to power greater innovation.
